(19) United States
(12) Patent Application Publication
(10) Pub. No.: US 2016/0227810 A1
(43) Pub. Date: Aug. 11, 2016

(54) STRUCTURED TRIACYLGLYCEROLS AND METHODS FOR MAKING THE SAME

(71) Applicants: UNIVERSITY OF GEORGIA RESEARCH FOUNDATION, INC., Athens, GA (US); KING ABDULAZIZ UNIVERSITY, Jeddah (SA)

(72) Inventors: Casimir C. AKOH, Athens, GA (US); Garima PANDE, Athens, GA (US); Supakana NAGACHINTA, Atlanta, GA (US); Ruoyu LI, Athens, GA (US); Jamal S.M. SABIR, Jeddah (SA); Nabih A. BAESHEN, Jeddah (SA)

(21) Appl. No.: 15/029,938

(22) PCT Filed: Oct. 17, 2014
(86) PCT No.: PCT/US14/61191

§ 371 Date: Apr. 15, 2016

Related U.S. Application Data
(60) Provisional application No. 61/892,017, filed on Oct. 17, 2013.

(51) Int. Cl. A23D 9/04

(52) U.S. Cl. CPC A23D 9/04; A23L 1/296; A23L 1/3006; A23V 2002/00

(57) ABSTRACT

The present disclosure provides structured lipids (SLs) and mixtures of SLs including structured triacylglycerols (TAGs), methods of producing the SLs, products including the SLs and methods of making the products.

### CROSS-REFERENCE TO RELATED APPLICATIONS

This application claims priority to U.S. provisional application entitled, “Structured triacylglycerols and methods for making the same,” having Ser. No. 61/892,017, filed on Oct. 17, 2013, which is entirely incorporated herein by reference.

### BACKGROUND

Maternal breast milk is universally considered a gold standard of nutrition for full term infants up to 6 months to a year. Human milk is a complex mix of nutrients and bioactive compounds that provides balanced nutrition and helps in building immunity. Although human breast milk is the preferred choice of nutrition for the infants, in certain cases when the mother cannot or chooses not to, or if the milk production is not sufficient, infant formulas are employed as a nutritional alternative to human breast milk. Lipids are an important constituent of human milk providing not only ˜50% energy but also essential fatty acids (EFAs) and fat-soluble vitamins. The total lipid content of human breast milk varies (3-5%), and 98% of those lipids are triacylglycerols (TAGs). Human milk provides a source of the EFAs linoleic acid (LA, 18:2n-6) and a-linolenic acid (ALA, 18:3n-3), as well as their long-chained derivatives arachidonic (ARA, 20:4n-6) and docosahexaenoic acids (DHA, 22:6n-3). In infants, the conversion of LA and ALA to ARA and DHA, respectively, is not efficient enough to meet the nutritional requirements; therefore, many conventional infant formulas are supplemented with preformed ARA and DHA. Although long chain polyunsaturated fatty acids (LCPUFAs) account for a very small proportion of human milk fat (<1%, individually), they play an important role in proper development of the infant, especially DHA (0.32±0.22%) and ARA (0.47±0.13%). Bioavailability of EFAs and LCPUFAs is critical during infancy for proper brain growth and functioning, cognitive skills, motor skills, sensory functions, and neurological.

In human milk, palmitic acid (16:0) is predominantly esterified at the sn-2 position (>50%); whereas vegetable oils or cows' milk fat contain most of their palmitic acid in the outer positions of the TAG molecules (e.g., sn-1 and sn-3 positions). This unique fatty acid distribution of human milk TAGs greatly affects their digestion, absorption, and metabolism. After hydrolysis by pancreatic lipase, palmitic acid is released from the sn-1,3 positions of TAGs. Free palmitic acid can form insoluble calcium soaps that result in loss of dietary calcium, hardening of stools, and constipation. Higher palmitic acid absorption has been observed in human milk compared to infant formulas, including formulas in which palmitic acid was mainly esterified at sn-1,3 positions. This has been observed in both term and preterm infants [Carnielli, V.; et al., Am. J. Clin. Nutr. 1995, 61, 1037-1042; Carnielli, V.; et al., J. Pediatr. Gastr. Nutr. 1996, 23, 554-560]. However, sn-2 palmitic acid rich infant formulas have higher palmitic acid absorption and may also improve calcium absorption [29].

### SUMMARY

Briefly described, embodiments of inventions of the present disclosure provide compositions of mixtures of structured lipids (SLs), products containing mixtures of SLs, and methods of making mixtures of SLs and products including mixtures of SLs.

In embodiments, the present disclosure provides compositions including a mixture of structured lipids (SLs) where at least a portion of the SLs in the mixture have palmitic acid at a sn-2 position and where the mixture is selected from the group of SL mixtures including: SL1-1, SL1-2, SL2-1, SL2-2, SL132, SL142, SL151, TDA-SL, PDG-SL, SL3, SLS, SL6, and SL7.

Embodiments of the present disclosure also include products including a mixture of SLs of the present disclosure selected from: SL1-1, SL1-2, SL2-1, SL2-2, SL132, SL142, SL151, TDA-SL, PDG-SL, SL3, SLS, SL6, and SL7. In embodiments, products of the present disclosure include infant formulas including an SL mixture of the present disclosure.

Embodiments of methods of the present disclosure for making a mixture of SLs of the present disclosure include providing one or more substrate oils, where at least one of the oils is a tripalmitin oil and providing one or more free fatty acid compounds, where the free fatty acid compounds include fatty acid oils, free fatty acids (FFAs), fatty acid ethyl ethers (FAEEs), or a combination thereof. In embodiments the fatty acid oils, FFAs and/or FAEEs are selected from: docosahexaenoic acid (DHA) oils, FFAs of DHA, FAEEs of DHA, arachidonic acid (ARA) oils, FFAs of ARA, FAEEs of ARA, gamma-linolenic acid (GLA) oils, FFAs of GLA, FAEEs of GLA, and combinations of these. The methods further include reacting the one or more substrate oils and the one or more free fatty acid compounds with one or more lipases selected from: non-specific lipases, sn-1,3 specific lipases, and combinations of both non-specific and sn-1,3 lipases to form an SL mixture.

Methods of the present disclosure also include methods of making a powder formulation of a mixture of SLs of the present disclosure. In embodiments, the methods include providing a SL mixture of the present disclosure and/or an SL mixture made by a method of the present disclosure, dispersing the SL mixture in a carbohydrate and protein mixture to form an emulsion, and spray drying the emulsion to provide a powder formulation of microencapsulated SLs

Other methods, compositions, plants, features, and advantages of the present disclosure will be or become apparent to one with skill in the art upon examination of the following drawings and detailed description. It is intended that all such additional compositions, methods, features, and advantages be included within this description, and be within the scope of the present disclosure.

### BRIEF DESCRIPTION OF THE DRAWINGS

Further aspects of the present disclosure will be more readily appreciated upon review of the detailed description of its various embodiments, described below, when taken in conjunction with the accompanying drawings. Moreover, in the drawings, like reference numerals designate corresponding parts throughout the several views.

FIG. 1 illustrates two reaction schemes for synthesis of SL mixtures of the present disclosure. The top scheme illustrates a two-stage, and the lower scheme illustrates a one-stage syntheses.

FIG. 2 is a bar graph illustrating the amount of palmitic acid incorporated at the sn-2 position as a function of reaction time using both the 1 stage and 2 stage synthesis.

FIGS. 3A and 3B are melting thermograms (FIG. 3A) and crystallization thermograms (FIG. 3B) of substrates and structured lipids. The temperatures shown are melting completion temperatures and crystallization onset temperatures, respectively.

FIG. 4 is a graph illustrating the mol % sn-2 palmitic acid (primary y-axis) and mol % total ARA+DHA (secondary y-axis) of structured lipids (1:1:0.5, TP:EVOO:AD) as a factor of Novozym 435 and Lipozyme TLIM lipases reusability in two-stage and one-stage syntheses.

FIG. 5 illustrates the melting thermograms of embodiments of substrates, structured lipids, and physical blends described in Example 2. The temperatures shown are melting completion temperatures.

FIG. 6 illustrates crystallization thermograms of embodiments of substrates, structured lipids, and physical blend from Example 2. The temperatures shown are crystallization onset temperatures.

FIGS. 7A-7C are contour plots of the effect of substrate molar ratio and temperature on PA at sn-2 (FIG. 7A), on total PA incorporation (FIG. 7B), and on total DHA incorporation (FIG. 7C), with time kept constant at 18 h.

FIG. 8 is a bar graph illustrating tocopherols concentration (ppm) in embodiments of SL mixtures, TDA-SL and PDG-SL from Example 4. T, tocopherol and T3, tocotrienol.

FIG. 9 is a graph illustrating the influence of stirring time on obscuration of embodiments of spray-dried TDA-SL and PDG-SL powders. Obscuration was measured as a function of time after powders were added to the stirring cell of a laser diffraction instrument.

FIG. 10 is a graph illustrating the mean droplet diameter (μm) measured as a function of time after embodiments of SL powders were added to the stirring cell of a laser diffraction instrument.

FIG. 11 illustrates two reaction schemes for preparing embodiments of SLs of the present disclosure, showing acidolysis (with FFAs as substrate, top reaction) and interesterification (with FAEEs as substrate, bottom reaction).

FIG. 12 is a graph illustrating the percent total incorporation of ARA and DHA via acidolysis (FFAs as substrate) and interesterification (FAEEs as substrate) using different substrate mole ratios (3-9 mol acyl donor: 1 mol tripalmitin) and different incubation time (12-24 h) at 60° C.

FIG. 13 illustrates carbonyl region of the broad band decoupled ¹³C-NMR spectrum of an embodiment of an SL mixture of the present disclosure. The assignment of sn-1, 3 and sn-2 regioisomeric peaks to individual fatty acids is annotated.

FIG. 14 illustrates TAG molecular species profile of palm olein, CIFL, and an embodiment of an SL mixture of the present disclosure as determined by reversed-HPLC. Annotated TAG species do not reflect stereochemical configuration.

FIG. 15 illustrates the crystallization (exothermic) and melting (endothermic) profile of tripalmitin, an embodiment of an SL mixture of the present disclosure, and CIFL.

FIGS. 16A and 16B are contour plots of the interaction of time and substrate molar ratio with palmitic acid content at the sn-2 position (FIG. 16A), and with total DHA and GLA incorporation (FIG. 16B).

FIG. 17 illustrates cooling and heating thermograms of an SL mixture of the present disclosure as described in Example 6 and palm olein.

FIG. 18 is a graph of the solid fat content (%) as a function of temperature of SLs of the present disclosure described in Example 7, PB (physical blend), IFF (infant formula), and MF (human milk fat).

FIG. 19 is a bar graph illustrating the oxidative stability index (OSI) of embodiments of SLs described in Example 7, PB, IFF, and MF. Values with the same letter are not significantly different (P<0.05).

FIG. 20 illustrates melting thermograms of SLs according to Example 7, PB, IFF, and MF. The temperatures shown are melting completion temperatures.

FIG. 21 illustrates crystallization thermograms of SLs according to Example 7, PB, IFF, and MF. The temperatures shown are crystallization onset temperatures.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Publications cited herein are not incorporated by reference unless otherwise specified, but for any publications and patents cited in this specification that are specifically incorporated by reference are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of biochemistry, molecular biology, chemistry and the like, which are within the skill of the art. Such techniques are explained fully in the literature.

It must be noted that, as used in the specification and the appended embodiments, the singular forms “a,” “an,” and “the” include plural referents unless the context clearly dictates otherwise. Thus, for example, reference to “a cell” includes a plurality of cells. In this specification and in the embodiments that follow, reference will be made to a number of terms that shall be defined to have the following meanings unless a contrary intention is apparent. Throughout this application, the term “about” is used to indicate that a value includes the standard deviation of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and “and/or.”

As used in this disclosure and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) have the meaning ascribed to them in U.S. Patent law in that they are inclusive or open-ended and do not exclude additional, unrecited elements or method steps. “Consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes any prior art embodiments.

Prior to describing the various embodiments, the following definitions are provided and should be used unless otherwise indicated.

Definitions

In describing the disclosed subject matter, the following terminology will be used in accordance with the definitions set forth below.

The term “fatty acid” (FA) refers to a carboxylic acid with a long aliphatic tail (chain), which is either saturated or unsaturated, and which is associated with (or a part of) a triacylglycerol. The term “free fatty acid” (FFA) refers to a carboxylic acid with a long aliphatic tail (chain), which is either saturated or unsaturated, and which is not associated with (or not a part of) a triacylglycerol. Fatty acids can be saturated fatty acids (SFA), short-chain saturated (SCSFA), medium-chain saturated (MCSFA), or unsaturated (UFA), with unsaturated fatty acids including monounsaturated (MUFA), polyunsaturated (PUFA), short-chain polyunsaturated fatty acids (SCPUFA), long-chain polyunsaturated fatty acids (LCPUFA), and the like.

As used in the present disclosure, the term “structured lipid” or “SL” refers to a triacylglycerol (TAG) or mixture of TAGs that is created in vitro, and where the TAG is modified from its natural form by changing the fatty acids and/or their position in the TAG. In embodiments of the present disclosure, an SL or mixture of SLs is synthesized to yield novel TAGs or mixture of TAGs with desired functional and nutritional properties. As used throughout the present disclosure, often the designation SL is used to refer to both a single TAG as well as a mixture of TAGs.

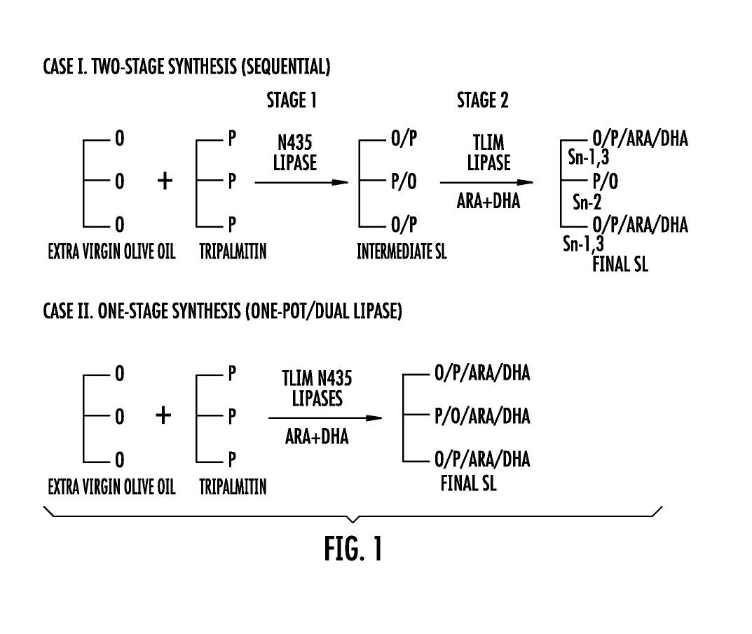

The term triacylglycerol” or “TAG” (also known as a triglyceride (TG)) refers to a lipid compound formed from a glycerol and three fatty acids. As discussed in the present disclosure, TAGs are described as having 3 positions, sn-1, sn-2, and sn-3, as illustrated in FIG. 1. Depending on the identity of the fatty acid at each position, different TAGs are given various abbreviations, including, but not limited the following: OAO, APA, OPD, ODO, LOL, LPL, MPL, POLn, SMM, OOL, POL, PLP, PPM, OOO, OPO, PPO, PPP, 00S, POS, PPS, DPD, SOO, PSO, DDD, MDD, C₈PD, DDO, PDD, PAA, PAD, MPD, PPD, LPA, C₁₀OO, C₁₀PP, SPD, OPA, PPA, MMP, POL, PPL, POO, PSO, MPP, SPP, LLO, LaPL, LaOL, LaMAl, C₈LaAl C₈LaL, DGD, GGD, DOD, GLD, OLD, SGD, PLD, LLG, OOD, POD, LOG, PLG, MOG, LaLO, OOG, LLP, POG, PLM, LaOP, MMP, MOP, SOO, SSO, LaCC, LaCla, LnDLn, LaLnLa, LaLaLa, LaMLa, OLaM, MLaM, LLL, MML, MMM, LnLnS LnOO, LOO, POP, OSO, OSP, PSP, MSS, SOS, PSS, and others listed in the tables of the Examples, below. In the foregoing abbreviations each letter represents a fatty acid, as follows: A is arachidonic acid (ARA) (C20:4 n-6), D is docosahexaenoic acid (DHA) (C22:6 n-3), L is linoleic acid (C18:2 n-6), Ln is linolenic acid (C18:3 n-3), M is myristic acid (C14:0), O is oleic acid (C18:1 n-9), P is palmitic acid (C16:0), S is stearic acid (C18:0), Al is alpha-linolenic acid (C18:3 n-3), C₈ is caprylic acid (C8:0), C₁₀ is capric acid (C10:0), G is Gamma-linolenic acid (C18:3 n-6), and La is lauric acid (C12:0). When specified, the first letter represents the fatty acid at sn-1 or 3, the middle letter represents the fatty acid at sn-2, and the third letter represents the fatty acid at sn-1 or 3, if specified, otherwise they may not be in regiospecific order.

The term “SL1-1” refers to a structured lipid mixture having the characteristics associated with the “SL1-1” designation in Table 1.2, Table 1.3, and/or Table 1.4 of Example 1. In some embodiments, a SL1-1 structured lipid mixture comprises, consists of, or consists essentially of a total (mol %) fatty acid composition shown in Table 1.2 of Example 1. In other or further embodiments, a SL1-1 structured lipid mixture comprises, consists of, or consists essentially of the triacylglycerol species shown in Table 1.3 of Example 1, where the TAGs are present in percent shown in Table 1.3+/−0.00-3.5%. In embodiments a SL1-1 structured lipid mixture is a structure lipid mixture synthesized using two-stage synthesis with substrate molar ratio 0.5:1:0.5 (TP:EVOO:AD).

The term “SL1-2” refers to a structured lipid mixture having the characteristics associated with the “SL1-2” designation in Table 1.2, Table 1.3, and/or Table 1.4 of Example 1. In some embodiments, a SL1-2 structured lipid mixture comprises, consists of, or consists essentially of a total (mol %) fatty acid composition shown in Table 1.2 of Example 1. In other or further embodiments, a SL1-2 structured lipid mixture comprises, consists of, or consists essentially of triacylglycerol species shown in Table 1.3 of Example 1, where the TAGs are present in the percent shown in Table 1.3+/−0.00-3.5%. In embodiments a SL1-2 structured lipid mixture is a structure lipid mixture synthesized using two-stage synthesis with substrate molar ratio 1:1:0.5 (TP:EVOO:AD).

The term “SL2-1” refers to a structured lipid mixture having the characteristics associated with the “SL2-1” designation in Table 1.2, Table 1.3, and/or Table 1.4 of Example 1. In some embodiments, a SL2-1 structured lipid mixture comprises, consists of, or consists essentially of a total (mol %) fatty acid composition shown in Table 1.2 of Example 1. In other or further embodiments, a SL2-1 structured lipid mixture comprises, consists of, or consists essentially of triacylglycerol species shown in Table 1.3 of Example 1, where the TAGs are present in the percent shown in Table 1.3+/−0.00-3.5%. In embodiments a SL2-1 structured lipid mixture is a structure lipid mixture synthesized using one-stage synthesis with substrate molar ratio 0.5:1:0.5 (TP:EVOO:AD).

The term “SL2-2” refers to a structured lipid mixture having the characteristics associated with the “SL1-1” designation in Table 1.2, Table 1.3, and/or Table 1.4 of Example 1. In some embodiments, a SL2-2 structured lipid mixture comprises, consists of, or consists essentially of a total (mol %) fatty acid composition shown in Table 1.2 of Example 1. In other or further embodiments, a SL2-2 structured lipid mixture comprises, consists of, or consists essentially of triacylglycerol species shown in Table 1.3 of Example 1, where the TAGs are present in the percent shown in Table 1.3+/−0.00-3.5%. In embodiments a SL2-2 structured lipid mixture is a structure lipid mixture synthesized using two-stage synthesis with substrate molar ratio 1:1:0.5 (TP:EVOO:AD).

The term “SL132” refers to a structured lipid mixture having the characteristics associated with the “SL132” designation in Table 2.2, Table 2.3, and/or Table 2.4 of Example 2. In some embodiments, a SL132 structured lipid mixture comprises, consists of, or consists essentially of a total (mol %) fatty acid composition shown in Table 2.2 of Example 2. In still other or further embodiments, a SL132 structured lipid mixture comprises, consists of, or consists essentially of a positional fatty acid profile as shown in Table 2.3 of Example 2. In still other or further embodiments, a SL132 structured lipid mixture comprises, consists of, or consists essentially of triacylglycerol species shown in Table 2.4 of Example 2, where the TAGs are present in the percent shown in Table 2.4+/−0.00-3.0%. In embodiments a SL132 structured lipid mixture is a structure lipid mixture synthesized with a substrate molar ratio 1:3:2 (TP:EVOOFFA:DHASCOFFA).

The term “SL142” refers to a structured lipid mixture having the characteristics associated with the “SL142” designation in Table 2.2, Table 2.3, and/or Table 2.4 of Example 2. In some embodiments, a SL142 structured lipid mixture comprises, consists of, or consists essentially of a total (mol %) fatty acid composition shown in Table 2.2 of Example 2. In still other or further embodiments, a SL142 structured lipid mixture comprises, consists of, or consists essentially of a positional fatty acid profile as shown in Table 2.3 of Example 2. In still other or further embodiments, a SL142 structured lipid mixture comprises, consists of, or consists essentially of triacylglycerol species shown in Table 2.4 of Example 2, where the TAGs are present in the percent shown in Table 2.4+/−0.00-3.0%. In embodiments a SL142 structured lipid mixture is a structure lipid mixture synthesized with a substrate molar ratio 1:4:2 (TP:EVOOFFA:DHASCOFFA).

The term “SL151” refers to a structured lipid mixture having the characteristics associated with the “SL151” designation in Table 2.2, Table 2.3, and/or Table 2.4 of Example 2. In some embodiments, a SL151 structured lipid mixture comprises, consists of, or consists essentially of a total (mol %) fatty acid composition shown in Table 2.2 of Example 2. In still other or further embodiments, a SL151 structured lipid mixture comprises, consists of, or consists essentially of a positional fatty acid profile as shown in Table 2.3 of Example 2. In still other or further embodiments, a SL151 structured lipid mixture comprises, consists of, or consists essentially of triacylglycerol species shown in Table 2.4 of Example 2, where the TAGs are present in the percent shown in Table 2.4+/−0.00-3.0%. In embodiments a SL151 structured lipid mixture is a structure lipid mixture synthesized with a substrate molar ratio 1:5:1 (TP:EVOOFFA:DHASCOFFA).

The term “SL3” refers to a structured lipid mixture having a characteristic associated with the “SL” designation in Table 3.6 of Example 3. In some embodiments, a SL3 structured lipid mixture comprises, consists of, or consists essentially of a total (mol %) fatty acid composition shown in Table 3.6 of Example 3. In still other or further embodiments, a SL3 structured lipid mixture comprises, consists of, or consists essentially of a positional fatty acid profile as shown in Table 3.6 of Example 3. In one embodiment, the SL3 structured lipid mixture comprises approximately 43% palmitic acid.

The terms “SL5” and “TDA-SL” are used interchangeably herein and refer to a structured lipid mixture having a characteristic associated with the “SL” designation in Table 3.1 and/or Table 3.2 of Example 5 and/or a structured lipid mixture having a characteristic associated with the “TDA-SL” designation in Table 4.1 of Example 4. In some embodiments, a SL5 or TDA-SL structured lipid mixture comprises, consists of, or consists essentially of a total (mol %) fatty acid composition shown in Table 5.1 of Example 5 (SL) and/or Table 4.1 of Example 4 (TDA-SL), +/−0.00-3.0% . In still other or further embodiments, a SL5 or TDA-SL structured lipid mixture comprises, consists of, or consists essentially of triacylglycerol species shown in Table 5.2 of Example 5 (SL) and/or Table 4.1 of Example 4 (TDA-SL), where the TAGs are present in the percent shown in Table 4, +/−0.00-3.0%.

The terms “SL6” and “PDG-SL” are used interchangeably herein and refer to a structured lipid mixture having a characteristic associated with the “SL” designation in Table 6.3 and/or Table 6.4 of Example 6 and/or the “PDG-SL” designation in Table 4.1 of Example 4. In some embodiments, a SL6 or PDG-SL structured lipid mixture comprises, consists of, or consists essentially of a total (mol %) fatty acid composition shown in Table 6.3 of Example 6 (SL) and/or Table 4.1 of Example 4 (PDG-SL), +/−0.00-3.0%. In still other or further embodiments, a SL6 or PDG-SL structured lipid mixture comprises, consists of, or consists essentially of triacylglycerol species shown in Table 6.4 of Example 6 (SL) and/or Table 4.1 of Example 4 (PDG-SL), +/−0.00-3.0%.

The term “SL7” refers to a structured lipid mixture having the characteristics associated with the “SLs” designation in Table 7.2 and/or Table 7.3 of Example 7. In some embodiments, a SL7 structured lipid mixture comprises, consists of, or consists essentially of a total (mol %) fatty acid composition shown in Table 7.2 of Example 7. In other or further embodiments, a SL7 structured lipid mixture comprises, consists of, or consists essentially of triacylglycerol species shown in Table 7.3 of Example 7, where the TAGs are present in the percent shown in Table 7.3+/−0.00-3.5%. In embodiments a SL7 structured lipid mixture is a structure lipid mixture synthesized with a substrate molar ratio (TP:ROO:DHASCO-EE/GLAEE) selected from 1:1-5:1-2.

As used herein the term “substrate mole ratio” refers to the ratio of substrate oil (e.g., olive oil, palm olein, trimpalmitin) to free fatty acid (FFA) in the reaction compounds used to make the SL mixtures of the present disclosure. However, in Example 5 below, the substrate mole ratio is reversed with the free fatty acid (FFA) or fatty acid ethyl ether (FAEE) as substrate, such that the substrate mole ratio is the ratio of FFA or FAEE (e.g., DHA and/or ARA free fatty acids, or fatty acid ethyl ethers) to the palmitic acid source (e.g., tripalmitin).

As used herein, “isolated” indicates removed or separated from the native environment. Therefore, an isolated peptide, enzyme, lipid, or other molecule indicates the protein is separated from its natural environment. Isolated nucleotide sequences and/or proteins are not necessarily purified. For instance, an isolated nucleotide or peptide may be included in a crude cellular extract or they may be subjected to additional purification and separation steps.

It is advantageous for some purposes that a molecule or compound is in purified form. The term “purified” in reference to compounds of the present disclosure (such as fatty acids, TAGs, etc.) represents that the compound has increased purity relative to the natural environment.

### Description

The embodiments of the present disclosure encompass compositions of a mixture structured lipids, products containing structured lipids of the present disclosure, infant formulas including structured lipids of the present disclosure, methods of making mixtures of structured lipids, and methods of making powders, infant formulas, and other products including the mixtures of structured lipids of the present disclosure. The mixtures of structured lipids provided herein contain increased amounts of palmitic acid at the sn-2 position, as compared to physical mixtures of lipids (TAGs) found in commercial infant formulas, and other essential fatty acids at the sn-1 and sn-3 positions, making the mixtures an improved nutrition source when added to products such as infant formula.

Lipids (usually TAGs) that have been structurally modified from their natural form by changing the fatty acids and/or their position, or synthesized to yield novel TAGs with desired functional and nutritional properties are called structured lipids (SLs). Positional specific TAGs suitable as infant formula fats analogs can be synthesized using lipases which are regio-and stereospecific. SLs containing palmitic acid at the sn-2 position are an excellent substrate for infant formula. Betapol® (Loders Croklaan, Chanhannon, Ill.) was the first commercially available enzymatically synthesized SL for use in infant formulas. Although Betapol has palmitic acid, it lacks long-chain polyunsaturated fatty acids (LCPUFAs). SLs and mixtures of SLs with palmitic acid at the sn-2 position and also enriched with LCPUFAs are desirable for optimal growth and development of the infant.

SLs can be produced with a single lipase, and symmetrical SLs can be produced using a two-step process with sequential addition of nonspecific and/or sn-1,3 specific lipases [115, 121, 87, 133, 104, 130]. First, the acyl moiety at the sn-2 position is modified followed by sn-1,3 regioselective acylations. Few studies have been done on simultaneous use of multiple lipases for SL synthesis. Ibrahim et al., used a dual lipase system for interesterification of palm stearin and coconut oil [45]. Tiirkan and Kalay also mentioned the use of dual lipase reaction system instead of a single enzymatic system in biodiesel production [35]. However, it is believed that a simultaneous dual lipase system for production of SL with increased palmitic acid at the sn-2 position has not been previously described. Furthermore, oils such as olive oil, and combinations of oils, such as palm olein, olive oil, tripalmitin, and free fatty acids (e.g., DHA and/or ARA, etc.) have not been used as substrates for making mixtures of SLs with a high percentage of palmitic acid at the sn-2 position and with high incorporation of DHA and ARA.

Accordingly, the present disclosure provides mixtures of structured lipids and methods of making mixtures of structured lipids, as well as products and methods of making products including the mixtures of SLs of the present disclosure. Such mixtures of SLs are useful for providing infant formulas with a better absorption profile for palmitic acid, calcium, and other important fatty acids.

Mixtures of Structured Lipids

Embodiments of the present disclosure provide compositions including a mixture of structured lipids. In embodiments the SL mixture includes TAGs with an increased percentage of palmitic acid at the sn-2 position of the TAG, as compared to the substrate oil used to make the SL mixture and/or compared to the percentage of palmitic acid at the sn-2 position of TAGs found in conventional, commercially available infant formula. Thus, in embodiments, the compositions of the present disclosure include a mixture of SLs where at least a portion of the SLs (TAGs) in the SL mixture have palmitic acid at a sn-2 position.

In embodiments, the compositions of the present disclosure include an SL mixture where the mixture is selected from SL1-1, SL1-2, SL2-1, SL2-2, SL132, SL142, SL151, TDA-SL, PDG-SL, SL3, SLS, SL6, SL7, or combinations of these. The SL mixtures of the present discloosure provide an advantage over conventional SLs in the prior art by having an increased percentage of palmitic acid at the sn-2 position of the triacylglycerol. In embodiments, the SL mixtures of the present disclosure include a total mol % of palmitic acid of about 30% or more. In some embodiments, the SL mixtures of the present disclosure can include a total mol % of palmitic acid (mol % of total fatty acids) of about 20 to 60%.

In the embodiments of compositions of the present disclosure, the mol % of palmitic acid at the sn-2 position can be described as a mole percent with respect to the total fatty acids in the SL mixture (mol % of total fatty acids), or with respect to the total palmitic acid in the SL mixture (mol % of total palmitic acid). In some embodiments, with respect to the mol % of total fatty acids in the SL mixture, the compositions can include a SL mixture having a mol % of palmitic acid (mol % of total fatty acids) at a sn-2 position of about 13 to 30%. In embodiments, the mol % of palmitic acid at the sn-2 position can be about 17 to 25% (mol % of total fatty acids). Thus, in embodiments, the SL mixtures of the present disclosure can include about 17%, 18%, 19%, 20%, 21%, 22%, 23%, 24% or 25% (and intermediate ranges and percentages) palmitic acid esterified at a sn-2 position (mol % of total fatty acids). In some embodiments, with respect to the mol % of total palmitic acid in the SL mixture, the SL mixtures can have about 30% or more palmitic acid (mol % of total palmitic acid) at sn-2. The SL mixtures of the present disclosure, in some embodiments, can include about 30 to 65% palmitic acid esterified at the sn-2 position (mol % of total palmitic acid). Thus, in embodiments, the structured lipid mixtures can have about 30%, 35%, 40%, 45%, 50%, 55%, 60% or 65% (and intermediate ranges and percentages) palmitic acid esterified at a sn-2 position (mol % of total palmitic acid). In embodiments, the SL mixtures can have about 50% or more palmitic acid (mol % of total palmitic acid) at the sn-2 position.

In some embodiments, these SL compositions of the present disclosure can further include one or more fatty acids selected from docosahexaenoic acid (DHA), arachidonic acid (ARA), palmitic acid, and gamma-linolenic acid (GLA). In embodiments, some of these fatty acids are incorporated in the TAGs of the SL mixtures at the sn-1, sn-2, and/or sn-3 positions of the triacylglycerol. In embodiments, the SL mixtures include one or more LCPUFAs in the TAGs of the SL mixture. In embodiments the LCPUFAs are selected from docosahexaenoic acid (DHA), and gamma-linolenic acid (GLA), and arachidonic acid (ARA). In addition to those mentioned above, other fatty acids that may be included in the SL mixture (present at any one of the sn positions of the TAGs) of the compositions of the present disclosure include, but are not limited to, linoleic acid, linolenic acid, myristic acid, oleic acid, stearic acid, alpha-linolenic acid (ALA), caprylic acid, capric acid, and lauric acid. In some embodiments, the SL compositions of the present disclosure can include about 1-15% ARA and/or about 1-10% DHA, and/or about 1-7% GLA.

The SL compositions of the present disclosure include SL mixtures produced by reacting at least one substrate oil with at least one free fatty acid compound and at least one lipase. The lipase can be a non-specific lipase, an sn-1,3 specific lipase, or a combination of both. If two lipases are used, the reaction may be conducted in a one step or a two-step process, as described in more detail in Example 1, below. An embodiment of the non-specific lipase is Novozym 435. In embodiments, the sn-1,3 specific lipase is Lipozyme TL IM. In embodiments, the substrate oil includes one or more substrate oils selected from olive oil (either extra virgin olive oil (EVOO) or refined olive oil), tripalmitin, and palm olein oil. In embodiments, the oils are unmodified, but in other embodiments, the fatty acids are first extracted/isolated from the oils prior to reaction with the free fatty acid compound and lipase, as described in the methods and examples, below. In embodiments, the free fatty acid compounds are selected from compounds including oils, free fatty acids, and/or fatty acid ethyl ethers of DHA, ARA, and/or GLA. In embodiments, just one free fatty acid is used, but in other one or more free fatty acids may be included in the mixture in various ratios.

The present disclosure also includes products that include the SL mixtures described above. In embodiments, the products include a SL mixture of the present disclosure in a powdered formulation. In embodiments, the SL mixture of the present disclosure as described above is prepared in a powder formulation by spray drying processes, such as described in the examples below. In embodiments, the SL mixtures are microencapsulated in a combination of protein and carbohydrate. In embodiments, the powdered SL mixtures have a microencapsulation efficiency of about 80% or more. In embodiments, the SL powders have a microencapsulation efficiency of about 90%. In embodiments, the moisture content of the powdered SL mixtures is less than about 4%. In embodiments, the moisture content is from about 1-2%. In embodiments, the powdered SL mixtures have a water activity (a_{w}) of about 0.10-0.25. In some embodiments, the powdered SL mixtures have a water activity of about 0.15 to 0.16. In embodiments, the powdered formulation is spray-dried. Embodiments of SL powders of the present disclosure also have other characteristics such as rapid dispersibility and high oxidative stability as discussed in Example 4.

In embodiments, the present disclosure includes infant formulas including the SL mixtures of the present disclosure. In embodiments, the infant formulas include powdered formulations of SL mixtures of the present disclosure.

Methods of Making SL Mixtures

The present disclosure also provides methods of making the mixtures of structured lipids of the present disclosure. Briefly described, in embodiments, the methods include 1) providing one or more substrate oils, 2) providing one or more free fatty acid compounds, and 3) reacting the one or more substrate oils and the one or more free fatty acids with one or more lipases to form a mixture of SLs having at least a portion of palmitic acid at a sn-2 position.

In embodiments, the one or more substrate oils can be selected from tripalmitin, olive oil (EVOO, refined, etc.), and palm olein oil. In some embodiments, at least one substrate oil is tripalmitin. In some embodiments, at least one substrate oil is olive oil. In some embodiments, the substrate oil includes a combination of tripalmitin and olive oil. In embodiments, the olive oil is refined olive oil (ROO), and in other embodiments the olive oil is EVOO. In embodiments, the substrate oil includes a combination of tripalmitin and palm olein. In other embodiments, additional combinations of one or more substrate oils may be used. In some embodiments, fatty acids are extracted/isolated from the oil substrates prior to reaction. In some embodiments, a substrate oil, such as, but not limited to, olive oil and/or palm olein oil is mixed with tripalmitic acid (e.g., extracted from a high tripalmitin containing oil) to form the substrate oil.

In embodiments, the free fatty acid compounds are selected from fatty acid oils, free fatty acids (FFA), and fatty acid ethyl esters (FAEE, or sometimes EE) of compounds including docosahexaenoic acid (DHA), arachidonic acid (ARA), gamma-linolenic acid (GLA), and the like, and combinations of these. In embodiments the free fatty acid compounds are prepared from oils including the desired fatty acids (e.g., docosahexaenoic acid single cell oil (DHASCO), such as from algae Crypthecodinium cohnii; ARA-rich single cell oil (ARASCO), such as from fungus Mortierella alpina). In some embodiments, the free fatty acid compounds include free fatty acids and/or fatty acid ethyl esters extracted/isolated from a fatty acid oil as described in the Examples below (e.g., DHA-FFA, ALA-FFA, GLA-FFA, DHA-FAEE, ALA-FAEE, and GLA-FAEE). In some embodiments where the FFA compound includes both DHA and ARA, the ratio of ARA/DHA (also described herein as n-6/n-3) is about 2-5.

In embodiments, the lipases include one or more non-specific lipase and/or one or more sn-1,3 specific lipase. In embodiment, the method includes at least one non-specific lipase and at least one sn-1,3 specific lipase. In some embodiments, the one or more non-specific and/or sn-1,3 specific lipases can be selected from Novozym 435 and Lipozyme TL IM. Novozym 435 is a non-specific lipase and Lipozyme TL IM is a sn-1,3 specific lipase. In some embodiments, both Novozym 435 and Lipozyme TL IM are reacted with the substrate oils and free fatty acid compounds. In embodiments including both non-specific and sn-1,3 specific lipases, both non-specific and sn-1,3 specific lipases can react with the oils and FFA simultaneously (a one-stage process), or both lipases can react with the oils sequentially, in a two-stage process. In some embodiments where the two-stage process is used, the substrate oils are reacted first with the non-specific lipase to produce an intermediate SL mixture, and then the intermediate SL mixture is reacted with the one or more free fatty acid compounds and the sn-1,3 specific lipase to produce a final SL mixture.

In embodiments, the methods of the present disclosure produce SL mixtures having one or more of the characteristics described above for SL mixtures of the present disclosure, such as total mol percent palmitic acid, mol percent palmitic acid at the sn-2 position, and the like. Some of these characteristics can be manipulated by changing the amounts or ratios of reactants and/or the reaction conditions.

In embodiments, the reaction time for the method of making the SL mixtures of the present disclosure is about 4-36 hours, in some embodiments the reaction time is about 4-24 hours, and in some embodiments, the reaction time is about 6-36 hours. In embodiments where a two-stage reaction is used, the reaction time for the first stage is about 6-12 hours, and the reaction time for the second stage is about 6-12 hours. In embodiments, the reaction time for each stage is about 6 hours. In embodiments, the reaction is carried out at a temperature of about 50-75° C. In embodiments, the reaction is carried out at a temperature of about 60° C.

In embodiments, the substrate oil(s) and the FFA compound are combined in a substrate mole ratio of substrate oil to FFA of about 1-14 (mol/mol). In embodiments, the substrate oil includes a combination of olive oil/tripalmitin or palm olein/tripalmitin and the free fatty acid compound includes one or more FFA or FAEEs of DHA, ARA, and/or GLA, and the substrate mole ratio of oil: FFA/FAEE is about 1 to about 10. In embodiments, the substrate oil includes olive oil and tripalmitin and the FFA compound includes a combination of DHA-FFA and ARA-FFA, in a substrate mole ratio olive oil: tripalmitin: FFA (DHA and/or ARA) of about 0.5-1:1:0.5-1, as described, for instance, in Example 1. In other embodiments, the substrate oil includes olive oil and tripalmitin, and the FFA compound includes a combination of DHA-FAEE and GLA-FAEE (also referred to as DHASCO-EE and GLAEE, such as in Example 7), combined in a substrate mole ratio of tripalmitin: olive oil: FAEE (DHA/ARA) of 1:1-5:1-2. In some such embodiments the substrate mole ratio of tripalmitin: olive oil: FAEE (DHA/GLA) is selected from 1:1:1, 1:2:1, 1:3:2, 1:4:2, 1:5:2, and 1:5:1, as described, for instance, in Example 7.

In yet other embodiments, the substrate oil is tripalmitin or oil mixture and the FFA compound is selected from FFAs and/or FAEEs of DHA and ARA, and the substrate mole ratio of acyl donors (FFAs and/or FAEEs) to tripalmitin/oil is from about 14-0.5. In some such embodiments, the substrate mole ratio of FFA/FAEE to tripalmitin is about 6-18 (mol/mol). In some such embodiments, the substrate mole ratio of FFA/FAEE: tripalmitin is about 9:1, as described for instance in Example 5.

Methods of the present disclosure also include methods of making powder formulations of the SL mixtures of the present disclosure. In embodiments of making SL powder formulations of the present disclosure, SL mixtures of the present disclosure are made according to the methods described herein and are then microencapsulated with a mixture of protein and carbohydrate. In embodiments, a mixture of protein and carbohydrate is made and then the SL oil mixture is dispersed into the protein/carbohydrate mixture by mechanical mixing (e.g., with a homogenizer) to form an emulsion. In embodiments, the emulsion is then spray-dried to form a powder of microencapsulated SLs. In embodiments, the protein can be, but is not limited to, whey protein, gelatin, etc. In embodiments, the carbohydrate can be, but is not limited to, corn syrup solid, cyclodextrin, maltodextrin, carboxymethyl cellulose (CMC), chitosan, gum Arabic, sodium alginate, pectin, milk protein in combination with carbohydrates, Maillard reaction products (MRP, amino acids plus reducing sugars), etc. In some embodiments, the protein/carbohydrate mixture is heated and then cooled before the addition of the SL mixture. In embodiments, the protein carbohydrate mixture is heated to about 70-100° C. (in some embodiments to about 90° C.) and then cooled to a temperature of about 50-65° C. (in some embodiments, to about 60° C.). In embodiments, the emulsion is formed by mixing in a homogenizer. In embodiments, the SL mixture and protein/carbohydrate mixture is homogenized at about 10-35 MPa. In some embodiments, the emulsion is heated to a temperature of about 50-65° C. (in embodiments, to about 60° C.) prior to spray drying. In embodiments, the emulsion is spray-dried at a higher inlet temperature than outlet temperature. In embodiments, the emulsion has a inlet temperature of about 175-185° C. (in some embodiments about 180° C.) and an outlet temperature of about 70-85° C. (in some embodiments about 80° C.).

In embodiments, methods of the present disclosure also include methods of making infant formulas using the SL mixtures of the present disclosure. In embodiments, methods include making powder formulations of the SL mixtures and using these powders to make infant formulas. In embodiments, the infant formulas are powdered infant formulas and are made by combining the SL powder formulations of the present disclosure with other infant formula ingredients to form a powdered infant formula.

Additional details regarding the methods and compositions of the present disclosure are provided in the Examples below. The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and protected by the following embodiments.

The following examples are put forth so as to provide those of ordinary skill in the art with a complete disclosure and description of how to perform the methods and use the compositions and compounds disclosed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

### Enzymatic Synthesis of Extra Virgin Olive Oil-Based Infant Formula Fat Analogs Containing ARA and DHA: One-Stage and Two-Stage Syntheses

### Materials and Methods

Materials. Extra virgin olive oil (EVOO) was provided by Al Jouf Agricultural Development Corporation (Al-Jouf Skaka, Saudi Arabia) while DHA-containing single cell oil (DHASCO®, 40% DHA) from algal Crypthecodinium cohnii and ARA-rich single cell oil (ARASCO®, 40% ARA) from fungal Mortierella alpina, were provided by DSM Nutritional Products-Martek (Columbia, Md.). The immobilized enzymes, Lipozyme° TLIM (Thermomyces lanuginosus lipase, sn-1,3 specific, specific activity 250 IUN/g: IUN=Interesterification Unit) and Novozym° 435 (Candida antarctica lipase, non-specific, specific activity 10,000 PLU/g: PLU=Propyl Laurate Unit) were purchased from Novozymes North America Inc. (Franklinton, N.C.). Lipid Standards Supelco 37 Component FAME mix, tocopherol standards, 2-oleoylglycerol, pinoresinol, gallic, ferulic, p-coumaric, and caffeic acids were purchased from Sigma-Aldrich Chemical Co. (St. Louis, Mo.). Hydroxytyrosol was purchased from Cayman Chemical Company (Ann Arbor, Mich.). Vanillic acid and tyrosol were obtained from Oakwood Products Inc. (West Columbia, S.C.). Luteolin and oleuropein were purchased from Indofine Chemical Company (Hillsborough, N.J.). Tripalmitin and pentadecanoic acid was procured from TCI America (Portland, Oreg.). The TAG standard mix (GLC-437) was purchased from Nu-chek Prep, Inc. (Elysian, Minn.). Other solvents and chemicals were from Fisher Scientific (Norcross, GA) and Sigma-Aldrich Chemical Co.

Preparation of Free Fatty Acids (FFAs) from ARASCO and DHASCO by Saponification. Saponification value (SV) was calculated based on AOCS Official Method Cd 3a-94²⁰. Fatty acid profile was used to calculate the molecular weight (MW) of the substrates. MW (g/mol) of ARASCO and DHASCO were 912.69 and 881.30, respectively. The SV (mg KOH/g) of ARASCO and DHASCO were 183.67 and 186.18, respectively. FFAs were prepared according to a previously described method [see reference 140, which is hereby incorporated by reference herein for the preparation of FFAs]. One hundred and fifty grams of oil was saponified using a mixture of KOH (based on the calculated SV), water (66 mL), 95% ethanol (396 mL), and butylated hydroxytoluene (0.03 g) by placing them in a 1 L stir-batch reactor with a circulating water bath at 60° C. for 1 h. After 1 h, 200 mL of distilled water was added to the saponified mixture and the unsaponifiable matter was extracted into hexane (2×200 mL). The hexane layer was discarded and the aqueous layer containing saponifiable matter was then acidified with 10 N HCl to a pH of 1-2 (separation of two phases). A separatory funnel was used to extract the top FFA layer into 200 mL hexane. The hexane layer was filtered through an anhydrous sodium sulfate column to remove any excess water. Hexane was removed with a Biichi rotovapor (Flawil, Switzerland) at 40° C. and 50 rpm speed until constant weight was obtained. The FFAs (ARASCO-FFA and DHASCO-FFA) were mixed in the ratio of 2:1 w/w and flushed with nitrogen. This 2:1 ARASCO-FFA: DHASCO-FFA mixture was termed AD and stored at −80° C. in amber Nalgene bottle until use.

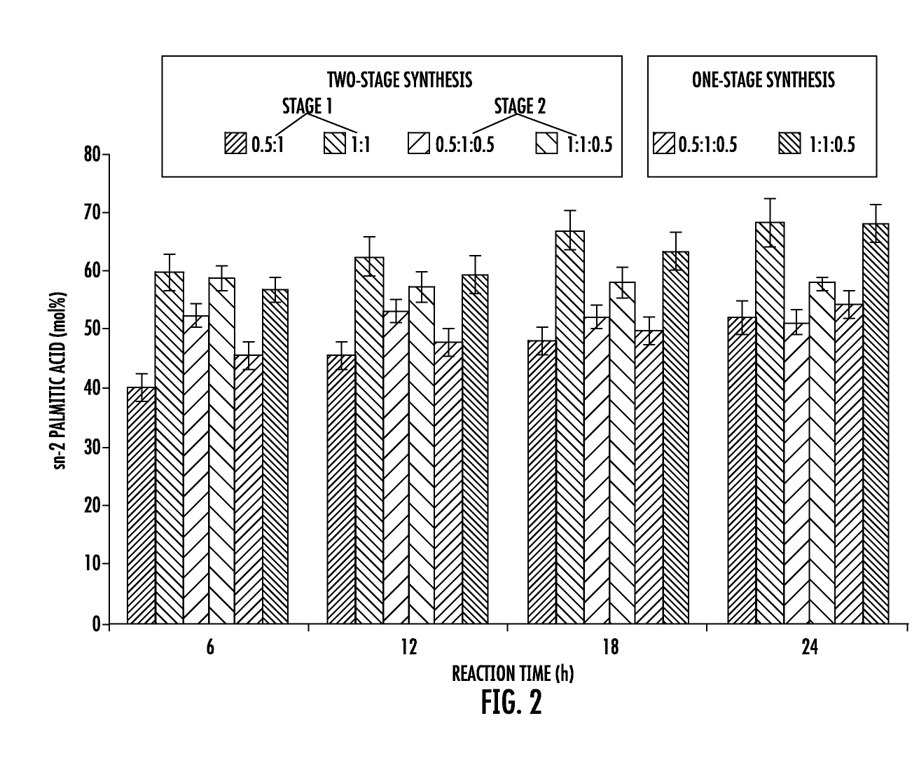

SL Synthesis. SLs were synthesized in Erlenmeyer flasks in a solvent free environment. Two types of reaction schemes were used (FIG. 1). Two-stage synthesis (case I) involved a sequential two-stage SL synthesis. In the first stage tripalmitin and EVOO were reacted in the presence of Novozym 435. Novozym 435 which is mostly considered as a non-specific lipase was used in the first stage with the aim of increasing palmitic acid at the sn-2 position of EVOO TAGs. The product of the first stage was then filtered (to remove enzyme) and AD (ARASCO-FFA and DHASCO-FFA, 2:1) was added. The acidolysis reaction was then catalyzed by Lipozyme TL IM, a sn-1,3 specific lipase, to incorporate ARA and DHA into the TAG structure while conserving the palmitic acid at the sn-2 position. In one-stage synthesis (case II), tripalmitin, EVOO, and AD were reacted together in the presence of Lipozyme TL IM and Novozym 435 lipases. The aim was to achieve similar product as in case I and to determine if the dual enzyme system had any synergistic effect. Carrying out multiple reactions (interesterification and acidolysis) simultaneously in the presence of dual biocatalysts may help reduce the reaction time, eliminate intermediate purification steps, and result in an improved SL synthesis process. The substrate molar ratios (tripalmitin:EVOO:AD) used were 0.5:1:0.5 and 1:1:0.5. The reaction temperature was fixed at 60° C. Preliminary small-scale reactions were performed at 6, 12, 18, and 24 h for reaction time selection. sn-2 Palmitic acid of the small-scale products are shown in FIG. 2. The following conditions were selected for scale-up:

Case I. Two-Stage (Sequential) Synthesis SL1-1—structured lipid synthesized using two-stage synthesis, with a substrate molar ratio of 0.5:1 (tripalmitin:EVOO) and the incubation was 24 h using Novozym 435 as biocatalyst. The reaction product was filtered to remove the lipase. No further purification was done prior to the addition of the second lipase. The product was then reacted with AD for 6 h in the presence of Lipozyme TL IM lipase. The final ratio was 0.5:1:0.5 (tripalmitin:EVOO:AD).

SL1-2—synthesized using a two-stage synthesis, similar to SL1-1 except a substrate molar ratio of 1:1:0.5 (tripalmitin:EVOO:AD) was used and the run time for both first and second stage was 6 h each.

Case II. One-Stage (One-Pot) Synthesis

SL2-1—One-stage synthesis with a substrate molar ratio of 0.5:1:0.5 (tripalmitin:EVOO:AD). The reaction time was 24 h using Novozym 435 and Lipozyme TL IM lipases as biocatalysts.

SL2-2—One stage synthesis where the substrate molar ratio used was 1:1:0.5 (tripalmitin:EVOO:AD) for 6 h using Novozym 435 and Lipozyme TL IM lipases as biocatalysts.

Each enzyme was added at 10% of the total weight of substrates. The Erlenmeyer flasks were kept in water bath shaker at 200 rpm for the specified time and temperature. After the reaction, the extra FFAs were removed through deacidification by alkaline extraction method [Reference 67, which is hereby incorporated by reference for the alkaline extraction method] and the purified SLs were stored at −20° C. until analysis.

Total and Positional Fatty Acids. Lipid samples were converted to fatty acid methyl esters following the AOAC Official Method 996.01 [95, which is hereby incorporated by reference herein] and analyzed with a Hewlett-Packard 6890 series II gas chromatograph (Agilent Technologies Inc., Palo Alto, Calif.) using a Supelco SP-2560, 100 m×25 mm×0.2 um column. sn-2 Positional fatty acid composition was determined following the AOCS Official Method Ch 3-91 [see 94, which is hereby incorporated by reference herein]. Fatty acid composition at the sn-1,3 position can be calculated using the following equation:

sn-1,3(%)=[3×total(%)−sn-2 (%)]/2.

All experiments were conducted in triplicate and average values reported.

Triacylglycerol (TAG) Molecular Species. The TAG composition was determined with a high-performance liquid chromatograph (HPLC) (Agilent Technologies 1260 Infinity, Santa Clara, Calif.) equipped with a Sedex 85 evaporative light scattering detector (ELSD) (Richard Scientific, Novato, Calif.). A Beckman Ultrasphere® C18 column, 5 μm, 4.6×250 mm was used with temperature set at 30° C. The injection volume was 20 μL. The mobile phase at a flow rate of 1 mL/min included solvent A, acetonitrile and solvent B, acetone:methyl tert butyl ether (90:10, v/v). A gradient elution was used starting with 35% solvent A to 5% solvent A at 42 min and then returning to the original composition in 3 min. Drift tube temperature was set at 50° C., pressure at 4.0 bar and gain at 8. The samples were dissolved in chloroform with final concentration of 5 mg/mL. The TAG peaks were identified by comparison of retention times with those of the standards and also by equivalent carbon number (ECN). ECN is defined as CN-2n, where CN is the number of carbons in the TAG (excluding the three in the glycerol backbone) and n is the number of double bonds. Triplicate determinations were made and averaged.

Tocopherols. HPLC (Shimadzu LC-6A pump equipped with an RF-10AXL fluorescence detector with excitation set at 290 nm and emission at 330 nm (Shimadzu Corp., Columbia, Md.)) was used for tocopherol analysis. An isocratic mobile phase of 0.85% (v/v) isopropanol in hexane was used at a flow rate of 1.0 mL/min. The normal phase column was a LiChrosorb Si 60 column (4 mm, 250 mm, 5 μm particle size, Hiber Fertigsaeule RT, Merck, Darmstadt, Germany). The sample concentration was 20 mg/mL in HPLC-grade hexane. Injection volume was 20 μL. The tocopherols were identified by comparing their retention times with those of authentic standards (1.25-20 μg/mL in hexane containing 0.01% butylated hydroxytoluene). Tocopherols were quantified based on the standard calibration curves and reported as μg/g from the average of triplicate determinations.

Major Phenolic Compounds. Phenolics were extracted with methanol, water, and acetonitrile using solid phase extraction [26, which is hereby incorporated by reference herein]. Major phenolic compounds were determined following the method described by Owen et al. [97, which is hereby incorporated by reference herein] using a Hewlett-Packard (Avondale, Pa.) HP 1100 HPLC system with diode array detector. The column was Beckman Ultrasphere® C18, 5 μm, 4.6×250 mm with temperature set at 40° C. The injection volume was 20 μL. The mobile phase consisted of solvent A, 2% acetic acid in water and solvent B, methanol at a flow rate of 1 mL/min. Gradient elution was as follows: at 2 min 5% solvent B, 10 min 25% B, 20 min 40% B, 30 min 50% B, and 100% B at 45 min. Detection was done at 260, 280, 320, and 360 nm. Identification was based on the retention times and characteristic UV spectra and quantification was done using the external standard curves. All analysis was performed in triplicates and average reported.

Melting and Crystallization Profiles. The melting and crystallization profiles were determined using a differential scanning calorimeter DSC 204 Fl Phoenix (NETZSCH Instruments North America, Burlington, Mass.) following AOCS Official Method Cj 1-94 [94]. 10-12 mg samples were weighed into aluminum pans and hermetically sealed. Samples were rapidly heated to 80° C. at 20° C. /min, and held for 15 min to destroy any previous crystalline structure. The samples were then cooled to −75° C. at 5° C./min (exotherms), held for 30 min and finally heated to 80° C. at 5° C./min (endotherms). Nitrogen was used as the protective and purge gas. All samples were analyzed in triplicates and average values reported.

Statistical Analysis. All analyses were performed in triplicate. Statistical analysis was performed with the SAS software package (SAS Institute, Cary, N.C.). Duncan's multiple-range test was performed to determine the significant difference (P≦0.05) between SLs.

### Results and Discussions

Total and Positional Fatty Acid Profiles. Table 1.1 shows the total and positional fatty acids of the substrates. The major fatty acids in EVOO were oleic (67.81 mol %) and palmitic acids (16.02 mol %). Tripalmitin contained 98.90 mol % palmitic acid. The major fatty acids in DHASCO-FFA were DHA (44.13 mol %), oleic (22.17 mol %), and myristic (10.30 mol %) acids and in ARASCO-FFA, ARA (43.22 mol %) and oleic acid (20.52 mol %) were the main fatty acids. In SL1-1, oleic (43.22 mol %) and palmitic (36.69 mol %) acids were the major fatty acids (Table 1.2). The main fatty acids in human milk are oleic (28.30-43.83%), palmitic (15.43-24.46%), and linoleic (10.61-25.30%) acids. SL1-1 and SL1-2 had 3.67 and 2.97 mol % ARA, respectively, and 1.53 and 1.39 mol % DHA, respectively. On the other hand, SL2-1 had 6.23 mol % ARA and 3.71 mol % DHA. 5.95 mol % ARA and 2.60 mol % DHA were incorporated in SL2-2. ARA and DHA are important fatty acids in infancy as they support brain development and improve visual acuity. A lower n-6/n-3 ratio is desirable for reducing the risk of several chronic diseases. SL1-1, SL1-2, SL2-1, and SL2-2 n-6/n-3 ratios were 4.72, 4.45, 2.78, and 3.14, respectively.

TAGs containing high sn-2 palmitic acid are preferred in human milk fat analogs as it helps in fat digestion and absorption. All the SLs had >50% palmitic acid at sn-2 position. sn-2 Palmitic acid increased from 2.31 mol % in EVOO (Table 1.1) to 52.67, 56.25, 50.33, and 55.34 mol % in SL1-1, SL1-2, SL2-1, and SL2-2, respectively (Table 1.2). The SLs were also enriched with DHA and ARA at the sn-2 position where they can be better metabolized. Higher level of DHA were found in the brain of newborn rats fed with oils containing DHA at the sn-2 position than those fed with oils containing randomly distributed DHA.

Although Lipozyme TL IM is an sn-1,3 specific enzyme, some ARA and DHA were also esterified to the second position of the TAGs in the two-stage synthesis (SL1-1 and SL1-2) where both enzymes were added separately and sequentially. This may be attributed to acyl migration. Acyl migration is an undesirable side reaction involving migration of acyl groups from sn-1,3 to sn-2 positions and vice versa, but in this case it was desirable since fatty acids at sn-2 positions are better absorbed. Acyl migration mainly occurs due to the presence of partial acylglycerols, specifically diacylglycerols, which are the intermediates in enzymatic interesterification reactions³¹. Acyl migration can be affected by a number of factors. Acyl migration increases with increase in reaction temperature, run time, water content, and water activity. The type of enzyme and its carrier also can have an effect on acyl migration. It has also been observed that the tendency to migrate increases with increasing unsaturation in fatty acids. In one-stage synthesis (SL2-1 and SL2-2), since both enzymes were added at the same time, the presence of ARA and DHA at the sn-2 position can be attributed to the action of either enzyme.

The target (>50% palmitic acid at sn-2 position) was achieved at a lesser run time in one-stage synthesis than in two-stage synthesis. This may be beneficial to the industry in terms of cost. The total reaction time in SL1-1 and SL2-1 were 30 and 24 h, respectively. In the case of SL1-2 and SL2-2, the reaction run times were 12 and 6 h, respectively. Compared to SL1-1 and SL2-1, higher total palmitic acid was found when using higher substrate molar ratio of 1:1:0.5 in both two-stage (44.23 mol % in SL1-2) and one-stage syntheses (40.07 mol % in SL2-2). In one-stage synthesis, lower saturated fats and higher ARA and DHA were found compared to the two-stage synthesis. Under the reaction parameters used in this study, there seems to be a synergistic effect when using the two enzymes simultaneously. Similarly, a synergistic effect on enzymatic interesterification has been observed previously when using Lipozyme TL IM and Novozym 435 together in equal ratios.

TAG Molecular Species. The TAG molecular species are shown in Table 1.3. The fatty acids in the TAGs molecular species analyzed are not in a regiospecific order. The main TAG of EVOO, triolein (OOO), decreased from 47.19% to 8.32, 6.12, 7.64, and 6.83% in SL1-1, SL1-2, SL2-1, and SL2-2, respectively. PPO and OPO (a combination of sn-OPO and sn-POO) were the predominant TAGs in the SLs. SL1-1 had 31.35% PPO and 25.17% OPO. In SL1-2, PPO (33.95%) was followed by OPO (28.84%). SL2-1 and SL2-2 had 23.00 and 25.96% OPO, respectively. Compared to OOP, OPO is better metabolized and absorbed in infants. The major TAG molecular species found in human milk are OPO (17.56-42.44%), POL (9.24-38.15%), OOO (1.61-11.96%), and LOO (1.64-10.18%). All the SLs had OPO, OOO, and LOO within this range but POL was lower than that found in human milk fat. The stereospecificity and chain lengths of fatty acids at the sn-1, sn-2, and sn-3 positions in TAG species, determine the metabolic fate of dietary fat during digestion and absorption. Tripalmitin (PPP) which is one of the starting substrate was also found in the SLs. SL1-1, SL1-2, SL2-1, and SL2-2 had 4.50, 10.32, 4.02, and 6.23% PPP, respectively.

TAG profile greatly influences the physical properties of the SL. The SLs were composed of all four types of TAGs namely, SSS (trisaturated), SUS (disaturated-monounsaturated), SUU (monosaturated-diunsaturated), and UUU (triunsaturated). UUU TAGs decreased from 12.85 to 8.91% in two-stage synthesis and from 14.23 to 12.01% in one-stage synthesis when substrate molar ratio increased from 0.5:1:0.5 to 1:1:0.5. SUU type TAGs were the predominant TAGs present in the SLs. SL1-1, SL1-2, SL2-1, and SL2-2 had 40.83, 40.39, 45.62, and 44.26% SUU TAGs, respectively. Compared to two-stage synthesis, one-stage synthesis resulted in higher UUU and SUU type TAGs and lower SUS and SSS type TAGs. EVOO contained 63.98% UUU, 31.81% SUU, and 4.21% SUS type TAGs. SLs also had newly formed TAGs including ARA and DHA such as OAO, APA, OPD, and ODO. Their relative percent was higher in one-stage synthesized SLs than in two-stage synthesized SLs.

Tocopherols. Tocopherols and tocotrienols, commonly grouped as vitamin E, are the major lipid-soluble, membrane-localized antioxidants in humans. LC-PUFAs are very susceptible to oxidation and therefore need antioxidants to protect their efficacy. Human milk contains 0.45-0.8 mg vitamin E/100 kcal. Oxidative susceptibility increases with increasing unsaturated fatty acids. The SLs were enriched with LC-PUFAs and may be prone to oxidation. Indigenous antioxidants such as tocopherols contribute to protection against oxidative deterioration. The major vitamin E isomers in EVOO were 212.34 μg/g α-tocopherol, 17.79 μg/g γ-tocopherol, and 16.38 μg/g α-tocotrienol (Table 1.4). The total vitamin E content of SL1-1, SL1-2, SL2-1, and SL2-2 were 70.46, 68.79, 79.64, and 79.31 μg/g, respectively of which α-tocopherol accounted for approximately 73%. Among tocotrienols only α-tocotrienol was found in the SLs. Compared to EVOO, >70% decrease was observed for α-tocopherol in the SLs. Similarly, β-tocopherol decreased 33.58% in SL1-1 and >40% in SL1-2, SL2-1, and SL2-2. The % decrease in γ-tocopherol was 64.25, 60.03, 54.92, and 49.58% in SL1-1, SL1-2, SL2-1, SL2-2, respectively. δ-Tocopherol decreased 39.63, 64.02, 20.43, and 22.87% in SL1-1, SL1-2, SL2-1, and SL2-2, respectively. Studies have shown that tocopherols and tocotrienols were lost mainly as tocopheryl and tocotrienyl esters during interesterification and acidolysis reactions [37, 150]. Higher loss of tocotrienols and tocopherols, except β-tocopherol, was observed in the two-stage synthesis than in the one-stage synthesis.

Phenolic Compounds. The phenolics were analyzed using solid phase extraction followed by HPLC-DAD. The major phenolics in EVOO were tyrosol (18.38 μg/g), hydroxytyrosol (9.42 μg/g), pinoresinol (3.52 μg/g), and oleuropein (1.86 μg/g). The other phenolic compounds identified were luteolin, vanillic, gallic, ferulic, p-coumaric, and caffeic acids. Olive oil phenolics are potent antioxidants as they inhibit lipid peroxidation. This may reduce oxidative stress and related diseases such as cancer and cardiovascular diseases. No peak was observed in case of SLs implying that the SLs lacked the indigenous phenolic compounds found in olive oil. Phenolic compounds may be lost either as esters or in free form during the interesterification and/or acidolysis reactions.

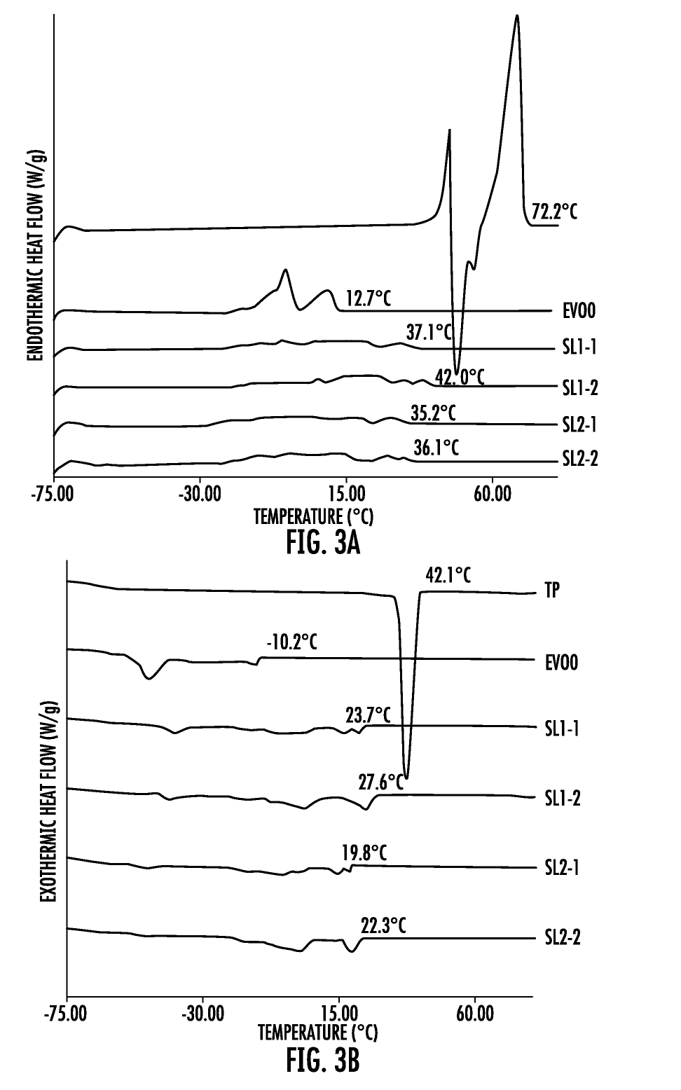

Melting and Crystallization Profiles. The melting properties of a fat or oil can be influenced by the fatty acid chain length (increase in chain-length corresponds to an increase in melting point), degree of unsaturation (increase in unsaturation results in a decrease in melting point), and polymorphism (α—lowest melting point, β′—intermediate melting point, and β—highest melting point) [125]. Melting and crystallization profiles of the substrates and products are shown in FIG. 3A and FIG. 3B, respectively. The melting completion temperature (Tₘₑ) depends on the type of fatty acids and TAGs present. Tripalmitin, including SSS type TAGs, had the highest Tₘₑ (72.2° C.). EVOO has mainly oleic acid and OOO as the major TAG and it was completely melted at 12.7° C. The Tₘₑ of SL1-1, SL1-2, SL2-1, and SL2-2 were 37.1, 42.0, 35.2, and 36.1° C., respectively. Human milk fat is completely melted at normal body temperature (about 37° C.). All the SLs except SL1-2 synthesized in this study have their Tₘₑ near 37° C., which may help in infant formula formulation to obtain proper consistency and texture. The relatively higher Tₘₑ of SL1-2 may be due to high saturated fatty acids (50.60 mol %) and high concentrations of saturated TAGs (SSS 12.11%; SUS 40.14%). The complexity and wide range of TAGs in SLs resulted in gradual melting range rather than a sharp melting as in tripalmitin which is a simple homogenous TAG. Similarly, the crystallization onset temperature (T_{co}) of SL1-1, SL1-2, SL2-1, and SL2-2 were 23.7, 27.6, 19.8, and 22.3° C. (FIG. 3B). The T_{co} of the SLs was between those of tripalmitin (42.1° C.) and EVOO (−10.2° C.) and consisted of multiple peaks due to the complexity in their fatty acid and TAG molecular species.

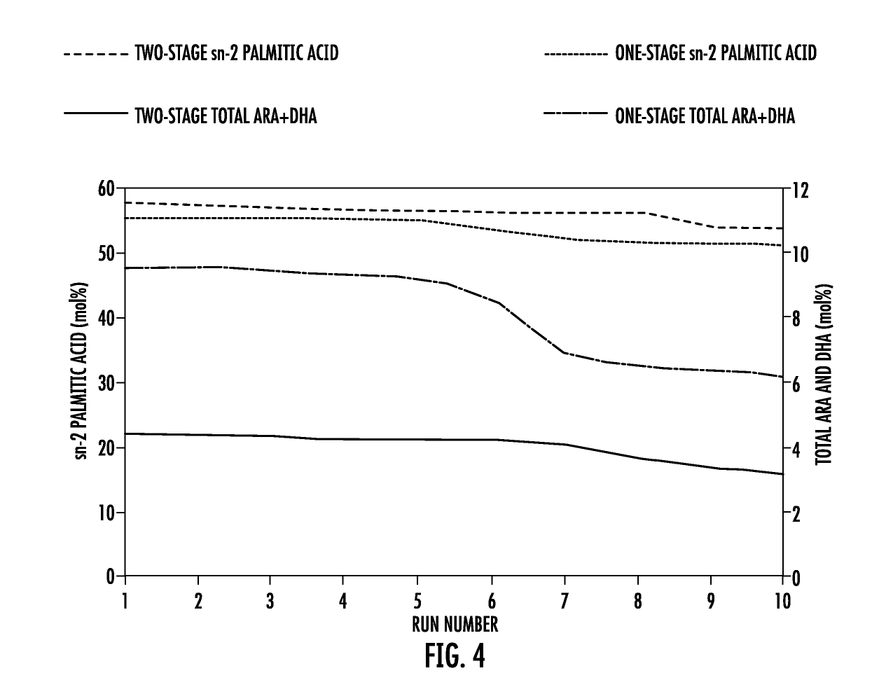

Enzyme Reusability. The enzymes' reusability was tested by performing the 1:1:0.5 reactions ten times in both two-stage and one-stage syntheses. After each run, the enzymes were washed 4-5 times with hexane and dried in a desiccator. They were stored at 4° C. until reuse. Total ARA and DHA and sn-2 palmitic acid (mol %) were determined as the main responses (FIG. 4). For two-stage synthesis, sn-2 palmitic acid (about 57.0 mol %) remained fairly constant till the eighth run after which it decreased. However, the total ARA and DHA content (about 4.4 mol %) started to decrease after the sixth run. In the one-stage synthesis, after the fifth run both palmitic acid at sn-2 position (about 55.3 mol %) and the total ARA and DHA content (about 9.5 mol %) decreased and continued to decrease until the last run. The enzymes performed better in two-stage synthesis in terms of sn-2 palmitic acid. This may be because in the two-stage synthesis the two enzymes, Novozym 435 and Lipozyme TL IM, were separately washed, dried, and reused. On the other hand, in one-stage synthesis both enzymes were washed and reused together which may affect their activity.

An decrease in the total ARA and DHA content was observed for both two-stage and one-stage syntheses, possibly due to the effect of heat on the activity and specificity. As the number of runs increased, the enzyme was exposed to more heat and solvent (hexane during cleaning). The enzyme immobilization carrier properties may also have an effect on enzyme reusability. Studies have shown that Lipozyme TL IM absorbs lesser oil and was easier to clean than Novozym 435 [99, 129]. This difference in the absorption capacity of the enzymes may be due to the different immobilization support system of the two enzymes (granulated silica for Lipozyme TL IM and macroporous acrylic resin for Novozym 435). In one-stage synthesis, the difference in immobilization carrier properties may have a negative effect on their activity explaining decreased response after fifth run. Iimmobilization may also affect the interaction and activity of two lipases when used together. The enzyme activity, stability, efficiency, and selectively may be improved through different immobilization protocols and carriers. Although enzymes had better reusability in two-stage synthesis, one-stage synthesis was a faster reaction and resulted in higher ARA and DHA.

Infant formulas based on human milk composition are substitutes for infant nutrition when breastfeeding may not be possible. SLs with high palmitic acid at the sn-2 position and enriched with ARA and DHA can be used in infant formulas to mimic the physical, chemical, and nutritional properties of human milk fat. The SLs produced in this study had the desired levels of palmitic acid at sn-2 position and contained ARA and DHA for proper growth and development of the infants.

TABLE 1.1
Total and positional fatty acid composition (mol %) of substrates

| | EVOO | | | | |
|---|---|---|---|---|---|
| fatty acid | total | sn-2 | Tripalmitin | ARASCO-FFA | DHASCO-FFA |
| C8:0 | nd^{d} | nd | nd | nd | 0.30 ± 0.00 |
| C10:0 | nd | nd | nd | nd | 1.15 ± 0.02 |
| C12:0 | nd | nd | 0.09 ± 0.00 | nd | 4.46 ± 0.07 |
| C14:0 | nd | nd | 0.47 ± 0.03 | 0.45 ± 0.00 | 10.30 ± 1.02 |
| C16:0 | 16.02 ± 1.21 | 2.31 ± 0.66 | 98.90 ± 1.02 | 8.39 ± 0.77 | 9.91 ± 0.79 |
| C18:0 | 2.50 ± 0.62 | 0.10 ± 0.00 | 1.02 ± 0.00 | 8.12 ± 1.05 | 0.83 ± 0.04 |
| C18:1n-9 | 67.81 ± 2.85 | 82.20 ± 2.95 | nd | 20.52 ± 1.86 | 22.17 ± 1.05 |
| C18:2n-6t | nd | nd | nd | 0.20 ± 0.00 | nd |
| C18:2n-6c | 9.56 ± 0.89 | 14.67 ± 1.73 | nd | 6.67 ± 0.59 | 1.04 ± 0.00 |
| C18:3n-6 | nd | nd | nd | 0.82 ± 0.00 | nd |
| C18:3n-3 | 0.75 ± 0.00 | 0.22 ± 0.00 | nd | 0.37 ± 0.00 | nd |
| C20:3n-6 | nd | nd | nd | 1.89 ± 0.02 | nd |
| C20:3n-3 | 0.89 ± 0.01 | nd | nd | 3.80 ± 0.01 | nd |
| C20:4n-6 | nd | nd | nd | 43.22 ± 1.28 | nd |
| C22:6n-3 | nd | nd | nd | nd | 44.13 ± 1.06 |
| minor^{e} | 2.47 | 0.00 | 0.11 | 5.56 | 3.98 |

^{d}nd, not detected.
^{e}Minor is the sum C14:1, C16:1, C17:0 C20:0, C20:1, C20:2, C22:0, C22:2, C24:0, and C24:1.
Each value is the mean of triplicates ± standard deviation.

TABLE 1.2
Fatty acid composition (mol %) of the structured lipids

| | total | | | |
|---|---|---|---|---|
| fatty acid | SL1-1 | SL1-2 | SL2-1 | SL2-2 |
| C8:0 | nd | nd | 0.50 ± 0.00 a | 0.60 ± 0.00 a |
| C10:0 | 1.04 ± 0.00 a | 1.02 ± 0.00 a | 1.11 ± 0.07 b | 0.70 ± 0.02 c |
| C12:0 | 0.21 ± 0.00 a | 0.18 ± 0.00 a | 0.44 ± 0.00 b | 0.42 ± 0.00 b |
| C14:0 | 1.97 ± 0.03 a | 2.11 ± 0.21 a | 2.47 ± 0.55 b | 2.54 ± 0.22 b |
| C16:0 | 36.69 ± 2.12 a | 44.23 ± 2.87 b | 35.23 ± 1.78 c | 40.07 ± 1.93 d |
| C16:1n-7 | 1.03 ± 0.07 a | 0.87 ± 0.01 b | 0.85 ± 0.00 b | 0.84 ± 0.00 b |
| C18:0 | 2.82 ± 0.03 a | 2.58 ± 0.05 a | 3.19 ± 0.48 b | 3.02 ± 0.45 b |
| C18:1n-9 | 43.22 ± 2.11 a | 38.64 ± 2.06 b | 38.08 ± 2.23 b | 37.10 ± 1.99 c |
| C18:2n-6 | 6.34 ± 0.04 a | 5.29 ± 0.98 b | 5.79 ± 0.45 b | 4.09 ± 0.56 c |
| C20:0 | 0.29 ± 0.00 a | 0.23 ± 0.00 a | 0.33 ± 0.00 b | 0.28 ± 0.00 a |
| C18:3n-6 | 0.08 ± 0.00 a | 0.06 ± 0.00 a | 0.46 ± 0.01 b | 0.45 ± 0.01 b |
| C18:3n-3 | 0.47 ± 0.00 a | 0.39 ± 0.00 b | 0.33 ± 0.01 c | 0.30 ± 0.00 c |
| C22:0 | 0.16 ± 0.00 a | 0.12 ± 0.00 b | 0.28 ± 0.00 c | 0.27 ± 0.02 c |
| C20:3n-3 | 0.16 ± 0.00 a | 0.11 ± 0.00 b | 0.55 ± 0.00 c | 0.54 ± 0.01 c |
| C20:4n-6 | 3.67 ± 0.21 a | 2.97 ± 0.11 b | 6.23 ± 0.96 c | 5.95 ± 0.33 d |
| C22:6n-3 | 1.53 ± 0.05 a | 1.39 ± 0.72 b | 3.71 ± 1.01 c | 2.60 ± 0.29 d |
| minor⁶ | 0.33 ± 0.00 a | 0.30 ± 0.03 a | 0.52 ± 0.02 b | 0.53 ± 0.00 b |
| n-6/n-3 | 4.72 | 4.45 | 2.78 | 3.14 |
| | sn-2 | | | |
| fatty acid | SL1-1 | SL1-2 | SL2-1 | SL2-2 |
| C8:0 | nd | nd | nd | nd |
| C10:0 | nd | nd | nd | nd |
| C12:0 | nd | nd | nd | nd |
| C14:0 | nd | 1.12 ± 0.00 a | 1.44 ± 0.00 b | 1.24 ± 0.01 c |
| C16:0 | 52.67 ± 3.07 a | 56.25 ± 2.65 b | 50.33 ± 2.84 c | 55.34 ± 2.22 d |
| C16:1n-7 | nd | nd | 0.87 ± 0.00 a | 0.73 ± 0.00 b |
| C18:0 | nd | nd | 2.34 ± 0.01 a | 1.97 ± 0.00 b |
| C18:1n-9 | 39.64 ± 1.64 a | 34.85 ± 1.98 b | 34.48 ± 1.82 bc | 33.50 ± 1.83 c |
| C18:2n-6 | 6.06 ± 0.78 a | 6.34 ± 0.82 a | 4.38 ± 0.79 b | 3.91 ± 0.57 c |
| C20:0 | nd | nd | nd | nd |
| C18:3n-6 | nd | nd | nd | nd |
| C18:3n-3 | nd | nd | nd | nd |
| C22:0 | nd | nd | nd | nd |
| C20:3n-3 | nd | nd | nd | nd |
| C20:4n-6 | 2.25 ± 0.02 a | 1.09 ± 0.03 b | 4.93 ± 0.22 c | 4.13 ± 0.21 c |
| C22:6n-3 | 0.78 ± 0.00 a | 0.83 ± 0.00 a | 2.41 ± 0.01 b | 2.05 ± 0.03 b |
| minor⁶ | | | | |
| n-6/n-3 | 10.65 | 8.96 | 3.86 | 3.92 |

⁶minor is the sum of C17:0, C20:1, C20:2, and C22:2.
Each value is the mean of triplicates ± standard deviation.
Values with different letter in each row within total and sn-2 columns separately are significantly different at P ≦ 0.05.

TABLE 1.3
Relative percent (%) of TAG molecular species of EVOO and structured lipids

| TAG | EVOO^{a} | SL1-1^{b} | SL1-2^{c} | SL2-1^{d} | SL2-2^{e} |
|---|---|---|---|---|---|
| OAO | nd^{f} | 0.98 ± 0.02 a | 0.75 ± 0.01 b | 1.21 ± 0.03 c | 0.74 ± 0.00 b |
| APA | nd | 2.56 ± 0.69 a | 1.78 ± 0.08 b | 6.11 ± 1.04 c | 5.24 ± 0.28 d |
| OPD | nd | 1.40 ± 0.11 a | 1.59 ± 0.04 b | 2.36 ± 0.83 c | 2.14 ± 0.19 c |
| ODO | nd | 0.33 ± 0.00 a | 0.36 ± 0.01 a | 1.20 ± 0.04 b | 0.98 ± 0.00 c |
| LOL | 6.59 ± 1.21 | nd | nd | 2.07 ± 0.21 a | 1.44 ± 0.21 b |
| LPL | 1.97 ± 0.67 | 1.46 ± 0.01 a | 1.14 ± 0.01 b | 0.66 ± 0.00 c | 0.87 ± 0.00 d |
| MPL | nd | 0.84 ± 0.00 a | 0.72 ± 0.00 b | 2.35 ± 0.11 c | 0.88 ± 0.01 a |
| POLn | nd | 2.13 ± 0.18 a | 1.50 ± 0.00 b | 6.03 ± 0.28 c | 4.56 ± 0.38 d |
| SMM | nd | nd | nd | 1.44 ± 0.01 a | 2.59 ± 0.19 b |
| OOL | 10.20 ± 1.55 | 3.22 ± 0.21 a | 1.68 ± 0.01 b | 2.11 ± 0.19 c | 2.02 ± 0.02 c |
| POL | nd | 6.28 ± 1.01 a | 4.68 ± 0.33 b | 6.08 ± 2.03 a | 4.34 ± 0.27 b |
| PLP | 0.74 ± 0.01 | 2.53 ± 0.46 a | 3.42 ± 0.19 b | 2.32 ± 0.79 a | 2.37 ± 0.68 a |
| PPM | nd | 1.12 ± 0.06 a | 1.11 ± 0.07 a | 0.88 ± 0.04 ab | 0.67 ± 0.00 b |
| OOO | 47.19 ± 3.08 | 8.32 ± 0.78 a | 6.12 ± 1.06 b | 7.64 ± 1.44 c | 6.83 ± 1.79 b |
| OPO | 25.37 ± 2.18 | 25.17 ± 2.51 a | 28.84 ± 2.11 b | 23.00 ± 2.18 c | 25.96 ± 2.79 a |
| PPO | 2.81 ± 0.22 | 31.35 ± 2.49 a | 33.95 ± 2.98 b | 24.82 ± 1.59 c | 28.64 ± 2.91 d |
| PPP | nd | 4.50 ± 1.62 a | 10.32 ± 1.70 b | 4.02 ± 0.58 a | 6.23 ± 1.04 c |
| OOS | 4.47 ± 0.67 | 1.83 ± 0.29 a | 0.86 ± 0.28 b | 1.38 ± 0.00 ac | 1.15 ± 0.00 c |
| POS | 0.66 ± 0.01 | 4.31 ± 0.01 a | 2.05 ± 0.29 b | 3.80 ± 0.02 c | 3.65 ± 0.00 c |
| PPS | nd | 0.82 ± 0.00 a | 0.68 ± 0.00 b | 0.78 ± 0.00 a | 0.82 ± 0.00 a |

The fatty acids are not in regiospecific order, and abreviations are set forth in the description above.
Each value is the mean of triplicates ± standard deviation.
Values with different letter in each row are significantly different at P ≦ 0.05.

TABLE 1.4
Tocopherol content (μg/g) of extra virgin olive oil and structured lipids

| | α-tocopherol | α-tocotrienol | β-tocopherol | γ-tocopherol | δ-tocopherol |
|---|---|---|---|---|---|
| EVOO^{a} | 212.34 ± 4.78 | 16.38 ± 2.11 | 4.02 ± 1.02 | 17.79 ± 1.68 | 3.28 ± 1.02 |
| SL1-1^{b} | 51.83 ± 2.99 a | 7.62 ± 1.09 a | 2.67 ± 0.68 a | 6.36 ± 1.03 a | 1.98 ± 0.79 a |
| SL1-2^{c} | 50.90 ± 2.16 a | 7.23 ± 1.21 b | 2.37 ± 0.79 a | 7.11 ± 1.01 b | 1.18 ± 0.49 b |
| SL2-1^{d} | 58.84 ± 1.97 b | 8.10 ± 1.77 c | 2.03 ± 0.88 b | 8.02 ± 0.93 c | 2.61 ± 0.68 c |
| SL2-2^{e} | 56.96 ± 2.41 c | 8.74 ± 1.69 c | 2.11 ± 0.82 b | 8.97 ± 1.11 d | 2.53 ± 0.39 c |

Each value is the mean of triplicates ± standard deviation.
Values with different letter in each column are significantly different at P ≦ 0.05.

### Example 2

Synthesis of Infant Formula Fat Analogs Enriched with DHA from Extra Virgin Olive Oil and Tripalmitin

### Materials and Methods

Materials. Materials were as described in Example 1.

Preparation of Free Fatty Acids (FFAs) from EVOO and DHASCO by Saponification. Saponification value (SV) was calculated based on AOCS Official Method Cd 3a-94 [10]. Fatty acid profile was used to calculate the molecular weight (MW) of the substrates. MW (g/mol) of EVOO and DHASCO were 872.49 and 881.30, respectively. The SV (mg KOH/g) of EVOO and DHASCO were 192.58 and 186.18, respectively. FFAs were prepared as described in Example 1. The FFAs (EVOOFFA and DHASCOFFA) were flushed with nitrogen and stored at −80° C. in amber Nalgene bottle until use.

SL Synthesis by Acidolysis. SLs were synthesized in Erlenmeyer flask in a solvent free environment. The substrates molar ratios (tripalmitin:EVOOFFA:DHASCOFFA) used were 1:1:1, 1:2:1, 1:3:2, 1:4:2, and 1:5:1. The resulting SLs were named SL111, SL121, SL132, SL142, and SL151, respectively. The MW (g/mol) of EVOOFFA, DHASCOFFA, and tripalmitin were 277.59, 282.49, and 806.89, respectively. The reaction temperature and time were fixed at 65° C. and 24 h. Total substrate weight was 8.47 g and 10% by weight Lipozyme TL IM lipase was added. A physical blend (PB) were also produced (1:3:2 substrate molar ratio) without using the enzyme as control. The PB was subjected to the same synthesis and clean-up process as that of SLs. The flasks were kept in water bath shaker at 200 rpm for above specified time and temperature. After the reaction, the products were filtered through a Whatman No. 1 filter paper sprinkled with anhydrous sodium sulfate under vacuum.

Removal of FFAs. The extra FFAs were removed through deacidification by alkaline extraction method [12]. Briefly, 8 g SLs/PB were mixed with 250 mL hexane, 1% phenolphthalein in 95% ethanol, and 125 mL 0.5 N KOH in 20% ethanol in a separatory funnel. The aqueous layer was discarded while 50 mL 0.5 N KOH in 20% ethanol and 100 mL of saturated NaCl solution were added to the hexane layer. The hexane layer was collected and passed through anhydrous sodium sulfate under vacuum. The solvent was removed by rotary evaporator at 40° C. and 50 rpm speed. The products were flushed with nitrogen and stored at −20° C. until analysis.

Determination of Fatty Acid Profiles. The substrates, namely EVOO, DHASCO, tripalmitin, EVOOFFA, and DHASCOFFA, and the products (SLs and PB) were converted to FA methyl esters (FAMEs) following AOAC Official Method 996.01 [95] with minor modifications. 0.1 g of sample was weighed into Teflon-lined test tubes and 0.25 mL internal standard (C15:0, 20 mg/mL in hexane) was added and dried under nitrogen. 2 mL 0.5 NaOH in methanol was added and heated at 100° C. for 10 min (except in FFAs samples). The samples were cooled in ice bath and 2 mL BF₃ in methanol was added and again heated at 100° C. for 10 min. The samples were cooled and finally 2 mL hexane and 2 mL saturated NaCl solutions were added and vortexed for 2 min. The upper FAME layer was collected after centrifuging the samples at 1000 rpm for 5 min at room temperature and passed through anhydrous sodium sulfate column into GC vials. Supelco 37 component FAME mix was used as the external standard. The samples were analyzed with Hewlett-Packard 6890 series II gas chromatograph (Agilent Technologies Inc., Palo Alto, Calif.) using Supelco SP-2560, 100 m×25 mm×0.2 μm column. Helium was the carrier gas at a constant flow rate of 1.1 mL/min. Injection volume was 1 μL and a split ratio of 20:1 was used. Detection was with flame ionization detector at 300° C. The column was initially held at 140° C. for 5 min and then increased to 240° C. at 4° C./min and held at 240° C. for 25 min. All samples were analyzed in triplicates and average values reported.

Positional Analysis. sn-2 Positional fatty acid composition was determined as described in Example 1 above. All samples were analyzed in triplicate and average values reported.

Triacylglycerol (TAG) Molecular Species. The TAG composition was determined as in Example 1, with minor modification described here. The reverse phase HPLC (Agilent Technologies 1100 Infinity, Santa Clara Calif.) was equipped with a Sedex 55 ELSD (Richard scientific, Novato, Calif.). The mobile phase at a flow rate of 1 mL/min included solvent A, acetonitrile and solvent B, acetone. A gradient elution was used starting with 35% solvent A to 5% solvent A at 45 min and then returning to the original composition in 5 min. Drift tube temperature was set at 70° C., pressure at 3.0 bar and gain at 8.

Melting and Crystallization Profiles. The melting and crystallization profiles were determined as described in Example 1, except the following modifications. 8-12 mg samples were weighed and sealed, rapidly heated to 80° C. at 20° C./min, and held for 10 min to destroy any previous crystalline structure. The samples were then cooled to −80° C. at 10° C./min (for crystallization profiles), and held for 30 min and finally heated to 80° C. at 10° C./min (for melting profiles). Nitrogen was used as the protective and purge gas. All samples were analyzed in triplicates and average values reported.

Statistical Analysis. All analyses were performed in triplicate as described in Example 1.

### Results and Discussions

Total and Positional Fatty Acid Profiles. Table 2.1 shows the common fatty acid composition of human milk fat and some commercial infant formulas. The main fatty acids in human milk are oleic (28.30-43.83%), palmitic (15.43-24.46%), and linoleic (10.61-25.30%) acids. The total fatty acid composition of the infant formulas was almost similar to human milk, whereas their palmitic acid content at the sn-2 position was considerably lower than human milk fat. The fatty acid profiles of tripalmitin, EVOOFFA, DHASCOFFA, SLs, and PB are shown in Table 2.2. Tripalmitin contained 97.90 mol % palmitic acid. The predominant fatty acids in EVOOFFA were oleic (68.32 mol %) and palmitic (16.13 mol %) acids. The major fatty acids in DHASCOFFA were DHA (44.13 mol %), oleic (22.17 mol %), and myristic (10.30 mol %) acids. The fatty acid profile of SL111 and SL121 are not shown in Table 2.2. SL111 and SL121 both had >60 mol % palmitic acid at sn-2 position but they had 68.32 and 60.97 mol %, respectively, total palmitic acid which was very high compared to human milk fat. Therefore, they were rejected for further analyses. SL132 had 42.23 mol % total palmitic acid and 67.34 mol % palmitic acid at sn-2 position (Table 2.3).

TAGs having high sn-2 palmitic acid are preferred in human milk fat analogs as it helps in overall digestibility and fat absorption. Also, if palmitic acid is present predominantly at sn-1,3 positions it is released as FFA as a result of pancreatic lipase action. Non-esterified palmitic acid's melting point is about 63° C. and that is considerably above body temperature. At the pH of the intestine, palmitic acid readily forms insoluble soaps with Ca and other divalent cations and are excreted as hard stool. This results in unavailability of both palmitic acid and minerals to the infants. SL142 and SL151 both had 63.27 and 58.78 mol % palmitic acid at sn-2 position, respectively (Table 2.3). Higher palmitic acid was found at sn-2 position than at sn-1,3 positions of the SLs which may help with better digestion and absorption.

Compared to the positional distribution of the commercial infant formulas (Table 2.1), the SLs synthesized in this study had similar sn-2 palmitic acid as human milk fat. The high content of total palmitic acid in these SLs can be attributed to the unreacted tripalmitin substrate, which subsequently resulted in a higher level of palmitic acid in the TAGs of the SLs. As EVOOFFA content increased, mol % oleic acid also increased in the SLs. SL132 had 33.55 mol % oleic acid, which increased to 34.81 mol % in SL142 and to 40.50 mol % in SL151. The SLs were also enriched with DHA. SL132 had 7.54 mol % total DHA with 10.34 mol % present at sn-1,3 positions. SL142 and SL151 had 6.72 and 5.89 mol % DHA. The PB had very high (>95 mol %) total palmitic acid. Since tripalmitin was the starting TAG, in the absence of lipase, FFAs were not esterified to the glycerol backbone. No DHA was present in the PB.

All the SLs in this example had diverse fatty acids ranging from short-chain fatty acids (C6:0) to long-chain polyunsaturated fatty acids (DHA). Short- and medium-chain fatty acids can be used for quick energy and rapid absorption in neonates whereas DHA is used for essential structural and functional development. Although the SLs contained higher total palmitic acid compared to human milk fat, they also had desirable sn-2 palmitic acid content and were enriched with DHA. They can be used as a blend with other vegetable oils to decrease the total palmitic acid content while still maintaining the desired sn-2 palmitic acid and containing DHA in the final product.

Although Lipozyme TL IM is an sn-1,3 specific enzyme, oleic acid and DHA were also esterified to the second position of the TAGs, which may be attributed to acyl migration. In this study, substrate molar ratio was also found to affect acyl migration. All the reactions were carried out at the same temperature for the same time in the presence of the same enzyme and same enzyme load. It was observed that as FFA content of the substrates increased, oleic acid migration to sn-2 position also increased and the sn-2 palmitic acid content decreased. Therefore, there seemed to be competition among the FFAs for esterification to the free OH group on the glycerol backbone of SL.

TAG Molecular Species. The TAG molecular species are shown in Table 2.4. The predominant TAG of all SLs and PB was PPP since tripalmitin was the starting TAG of the acidolysis reaction. The PB had ˜97% PPP similar to that of tripalmitin implying that there was no change in the TAG molecular species. In SL132, PPP (42.46%) was followed by PPO (28.56%) and OPO (23.67%). The relative percent of OPO increased to 30.61% in SL142 and 31.46% in SL151. Compared to OOP, OPO is better metabolized and absorbed in infants [22]. The major TAG molecular species found in human milk are OPO (17-56-42.44%), POL (9.24-38.15%), 000 (1.61-11.96%), and LOO (1.64-10.18%) [23]. OPO content of the SLs was within the range of that found in maternal milk.

The SLs were composed of all four types of TAGs namely, SSS (trisaturated), SUS (disaturated-monounsaturated), SUU (monosaturated-diunsaturated), and UUU (triunsaturated). SL132 had 42.61% SSS type TAGs which decreased to 41.84% in SL142 and 39.19% in SL151. The SUS type TAGs also decreased from 29.22% in SL132 to 20.47% in SL151. On the other hand, a major increase in SUU type TAGs was observed. SL132, SL142, and SL151 were comprised of 27.10, 33.98, and 40.22% SUU TAGs, respectively. The new TAGs formed also contained DHA mainly as OPD. The physical blend had higher proportion of SSS type TAGs than the SLs and no SUU and UUU type TAGs. The TAG molecular species of the physical blend resembled those of tripalmitin whereas the SLs consisted of more diverse and newly formed TAGs.

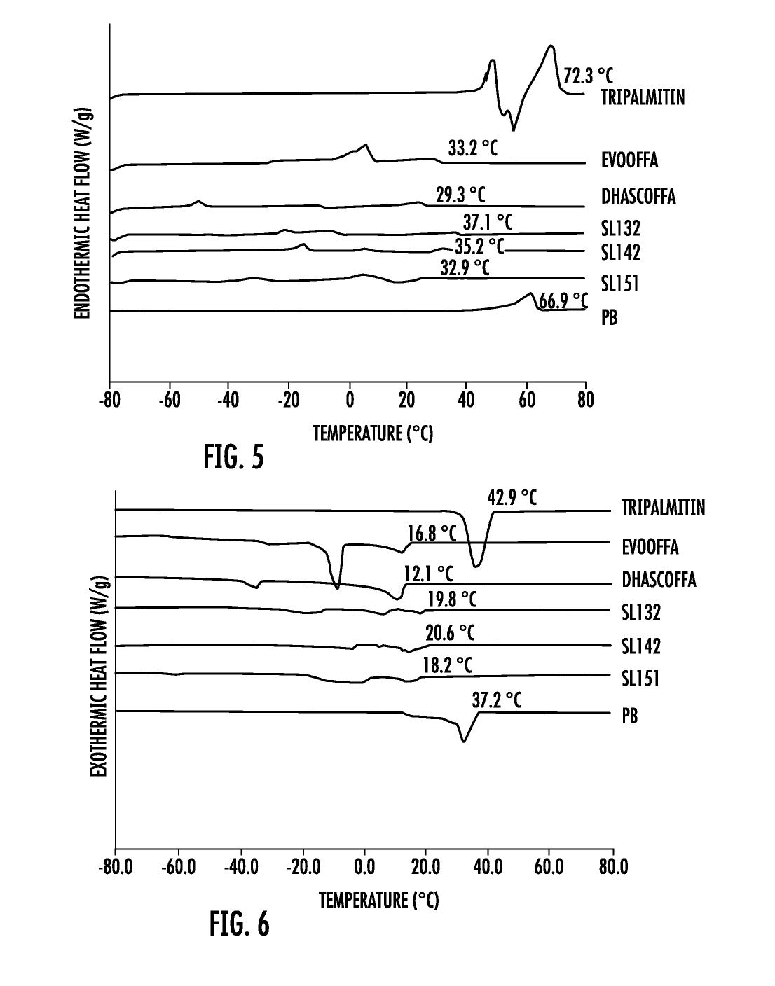

Melting and Crystallization Profiles. Melting and crystallization profiles of the substrates and products are shown in FIG. 5 and FIG. 6, respectively. The melting completion temperature (Tₘₑ) depends on the type of fatty acids and TAGs present. As UUU type TAGs increased and SSS type TAGs decreased, T_{mc} also decreased. Tripalmitin, including SSS type TAGs, had the highest Tₘₑ (72.3° C.) followed by EVOOFFA (33.2° C.) and DHASCOFFA (29.3° C.) (FIG. 5). Similarly, the crystallization onset temperature (T_{co}) of the substrates decreased from 42.9° C. in tripalmitin to 16.8° C. in EVOOFFA and 12.1° C. in DHASCOFFA (FIG. 6). The Tₘₑ of SL132, SL142, and SL151 were 37.1, 35.2, and 32.9° C., respectively. Normal body temperature is around 36-37° C. This may help in infant formula formulation and metabolism as the SL would be completely melted at body temperature. Human milk fat melts at near body temperature. The Tₘₑ of the PB (66.9° C.). was much higher than the SLs. The T_{co} of SL132, SL142, and SL151 were 19.8, 20.6, and 18.2° C., respectively (FIG. 2). No significant differences (P>0.05) in T_{co} were found between the SLs whereas significant difference (P<0.05) was found in Tₘₑ. Significant difference (P<0.05) was also found in Tₘₑ and T_{co} of SLs and PB.

This example demonstrates that SLs that contain palmitic acid predominantly (e.g., about 60%) at the sn-2 position and which are also enriched with DHA can be used in infant formulas to mimic the physical, chemical, and nutritional properties of human milk fat. Therefore, all three SLs, SL132, SL142, and SL151, may be suitable for use in infant formula as human milk fat analogs. They had the desired levels of palmitic acid at sn-2 position and also contained DHA for proper growth and development of the infants.

TABLE 2.1
Fatty acid composition (%) of human milk and
commercial infant formulas [73].

| | Human milk (n = 40) | | Infant formulas (n = 11) | |
|---|---|---|---|---|
| Fatty acid | total | sn-2 | total | sn-2 |
| C8:0 | 0.11-0.36 | nd² | 0.51-1.20 | 0.03-0.09 |
| C10:0 | 0.85-3.08 | 0.36 ± 0.10 | 0.74-1.24 | 0.16-1.54 |
| C12:0 | 4.05-9.35 | 4.81 ± 0.81 | 5.19-12.64 | 4.68-15.32 |
| C14:0 | 3.60-9.13 | 9.66 ± 1.61 | 4.06-5.91 | 2.23-7.10 |
| C16:0 | 15.43-24.46 | 52.30 ± 4.44 | 17.96-26.75 | 5.88-43.01 |
| C18:0 | 4.60-8.13 | 1.71 ± 0.29 | 3.05-6.72 | 0.56-2.38 |
| C18:1n-9 | 28.30-43.83 | 13.97 ± 2.74 | 34.34-44.69 | 26.33-52.37 |
| C18:2n-6 | 10.61-25.30 | 10.95 ± 2.75 | 8.93-18.43 | 8.14-26.69 |
| C18:3n-6 | 0.00-0.27 | — | — | — |
| C18:3n-3 | 0.41-1.68 | 0.59 ± 0.10 | 0.67-2.83 | 0.91-4.31 |
| C20:4n-6 | 0.23-0.75 | 0.67 ± 0.15 | nd-0.35 | nd-0.40 |
| C22:6n-3 | 0.15-0.56 | 0.64 ± 0.10 | nd-0.20 | nd-0.28 |
| SFA³ | 34.18-47.48 | | 40.60-47.16 | |
| MUFA⁴ | 32.08-47.34 | | 34.94-45.50 | |
| PUFA⁵ | 13.26-29.15 | | 10.65-20.02 | |
| n-3PUFA | 0.81-3.06 | | 1.45-2.83 | |
| n-6PUFA | 12.10-27.77 | | 9.71-18.46 | |

TABLE 2.2
Total fatty acid (mol %) composition of substrates, structured lipids, and physical blend

| Fatty acid | Tripalmitin | EVOOFFA | DHASCOFFA | SL132 | SL142 | SL151 | PB |
|---|---|---|---|---|---|---|---|
| C6:0 | nd | nd | nd | 1.12 ± 0.00a | 1.09 ± 0.00a | 1.02 ± 0.00a | 1.01 ± 0.00a |
| C8:0 | nd | nd | 0.30 ± 0.00 | nd | nd | nd | nd |
| C10:0 | nd | nd | 1.15 ± 0.04a | 0.31 ± 0.00b | 0.25 ± 0.00c | 0.15 ± 0.00d | nd |
| C12:0 | 0.09 ± 0.00a | nd | 4.46 ± 0.08b | 1.32 ± 0.00c | 1.09 ± 0.03d | 0.60 ± 0.00e | 0.05 ± 0.00a |
| C14:0 | 1.47 ± 0.00a | nd | 10.30 ± 0.82b | 3.71 ± 0.01c | 3.21 ± 0.03c | 3.69 ± 0.01c | 1.09 ± 0.01d |
| C16:0 | 97.90 ± 0.02a | 16.13 ± 1.03b | 9.91 ± 0.70c | 42.23 ± 2.08d | 40.45 ± 2.03d | 39.47 ± 2.22d | 96.24 ± 2.86a |
| C16:1n-7 | 0.11 ± 0.00a | 1.52 ± 0.04b | 2.18 ± 0.00c | 1.24 ± 0.00b | 1.32 ± 0.09b | 1.19 ± 0.03b | 0.09 ± 0.00a |
| C18:0 | 1.02 ± 0.00a | 2.52 ± 0.01b | 0.83 ± 0.00c | 2.01 ± 0.01b | 2.08 ± 0.02b | 2.24 ± 0.02b | 1.01 ± 0.11a |
| C18:1n-9 | nd | 68.32 ± 2.41a | 22.17 ± 0.47b | 33.55 ± 1.19c | 34.81 ± 0.9c | 40.50 ± 2.89d | 0.05 ± 0.07e |
| C18:2n-6 | nd | 9.67 ± 0.92a | 1.04 ± 0.00b | 3.72 ± 0.23c | 4.30 ± 0.00c | 5.28 ± 0.03d | 0.02 ± 0.00e |
| C20:0 | nd | 0.24 ± 0.00a | nd | 0.17 ± 0.00b | 0.19 ± 0.00b | 0.22 ± 0.00a | nd |
| C20:1n-9 | nd | 0.43 ± 0.00a | 0.25 ± 0.00b | 0.40 ± 0.00a | 0.51 ± 0.00c | 0.60 ± 0.00d | nd |
| C18:3n-3 | nd | 1.02 ± 0.00 | nd | nd | nd | nd | nd |
| C22:6n-3 | nd | nd | 44.13 ± 1.57a | 7.54 ± 0.89b | 6.72 ± 0.67c | 5.89 ± 0.44d | nd |
| Minor | nd | 0.56 ± 0.00a | 1.55 ± 0.00b | nd | nd | nd | nd |

Minor: minor fatty acids include C14:1, C20:2, C22:0, C20:3n3, C24:0, and C24.1.
Each value is the mean of triplicates ± standard deviation.
Values with different letter in each row are significantly different at P ≦ 0.05.

TABLE 2.3
Positional fatty acid (mol %) profiles of structured lipids and physical blend

| | SL132¹ | | SL142² | | SL151³ | | PB⁴ | |
|---|---|---|---|---|---|---|---|---|
| Fatty acid | sn-2 | sn-1,3 | sn-2 | sn-1,3 | sn-2 | sn-1,3 | sn-2 | sn-1,3 |
| C6:0 | nd⁵ | 1.63 ± 0.00a | nd | 1.53 ± 0.00a | nd | 1.52 ± 0.02a | nd | nd |
| C10:0 | nd | 0.47 ± 0.00a | nd | 0.38 ± 0.00b | 0.05 ± 0.00 | 0.20 ± 0.00c | nd | nd |
| C12:0 | 0.71 ± 0.00a | 1.62 ± 0.00a | 0.68 ± 0.00a | 1.64 ± 0.00a | 0.55 ± 0.00b | 0.63 ± 0.01b | nd | 0.23 ± 0.00c |
| C14:0 | 2.33 ± 0.00a | 4.40 ± 0.49a | 2.65 ± 0.00a | 3.50 ± 0.02b | 2.05 ± 0.01a | 1.95 ± 0.01c | 2.08 ± 0.05a | 1.95 ± 0.00c |
| C16:0 | 67.34 ± 3.33a | 34.18 ± 1.10a | 63.27 ± 3.18a | 30.54 ± 1.89b | 58.78 ± 1.95b | 31.32 ± 1.98b | 93.20 ± 1.89c | 91.76 ± 2.95c |
| C16:1n7 | 0.60 ± 0.00a | 1.56 ± 0.04a | 0.64 ± 0.02a | 1.66 ± 0.39a | 0.82 ± 0.08b | 1.38 ± 0.03b | nd | 0.14 ± 0.00c |
| C18:0 | 2.39 ± 0.04a | 1.82 ± 0.00a | 2.71 ± 0.00a | 1.77 ± 0.08a | 2.58 ± 0.07a | 2.07 ± 0.05b | 2.19 ± 0.02a | 1.95 ± 0.03c |
| C18:1n9 | 20.89 ± 0.36a | 39.8 ± 1.02a | 22.57 ± 2.91a | 40.93 ± 2.20a | 28.89 ± 2.08b | 49.31 ± 3.72b | 0.87 ± 0.00c | 3.24 ± 0.45c |
| C18:2n6 | 2.30 ± 0.00a | 4.42 ± 0.98a | 3.54 ± 0.67b | 4.68 ± 1.09a | 4.24 ± 0.78c | 5.79 ± 0.89b | nd | 0.44 ± 0.05c |
| C20:0 | nd | 0.25 ± 0.00a | nd | 0.28 ± 0.00a | nd | 0.32 ± 0.00a | nd | nd |
| C20:1n9 | nd | 0.60 ± 0.00a | nd | 0.76 ± 0.00b | 0.90 ± 0.00 | 0.44 ± 0.01c | nd | nd |
| C22:6n3 | 1.95 ± 0.01a | 10.34 ± 1.26a | 2.57 ± 0.03b | 8.80 ± 1.87b | 1.79 ± 0.00c | 7.95 ± 0.37c | nd | nd |

Each value is the mean of triplicates ± standard deviation.
Values with different letter in each row within sn-2 and sn-1,3 columns separately are significantly different at P ≦ 0.05.

TABLE 2.4
Relative percent (%) of triacylglycerol (TAG) molecular species
of structured lipids and physical blend

| TAG | | | | |
|---|---|---|---|---|
| Spe- | | | | |
| cies | SL132¹ | SL142² | SL151³ | PB⁴ |
| DPD | 0.08 ± 0.00a | 0.05 ± 0.00a | 1.16 ± 0.02b | nd⁵ |
| OPD | 2.60 ± 0.01a | 2.10 ± 0.04b | 3.05 ± 0.09c | nd |
| ODO | 0.10 ± 0.00a | 0.11 ± 0.00a | 0.09 ± 0.00a | nd |
| LOL | 0.05 ± 0.00a | 0.05 ± 0.00a | 0.13 ± 0.00b | nd |
| LPL | 0.19 ± 0.00a | 0.19 ± 0.00a | 0.18 ± 0.00a | nd |
| OOL | 0.04 ± 0.00a | 0.05 ± 0.00a | 0.04 ± 0.00a | nd |
| POL | 0.48 ± 0.00a | 0.85 ± 0.02b | 4.21 ± 0.98c | nd |
| OOO | 1.37 ± 0.00a | 1.67 ± 0.01b | 1.13 ± 0.39c | nd |
| PLP | 0.51 ± 0.00a | 0.44 ± 0.00a | 0.17 ± 0.00b | 1.36 ± 0.01c |
| PPM | 0.15 ± 0.00a | 0.47 ± 0.03b | 0.72 ± 0.02c | nd |
| OPO | 23.67 ± 2.56a | 30.61 ± 2.10b | 31.46 ± 2.29b | nd |
| PPO | 28.56 ± 2.19a | 20.93 ± 2.08b | 20.18 ± 1.93b | 1.02 ± 0.00c |
| PPP | 42.46 ± 3.12a | 41.37 ± 3.00a | 38.47 ± 2.68b | 97.01 ± 2.31c |
| SOO | 0.09 ± 0.00a | 0.18 ± 0.00b | 0.23 ± 0.01c | nd |
| PSO | 0.15 ± 0.00a | 0.12 ± 0.00a | 0.13 ± 0.00a | nd |

The fatty acids are not in regiospecific order and are abbreviated as described in the description. Each value is the mean of triplicates ± standard deviation. Values with different letter in each row are significantly different at P ≦ 0.05.

### Example 3

Enrichment of Refined Olive Oil with Palmitic Acid and Docosahexaenoic Acid to Produce Human Milk Fat Analogue

### Materials and Methods

Material. Materials were obtained as described in Example 1, with the addition of the following. Refined olive oil (ROO) was purchased from Columbus Vegetable Oils (Des Plaines, Ill.). DHASCO was purchased from DSM Nutritional Products (Columbia, Md.). Palmitic acid was purchased from Alfa Aesar (Ward Hill, Mass.). The lipid standards C15:0 pentadecanoic acid (>98% purity) and triolein were purchased from Sigma-Aldrich Chemical Co. (St. Louis, Mo.).

Experimental Design for RSM Study. To study the effects of experimental conditions on the incorporation of total palmitic acid, DHA, and palmitic acid in the sn-2 position, response surface methodology (RSM) was applied using the experimental design provided by Modde 5.0 software (Umetrics, Umea, Sweden). A mathematical model was generated by the software to predict the three reaction responses. Three factors were taken into consideration when designing the experiments: reaction time (12-24 h), reaction temperature (55-65° C.), and substrate molar ratio of refined olive oil to DHA FFA to palmitic acid (1:1:6, 1:1:9, and 1:1:12 mol/mol). The resulting design included fifteen different combinations of reaction conditions. Experiments were performed in triplicate resulting in forty-five total reactions.

Preparation of DHA free fatty acid from DHASCO. DHA single cell oils (DHASCO) were converted into DHA FFAs following the methods described above with minor modification. Twenty-five grams of DHA was treated with 5 mg butylated hydroxytoluene and then saponified as in Example 1. 50 mL of distilled water was added to the saponified mixture and the unsaponified matter was extracted twice with hexane (100 mL) and discarded. 10 mol/L HCL was then used to acidify the aqueous layer to a pH about 1.0. 50 ml hexane was employed to extract the liberated free fatty acids. Subsequently, the hexane containing free fatty acids was dried over anhydrous sodium sulfate and the solvent was removed in a rotary evaporator at 60° C. The resulting free fatty acids were flushed with nitrogen and stored in a freezer at −80° C.

Acidolysis Reactions. Refined olive oil of 0.1 g in screw-capped test tubes was mixed with DHA FFA and palmitic acid of a certain amount according to the respective substrate molar ratio. 3 mL hexane and Novozym 435 lipase at 10% (w/w) of the total substrate mass were also added to the reaction mix. The mixture was then incubated in a water bath at its corresponding reaction temperature (55, 60, or 65° C.) with constant agitation at 200 rpm for 12, 18, or 24 h. The reactions were stopped by filtering out the lipase and the product was stored at −80° C. for future analysis. All reactions were performed in triplicate and the average value and standard deviation were reported.

Pancreatic Lipase—Catalyzed sn-2 Positional Analysis. sn-2 positional fatty acid composition was determined following the method described above and/or by reference 103, incorporated herein by reference. All samples were analyzed in triplicate and average values were reported.

Determination of Fatty Acid Profiles. Refined olive oil, DHASCO, and the products (SLs) were converted to FA methyl esters (FAME) following the procedures described in Example 2 above, except that heating steps were 5 min, the injection volume was 1 μL with a split ratio of 5:1, and detection was with flame ionization detector at 250° C. All samples were analyzed in triplicate and average values were reported.

Model Verification. Verification of the model was carried out by randomly selecting five regions from the contour plot and performing acidolysis reactions using the conditions corresponding to these regions. The obtained response values were compared to the predicted values from the model. A chi-square test was done to compare the observed and predicted values.

Statistical Analysis. All the reactions were carried out in triplicates and average values were reported. Response surfaces, regression analysis, and backward elimination were performed using Modde 5.0 software (Umetrics, Umea, Sweden).

### Results and Discussion

Model Fitting. Table 3.1 shows the total fatty acid composition and sn-2 profiles of the SLs produced using the conditions generated by RSM. Refined olive oil was enriched with DHA and palmitic acid by acidolysis reactions. Total DHA incorporation in the SL ranged from zero to 3.5 mol % while total palmitic acid incorporation ranged from 26.8 to 54.6 mol %. Additionally, palmitic acid at sn-2 position ranged from 18.0 to 33.6 mol %. Results were subjected to multiple linear regression and backward elimination analysis to fit into a polynomial model. The regression coefficients ((3) and significance (P) values were calculated based on the numbers in Table 3.1. The respective ANOVA tables for the three responses can be found in Tables 3.2, 3.3, and3. 4. The R² value, the fraction of the variation of the response explained by the model and Q², the fraction of the variation of the response that can be predicted by the model were also listed for each of the three responses.

The model equation for palmitic acid content at the sn-2 position is:

PA at sn-2=27.09−2.10*SR−1.90*Time+1.98*SR*Temp,

where SR stands for substrate molar ratio. It can be seen that both substrate molar ratio and time had a negative impact, while the interaction between substrate molar ratio and temperature had a positive impact. For total palmitic acid and DHA incorporation, the models are: total PA=46.18−1.63*SR+3.29*Temp+9.08*Time−8.64 *Temp*Temp+4.21*Time*Time and total DHA incorporation=0.97−0.79*SR+0.44*Temp+0.65*Time+0.93*SR*SR−0.85 *Temp*Temp+0.66*Time*Time+0.40SR*Temp−0.52 SR*Time. Both models included more significant terms than that for palmitic acid at the sn-2 position. Generally, substrate molar ratio consistently had a negative impact on both responses while temperature and time showed a consistent positive effect. The effect of second-order terms of temperature and time were also consistent in both models with the former being negative and the latter being positive. In addition, the model for total DHA incorporation contained two interaction terms between substrate molar ratio and temperature and time with their effects being positive and negative, respectively.

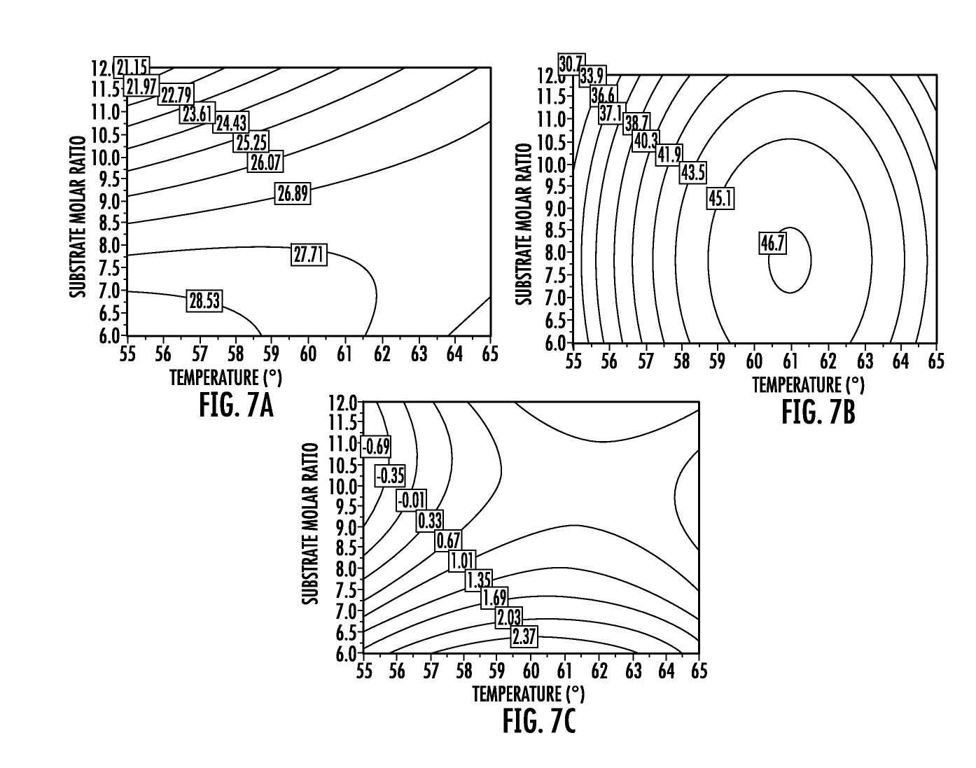

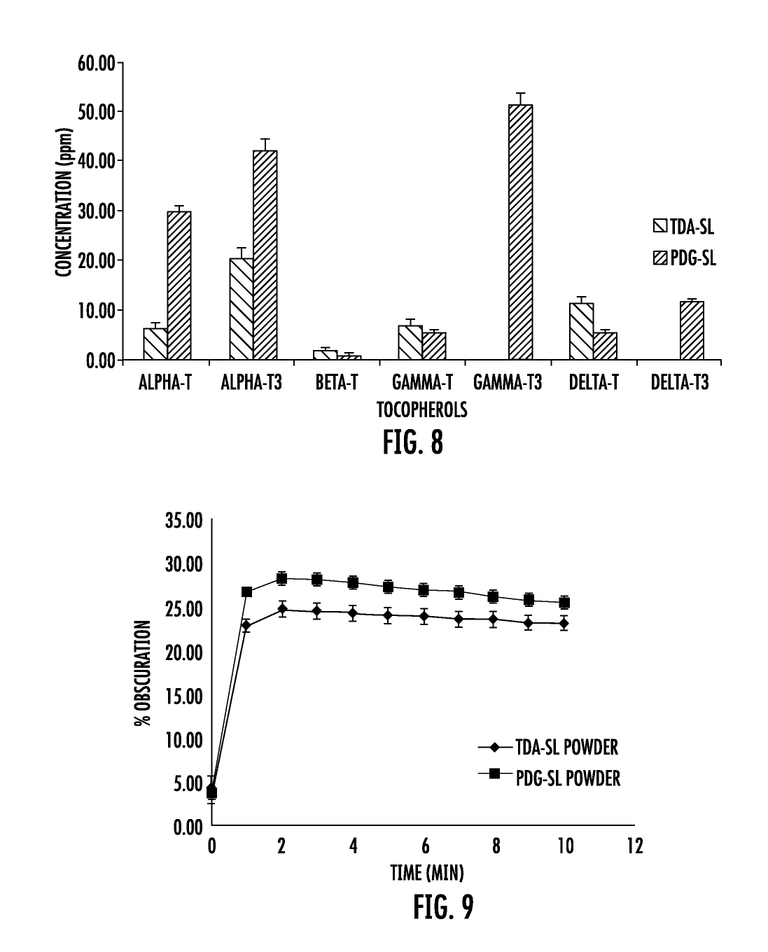

Optimization of the Reaction. Contour plots are generated by Modde 5.0 software to display the relationships between reaction conditions and each response. As shown in FIG. 7A-7C, time was kept constant at 18 h while substrate molar ratio and temperature were placed on y and x-axes, respectively. In general, for both total DHA incorporation (FIG. 7C) and PA at sn-2 position (FIG. 7A), their contents increased as substrate molar ratio was increased. For total PA incorporation (FIG. 7B), the effect of substrate molar ratio was more complicated, as suggested by the second-order model described above. Nonetheless, in all three cases, the effect of temperature displayed a similar pattern, where the response level increased as temperature became higher, and then at a certain point, as temperature continued to increase, the response level started to decrease. The reason for this phenomenon was likely because as temperature started to increase, substrate molecules were more active in the mix and therefore higher responses were recorded; however, as temperature continued to increase, enzyme protein denaturation became an issue and some Novozym 435 was likely inactivated and consequently caused a decrease in response levels as seen in the contour plots.

In addition, it can be seen that to achieve a certain level of response, different combinations of reaction conditions can be utilized. The complex relationship of linear and quadratic variables suggests that the cost-effectiveness of the reaction to produce the desired response values should be considered when optimizing the reaction models.

Verification of the Model. Verification of the models were performed by conducting Chi-square Tests and there were no significant difference between the observed and expected values since the chi square value for total DHA (3.085), total PA (6.997) and PA at sn-2 (3.644) are all smaller than the cutoff point (9.488) at α=0.05 and DF =4 (Table 3.5). Interestingly, although the R² and Q² values for palmitic acid content at sn-2 position was significantly lower than that for the other two responses, seeming to imply the prediction power of the model was low. But the verification results showed that the model is still relatively accurate in terms of its predictability. This is likely because some second-order terms of reaction conditions were eliminated during multiple regression and backward elimination but in fact had some impact on the responses only that the impact were not statistically significant.

The validity of the models were further tested by conducting a scale-up reaction (total substrates of 8 g) without solvent at 60° C. with a substrate molar ratio of 1:1:6 (refined olive oil: DHAFFA:PA) for 12 hours. The results shown (Table 3.6) again proves that the models possess high prediction accuracy for the three responses determined. Moreover, it is worth noting that at sn-2 position, more varieties of fatty acids were detected comparing to that of milligram scale production, noticeably linoleic acid (C18:2n6) and DHA (C22:6n3). This implies that these fatty acids possibly were present at milligram scale production but their signals were too weak to be detected by GC.

Fatty Acid and sn-2 Positional Composition of Refined Olive Oil and SL. The total and sn-2 positional fatty acid compositions of refined olive oil and DHA-FFA are shown in Table 3.6. It can be seen that the major fatty acids in refined olive oil are oleic (73.95 mol %), palmitic (9.97 mol %), linoleic (7.26 mol %), and stearic (6.90 mol %). The dominance of oleic acid is even more striking on the sn-2 position with the oleic being 86.35 mol % while palmitic acid was only 1.49 mol %. As discussed above, in HMF, close to 60% of palmitic acid is located at the sn-2 position where the unsaturated fatty acids such as oleic acid are located at the sn-1,3 positions. Acidolysis reaction was carried out with the aim to increase the palmitic acid content at sn-2 position and the resultant SL contained up to 33.6 mol % palmitic acid at sn-2 compared to 1.5 mol % in the refined olive oil. Additionally, DHA incorporation is 3 mol % when palmitic acid is 33.6 mol % at sn-2 position, which further increases the nutritional value of the SL considering that DHA is normally found at 0.15 to 0.92% in human milk [73].

Although the palmitic acid incorporation at sn-2 position is still lower than the level found in HMF, it is a significant increase from that in refined olive oil. Moreover, the oleic acid composition is in the same range as in HMF, and DHA composition is significantly improved. These findings suggest that the produced SL can be used in an oil blend to produce an infant formula that contains similar fatty acid profile as HMF with added value of higher DHA content.

Conclusion. The SLs produced in the example at small-scale production contain a promising amount of DHA and PA at sn-2 position. The PA content at sn-2 position was increased compared to that of refined olive oil, and the SL has a great potential in infant formula applications. Furthermore, substrates such as tripalmitin that contain high amount of PA at sn-2 position may be added to the reaction mix, such as described in Examples 1 and 2 to improve its composition in the final SL.

TABLE 3.1
Experimental settings of the factors and the responses used for optimization by RSM

| Total Fatty Acid^{a} (mol %) | | | | | | sn-2^{a} (mol %) | |
|---|---|---|---|---|---|---|---|
| | C16:0 | C18:0 | C18:1n9 | C18:2n6 | C22:6n3 | C16:0 | C18:1n9 |
| 6; 55 C.; 12 h | 28.26 ± 1.37 | 2.89 ± 0.53 | 63.26 ± 1.74 | 4.32 ± 2.18 | 1.26 ± 0.12 | 32.46 ± 6.36 | 67.54 ± 6.36 |
| 6; 55 C.; 24 h | 48.13 ± 2.58 | ND | 44.36 ± 2.60 | 3.97 ± 0.21 | 3.54 ± 0.26 | 19.28 ± 4.61 | 80.72 ± 4.61 |
| 6; 60 C.; 18 h | 48.32 ± 0.52 | 1.47 ± 0.03 | 43.65 ± 0.45 | 4.02 ± 0.04 | 2.54 ± 0.08 | 28.72 ± 3.12 | 71.28 ± 3.12 |
| 6; 65 C.; 12 h | 31.98 ± 2.13 | 2.53 ± 0.16 | 58.4 ± 1.67 | 5.15 ± 0.18 | 1.94 ± 0.20 | 31.57 ± 0.81 | 68.43 ± 0.81 |
| 6; 65 C.; 24 h | 54.64 ± 1.72 | 1.53 ± 0.34 | 36.95 ± 1.49 | 3.45 ± 0.22 | 3.43 ± 0.19 | 22.69 ± 1.37 | 77.31 ± 1.37 |
| 9; 55 C.; 18 h | 31.33 ± 0.76 | 2.50 ± 0.09 | 60.73 ± 0.79 | 5.43 ± 0.03 | ND | 25.27 ± 0.94 | 74.73 ± 0.94 |
| 9; 60 C.; 12 h | 45.52 ± 1.80 | 1.87 ± 0.20 | 48.36 ± 1.47 | 4.26 ± 0.14 | ND | 24.71 ± 1.45 | 75.29 ± 1.45 |
| 9; 60 C.; 18 h | 45.13 ± 0.60 | 1.62 ± 0.04 | 47.62 ± 0.48 | 5.03 ± 0.65 | 1.46 ± 0.03 | 24.45 ± 3.47 | 75.55 ± 3.47 |
| 9; 60 C.; 24 h | 55.79 ± 1.22 | 1.29 ± 0.09 | 36.54 ± 1.07 | 3.37 ± 0.21 | 3.01 ± 0.13 | 33.63 ± 1.69 | 66.37 ± 1.69 |
| 9; 65 C.; 18 h | 44.29 ± 3.13 | 1.87 ± 0.23 | 49.42 ± 2.71 | 4.43 ± 0.19 | ND | 29.72 ± 0.67 | 70.28 ± 0.67 |
| 12; 55 C.; 12 h | 26.81 ± 0.71 | 2.73 ± 0.03 | 64.78 ± 0.66 | 5.68 ± 0.03 | ND | 27.21 ± 1.88 | 72.79 ± 1.88 |
| 12; 55 C.; 24 h | 45.70 ± 0.53 | 1.84 ± 0.21 | 48.17 ± 0.29 | 4.28 ± 0.29 | ND | 18.01 ± 0.83 | 81.99 ± 0.83 |
| 12; 60 C.; 18 h | 40.36 ± 1.85 | 1.93 ± 0.09 | 52.07 ± 1.74 | 4.68 ± 0.14 | 1.01 ± 0.12 | 24.88 ± 1.32 | 75.12 ± 1.32 |
| 12; 65 C.; 12 h | 31.58 ± 1.70 | 2.57 ± 0.08 | 58.64 ± 1.51 | 5.16 ± 0.03 | 2.05 ± 0.27 | 30.04 ± 1.26 | 69.96 ± 1.26 |
| 12; 65 C.; 24 h | 50.12 ± 1.70 | 1.44 ± 0.04 | 42.88 ± 1.32 | 3.90 ± 0.07 | 1.71 ± 0.18 | 23.57 ± 1.26 | 76.43 ± 1.26 |

^{a}Mean ± SD, n = 3; ND: not detected

TABLE 3.2
ANOVA table for PA at sn-2 position

| | | | MS | | | |
|---|---|---|---|---|---|---|
| PA at sn-2 | DF | SS | (variance) | F | p | SD |
| Total | 45 | 33781.5 | 750.7 | | | |
| Constant | 1 | 32930.7 | 32930.7 | | | |
| Total | 44 | 850.801 | 19.3364 | | | 4.39732 |
| Corrected | | | | | | |
| Regression | 9 | 368.523 | 40.947 | 2.97162 | 0.010 | 6.39899 |
| Residual | 35 | 482.277 | 13.7794 | | | 3.71206 |
| Lack of Fit | 5 | 376.963 | 75.3927 | 21.4765 | 0.000 | 8.68289 |
| (Model | | | | | | |
| Error) | | | | | | |
| Pure Error | 30 | 105.314 | 3.51047 | | | 1.87363 |
| (Replicate | | | | | | |

N = 45,
DF = 35,
Q² = 0.098,
R² = 0.433,
R²_{adj} = 0.287;
DF: degree of freedom;
SS: sum of squares;
MS: mean square;
SD: standard deviation

TABLE 3.3
ANOVA table for incorporation of PA

| | | | MS | | | |
|---|---|---|---|---|---|---|
| Total PA | DF | SS | (variance) | F | p | SD |
| Total | 45 | 82696.6 | 1837.7 | | | |
| Constant | 1 | 78734.1 | 78734.1 | | | |
| Total | 44 | 3962.46 | 90.0559 | | | 9.48978 |
| Corrected | | | | | | |
| Regres- | 9 | 3638.86 | 404.318 | 43.7305 | 0.000 | 20.1077 |
| sion | | | | | | |
| Residual | 35 | 323.599 | 9.24568 | | | 3.04067 |
| Lack | 5 | 241.469 | 48.2937 | 17.6404 | 0.000 | 6.94937 |
| of Fit | | | | | | |
| (Model | | | | | | |
| Error) | | | | | | |
| Pure Error | 30 | 82.1301 | 2.73767 | | | 1.65459 |
| (Replicate | | | | | | |
| Error) | | | | | | |

N = 45,
DF = 35,
Q² = 0.869,
R² = 0.918,
R²_{adj} = 0.897

TABLE 3.4
ANOVA table for incorporation of DHA

| Total | | | | | | |
|---|---|---|---|---|---|---|
| DHA | DF | SS | MS | F | p | SD |
| Total | 45 | 166.617 | 3.7026 | | | |
| Constant | 1 | 96.1353 | 96.1353 | | | |
| Total | 44 | 70.4817 | 1.60186 | | | 1.26564 |
| Corrected | | | | | | |
| Regres- | 9 | 61.8262 | 6.86958 | 27.7785 | 0.000 | 2.62099 |
| sion | | | | | | |
| Residual | 35 | 8.65545 | 0.247298 | | | 0.497291 |
| Lack | 5 | 8.0781 | 1.61562 | 83.9507 | 0.000 | 1.27107 |
| of Fit | | | | | | |
| (Model | | | | | | |
| Pure Error | 30 | 0.577346 | 0.0192449 | | | 0.138726 |
| (Replicate | | | | | | |

N = 45,
DF = 35,
Q² = 0.808,
R² = 0.877,
R²_{adj} = 0.846

TABLE 3.5
Verification of the models using Chi-squared test

| | | | | O | E | O | E | O | E | (O − E)²/E | | |
|---|---|---|---|---|---|---|---|---|---|---|---|---|
| | | Temp | Time | Total | Total | Total | Total | PA at | PA at | Total | Total | PA at |
| Region | SR | (° C.) | (h) | DHA | DHA | PA | PA | sn-2 | sn-2 | DHA | PA | sn-2 |
| 1 | 7 | 57 | 15 | 0 | 1.12 | 28.01 | 37.6 | 25.36 | 29.4 | 1.12 | 2.446 | 0.555 |
| 2 | 8 | 56 | 13 | 0 | 0.225 | 22.90 | 33.7 | 24.92 | 29.7 | 0.225 | 3.461 | 0.769 |
| 3 | 9 | 60 | 22 | 1.98 | 0.986 | 49.01 | 54.1 | 28.68 | 26.4 | 1.002 | 0.479 | 0.197 |
| 4 | 10 | 63 | 20 | 1.36 | 1.05 | 44.63 | 47.7 | 20.08 | 26.3 | 0.092 | 0.198 | 1.471 |
| 5 | 11 | 59 | 17 | 0 | 0.646 | 37.74 | 41.9 | 29.36 | 25.3 | 0.646 | 0.413 | 0.652 |
| χ² | | | | | | | | | | 3.085 | 6.997 | 3.644 |

SR: substrate molar ratio (ROO:DHAFFA:PA);
O: observed response mol %;
E: expected response mol %.

TABLE 3.6
Total and sn-2 fatty acid composition (mol %) of SL from
scale-up trial

| | |
|---|---|
| Observed^{a} | Predicted^{a} |

| Fatty Acid | Total | sn-2 | Total | sn-2 |
|---|---|---|---|---|
| C14:0 | 1.25 ± 0.17 | ND | 45.7 | 28.2 |
| C16:0 | 42.94 ± 4.35 | 28.23 ± 0.55 | | |
| C16:1 | 0.65 ± 0.06 | ND | | |
| C18:0 | 1.56 ± 0.06 | ND | | |
| C18:1n9 | 46.14 ± 4.31 | 62.37 ± 0.31 | | |
| C18:2n6 | 4.33 ± 0.37 | 7.22 ± 0.18 | | |
| C18:3n3 | 0.38 ± 0.04 | ND | | |
| C22:6n3 | 2.75 ± 0.36 | 2.19 ± 0.42 | 2.69 | |

^{a}Mean ± SD, n = 3;
ND: not detected

TABLE 3.7
Total fatty acid and sn-2 profile (mol %) of refined
olive oil and DHA-FFA

Refined Olive Oil

| Fatty Acid | Total | sn-2 | DHA-FFA^{a} |
|---|---|---|---|
| C12:0 | ND | ND | 5.55 ± 0.37 |
| C14:0 | ND | ND | 12.59 ± 0.13 |
| C16:0 | 9.97 ± 0.08 | 1.49 ± 0.33 | 10.67 ± 0.12 |
| C16:1n7 | 1.01 ± 0.00 | 0.84 ± 0.01 | 2.64 ± 0.05 |
| C18:0 | 6.90 ± 0.15 | ND | 0.57 ± 0.01 |
| C18:1n9 | 73.95 ± 0.55 | 86.35 ± 0.32 | 16.84 ± 0.41 |
| C18:2n6 | 7.26 ± 0.01 | 10.30 ± 0.03 | 0.68 ± 0.02 |
| C18:3n3 | 0.51 ± 0.00 | 1.01 ± 0.02 | ND |
| C22:6n3 | ND | ND | 47.90 ± 1.09 |

^{a}Others include: C8:0, C10:0, C14:1

### Example 4

### Spray-Dried Structured Lipid Containing Long-Chain Polyunsaturated Fatty Acids for Use in Infant Formulas

### Materials and Methods

Materials. DHASCO® and ARASCO® were as described in example 1 above. GLA in free fatty acid form (70% GLA) was purchased from Sanmark Corp. (Greensboro, N.C.). Tripalmitin was purchased from Tokyo Chemical Industry America (Montgomeryville, Pa.). Palm olein (San Trans25) was generously donated by IOI-Loders Croklaan (Channahon, Ill.).

Synthesis of SL Mixtures:

Two structured lipids (SLs) were prepared via lipase-catalyzed acidolysis reaction as generally described in the examples above. The fatty acid composition of these SLs are shown in Table 4.1.

Briefly, TDA-SL was prepared from tripalmitin and a free fatty acid mix of DHASCO and ARASCO. The solvent-free acidolysis reaction was performed in a 1 L-stirred batch reactor at 60° C. for 24 hours with a substrate mole ratio of 9 (a mixture of FFAs to tripalmitin), 10% (w/w) of Lipozyme TL IM, and a constant stirring at 200 rpm. The reactor was wrapped with foil to reduce exposure to light. At the end of the reaction, the resulting SL was vacuum filtered through a Whatman no. 1 containing sodium sulfate and then through a 0.45 μm membrane filter to dry and separate the SL from the enzyme. SL was stored in an airtight amber container under nitrogen at 4° C. Purification of SL product was performed using short-path distillation and followed by alkaline deacidification. Distillation was performed under the following conditions: 60° C. holding temperature; approximately 100 mL/h feeding rate; 170° C. heating oil temperature; 20° C. coolant temperature; and vacuum <13.33 Pa. Deacidification by alkaline extraction was performed according to the method described in the examples above with minor modification. Purified SL (10 g) from short-path distillation was mixed with hexane (150 mL), phenolphthalein solution, and 80 mL of 0.5 N KOH in 20% ethanol. The separation was obtained in a separatory funnel, and the upper phase was collected. The upper phase was extracted with another 30 mL of 0.5 N KOH in 20% ethanol and 60 mL of saturated NaCl solution. The hexane phase containing SL was passed through a sodium sulfate column. Hexane was evaporated to obtain the deacidified SL. The deacidification step was completed to obtain sufficient purified SL for further studies (FFAs<0.1%).

PDG-SL was prepared from palm olein and a free fatty acid mix of DHASCO and GLA in a similar manner with modifications. The substrate mole ratio was 2 (palm olein: FFA mix) and Novozym 435 (10% weight of total reactants) as biocatalyst. The reaction was incubated for 22.7 hours with constant stirring, at 200 rpm. Short-path distillation (KDL-4 unit, UIC Inc.) was used to remove FFAs from the SL under the following conditions: holding temperature: 60° C.; feeding rate: ˜100 mL/h; heating oil temperature: 185° C.; coolant temperature: 15-20° C.; and vacuum: <100 mTorr. The SL obtained was stored under nitrogen at −80° C. until further use.

Preparation of SL powders. TDA-SL and PDG-SL were microencapsulated following the method of Augustin [11, which is hereby incorporated herein by reference for the microencapsulation process] with minor modification. Whey protein isolate (21 g) was reconstituted in 350 mL water at 60° C. followed by the addition of corn syrup solid (42 g). NaOH solution (1 M) was added to the mixture to adjust the pH to 7.5. The mixture was heated in a water-bath at 90° C. for 30 min and cooled down to 60° C. before the addition of TDA-SL or PDG-SL (21 g). The oil was dispersed into the mixture using a benchtop homogenizer (Brinkmann Kinematica Polytron, Luzern, Switzerland). The pre-emulsion was passed through a high-pressure homogenizer (Avestin Emulsiflex-C5, Ontario, Canada) in two steps at 35 MPa and subsequently at 10 MPa. The homogenized emulsion was held at 60° C., spray-dried at inlet temperature of 180° C. and outlet temperature of 80° C. at a feeding rate of 5 mL/min.

Microencapsulation efficiency. Extraction of total oil was carried out according to the method of Klinkesorn [61, which is hereby incorporated herein by reference for the extraction process] with some modifications. Two milliliters of distilled water was added to 0.5 g powder. The mixture was vortexed for 1 min before adding 25 mL hexane/isopropanol (3:1, v/v). The tube was subsequently vortexed three times for 5 min each and centrifuged for 30 min at 3,000 g. The organic phase was collected. The aqueous phase was re-extracted twice with the same solvent mixture. After filtration through a sodium sulfate column, the solvent was evaporated at 60° C. using a rotary evaporator (Büchi Rotavapor, Flawil, Switzerland). The amount of total oil was determined gravimetrically. Free oil or hexane extractable oil was determined gravimetrically after extraction of 2.5 g powder with 15 mL of hexane. The mixture was vortexed for 3 min and centrifuged at 3,000 g for 30 min. The supernatant was filtered, and the filter paper was washed twice with hexane. The filtrate was collected, and hexane was evaporated at 60° C. Microencapsulation efficiency (ME) was calculated as follows:

ME=[(total oil−free oil)/total oil]×100

The units for total oil and free oil were g/g of sample.

Water activity (a_{w}) and moisture content. The water activity of SL powders was measured with Aqua Lab water activity meter (CX-2, Decagon Devices, Inc., Pullman, Wash.) at 25° C. Two grams of sample was weighed into an aluminum pan and dried for 24 h at 70° C. and 29 in.Hg in vacuum oven (Fisher Scientific, Fairlawn, N.J.). Moisture content was calculated from the weight difference.

Lipid oxidation measurement. Lipid hydroperoxide and thiobarbituric acid-reactive substances (TBARS) were measured using a modified method of Klinkesorn [62, which is hereby incorporated by reference]. SL powder (0.1 g) was reconstituted in 0.3 mL distilled water. The reconstituted sample was added to 1.5 mL of isooctane-2-propanal (3:1, v/v) followed by vortexing 3 times for 10 sec each and centrifuging at 3,000 g for 2 min. The organic phase (0.2 mL) was collected and added to 2.8 mL methanol-butanol (2:1, v/v), followed by 15 μL thiocyanate solution (3.94 M) and 15 μL ferrous iron solution. The solution was vortexed and the absorbance measured at 510 nm after 20 min. Ferrous iron solution was prepared by mixing 0.132 M BaCl₂ and 0.144 M FeSO₄ in acidic solution. Lipid hydroperoxide concentrations were determined using a cumene hydroperoxide standard curve. Thiobarbituric acid (TBA) solution was prepared by mixing 15 g trichoroacetic acid, 0.375 g TBA, 1.76 mL 12 N HCl, and 82.9 mL distilled water. Three milliliters of 2% butylated hydroxytoluene (BHT) in ethanol was added to 100 mL of TBA solution, and 2 mL of this solution was mixed with 1 mL of reconstituted sample (5 mg of emulsion powder in 1 mL of distilled water). The mixture was vortexed, heated in a boiling water bath for 15 min, and centrifuged at 3,000 g for 25 min. The absorbance of the supernatant was measured at 532 nm. TBARS concentrations were determined using standard curve prepared with 1,1,3,3 -tetraethoxypropane.

Accelerated oxidative tests. The oxidative stability of SL powders was also evaluated by accelerated oxidative tests using differential scanning calorimetry (DSC). The calorimetric measurements were performed with Netzsch DSC 204 F1 Phoenix (Burlington, Mass.). Oxygen was used as the purge gas at a rate of 20 mL/min. The instrument was calibrated with indium using standard DSC procedure. Samples (4-5 mg) were placed in crimped aluminum sample pans. In order to facilitate the contact of samples to oxygen, the lid of each pan was perforated by four pinholes. Determination of the onset oxidation temperature (OOT) was carried out in the temperature interval of 50-300° C. with a heating rate of 10° C./min. The oxidation induction time (OIT) was determined isothermally at 200° C. All measurements were performed in triplicate and average was reported.

Tocopherol analysis. Tocopherol analysis was performed as described in Example 1 above, except, rention times for authentic standards were 0.03 to 1.25 μg/mL in hexane containing 0.01% BHT and quantification was reported as parts per million (ppm) from the average of triplicate determinations.

Dispersibility of SL powder. Dispersibility was determined by adding a small amount of powder (˜0.1 g) into the stirring chamber (2,000 rpm) of a laser diffraction instrument (Malvern Laser Particle Size Analyzer, Mastersizer S, Malvern Instruments, Southborough, Mass.). The measurement was performed with distilled water as dispersant. The dispersibility was assessed by measuring the change in mean particle diameter (d_{4,3}) and obscuration (the fraction of light lost from the main laser beam when the sample was introduced) as a function of time (Klinkesorn and others 2005).

Statistical analysis. Mean values and standard deviations of at least triplicate determinations were reported. Independent samples t-test (α=0.05) was performed using IBM SPSS Statistics 21 to determine a significant difference between TDA-SL and PDG-SL powders.

### Results and Discussion

Fatty acid composition and positional distribution of TDA-SL and PDG-SL. Tripalmitin and palm olein were modified via lipase-catalyzed acidolysis reaction with a free fatty acid mix of DHASCO and ARASCO (yielding TDA-SL), and a free fatty acid mix of DHASCO and GLA (yielding PDG-SL), respectively. The fatty acid profile of these SLs and their substrates are shown in Table 4.1. The levels of palmitic acid at the sn-2 position of TAGs in TDA and PDG-SLs were 48.53 and 35.11%, respectively. These levels are lower than the content of sn-2 palmitic acid in HMF, which are greater than 50% (Straarup and others 2006). However, these levels are higher than the levels in vegetable oils (5-20% sn-2 palmitic acid) (Mattson and Lutton 1958), which are commonly added as fat ingredient in infant formula mix. The levels of LCPUFAs in HMF vary and depend on the mothers' diet. The reported value of ARA, DHA, and GLA in human milk are 0.24-1.00%, 0.06-1.40%, and 0.07-0.12%, respectively (Brenna and others 2007; Jensen 1999). TDA-SL contained 17.69% ARA and 10.75% DHA. PDA-SL contained 5.03% GLA, and 3.75% DHA. These SLs can be partially added in vegetable oil blend used in infant formula to provide palmitic acid at the sn-2 position and the beneficial LCPUFAs.

Moisture content and water activity (a_{w}). Moisture content and a_{w} affect the shelf life of food products and influence the rate of lipid oxidation. The maximum moisture content of dried powder specified by the food industry is between 3-4% (Master 1991). SL powders produced in this study have moisture contents of 1.78-1.96% and water activities of 0.15-0.16 (Table 4.2). In general, low moisture content (1-3%) and low a_{w} (0.10-0.25) are achieved through spray-drying conducted at a temperature between 165-195° C. (Hogan and others 2001; Klinkesorn and others 2006). The role of water in lipid oxidation depends on the structure and composition of the food. For example, storage study of spray-dried tuna oil coated with a lecithin-chitosan wall, conducted at equilibrium relative humidity (RH) of 11, 33, and 52% showed a rapid oxidation at lower relative humidities (11 and 33% RH) (Klinkesorn and others 2005). This contradicts the generalized view that lipid oxidation in foods is at its lowest level when a_{w} is between 0.2 and 0.4 (monolayer water), but increases rapidly when the a_{w} is either decreased or increased (Karel and others 1967). Further evidence showed that initial powder quality of dried-whole milk powder was retained best at a_{w} between 0.11 and 0.23 (Stepelfeldt and others 1997).

Efficiency of microencapsulation. Microencapsulation efficiency reflects the presence of free oil on the surface of the particles, and the degree to which the wall can prevent extraction of internal oil (Hogan and others 2001). Previously reported microencapsulation efficiencies using MRPs as encapsulants were between 80-98%, depending on the type of protein, the oil to protein ratio, and the oil load in the powder (Rus li and others 2006). Microencapsulation efficiency for the SL powders was 90%, and in the mid-range of the reported values. These lower values may be a result of the different extraction conditions used.

Oxidative stability. During lipid oxidation hydroperoxide primary oxidation products form continuously, and break down into a variety of non-volatile and volatile secondary products (Shahidi and Zhong 2005). The oxidative stability of dried SL powders was determined on the basis of total lipids for both lipid hydroperoxide (PV) and TBARS formation (Table 4.2). The levels of hydroperoxide and TBARs of these SL powders were comparable to fish oil powders produced in previous study (Klinkesorn and others 2005). Both TDA-SL and PDG-SL powders have low TBARS and PV values suggesting their stability to oxidative stress. MRPs possess antioxidant properties (Wijewickreme and others 1999) and may be providing protection to the unsaturated oils. Hydroperoxide concentrations in spray-dried TDA-SL powder were significantly higher than PDG-SL (p<0.05). TDA-SL powder had slightly higher TBARS concentration compared to PDG-SL powder; however, the differences were not significant (p>0.05). The oxidative stability index (OSI), determined using an oxidative stability instrument at 110° C. also indicated a higher oxidative stability for PDG-SL powder (data not shown). Both SL powders were prepared using the same microencapsulation protocol. The lower degree of oxidation for TDA-SL indicates that PDG-SL was relatively more stable to oxidizing conditions during the microencapsulation process. The amount of polyunsaturated fatty acids was greater than 30% in TDA-SL, but lower than 20% in PDG-SL (Table 4.1). Higher concentration of unsaturated fatty acids in the oil may contribute to an increase in the rate of lipid oxidation. The greater the degree of unsaturation in a fatty acid the more vulnerable it is to lipid oxidation. DHA (6 double bonds), ARA (4 double bonds), and GLA (3 double bonds) are LCPUFAs in the SLs with high degree of unsaturation. The lower oxidative stability in TDA-SL is likely attributable to a higher amount of DHA and ARA with higher degree of unsaturation, compared to PDG-SL.

Tocopherol analysis of oil substrates. The oxidative stability of fats and oils depends on fatty acid composition and on the amount of antioxidant present. Antioxidant effects of tocopherols in the oils may help improve the oxidative stability of the products during microencapsulation process. Tocopherol analysis revealed that TDA-SL contained a lower amount of total tocopherols (48.19 ppm) compared to PDG-SL (147.84 ppm). The amount of each tocopherol and tocotrienol in TDA-SL and PDG-SL are shown in FIG. 8. Tocotrienols are present at higher concentrations in PDG-SL. The substrate oil for PDG-SL is palm olein, a natural source of vitamin E. The higher oxidative stability of PDG-SL microencapsulated product is possibly due to the lower amount and lower degree of unsaturation of LCPUFAs and higher content of total tocopherols in PDG-SL compared to TDA-SL.

Accelerated stability test. Oxidation reactions are exothermic process, which can be measured by DSC either in an isothermal or non-isothermal mode. Oxidation onset temperature (OOT) is a relative measure of the degree of oxidative stability of the material evaluated at a given heating rate and oxidative environment. The higher the OOT value, the more stable the material (ASTM Standard E2009-2008). Similarly, oxidative induction time (OIT) is a relative measure of the degree of oxidative stability of the material evaluated at the isothermal temperature of the test (ASTM Standard El 858-2008). OOT and OIT values were determined for SL powders to obtained relative oxidative stability information. DSC measurements were conducted at a heating rate of 10° C./min for OOT and isothermally at 200° C. for OIT. PDG-SL powder has a higher OOT and a longer OIT compared to TDA-SL powder (Table 4.2). Again, this is possibly due to the differences in the levels of antioxidants and unsaturated fatty acids between the two SLs powders since they were produced using the same microencapsulation and spray-drying method.

Product dispersibility. A small sample (˜0.1 g) of the SL powder was added to a continuously stirred measurement chamber filled with distilled water. The volume-weighed average diameter d_{4,3} (the sum of the volume ratio of droplets in each size class multiplied by the mid-point diameter of the size class) is sensitive to the presence of large particles in an emulsion, and therefore sensitive to phenomena such as flocculation (Walstra 2003). The obscuration is sensitive to the total amount of material dispersed in the fluid. The change in obscuration as a function of time, and the mean particle size d_{4,3} were measured to assess the dispersibility of SL powder (Walstra 2003). FIG. 9 showed that the droplet obscuration of both SL powders increased steeply within the first minute of agitation time, after that it reached a fairly constant value (approximately 24% for TDA-SL powder and 27% for PDG-SL powder). In addition, d_{4,3} decreased after 1 min of stirring time, as shown in FIG. 10. Both obscuration and d_{4,3} reached a relatively constant value (approximately 1.7 μm for TDA-SL powder and 2 μm for PDG-SL powder) soon after 2-3 min. Rapid decrease in particle size and increase in droplet obscuration indicated that these products dispersed quickly into homogeneous suspension (Raphael and Rohani 1996).

### Conclusion

Two enzymatically synthesized SLs for infant formula use were encapsulated and spray-dried into a powder form. These SLs were encapsulated in MRPs of a heated whey protein isolates and corn syrup solid. The encapsulated SL powders resulted in 90% encapsulation efficiency, low peroxide values, and low TBARs values. These powders were rapidly dispersed in water to give a homogenous suspension. The powder containing SL with a higher degree of unsaturation and a lower concentration of tocopherols resulted in higher peroxide and TBARs values. The results suggested that the degree of unsaturation and concentration of the antioxidant present in the starting oils influence the oxidative stability of the encapsulated products.

TABLE 4.1
Fatty acid composition and positional distribution (%) of enzymatically produced TDA-SL
and PDG-SL

| | TDA-SL | | PDG-SL | |
|---|---|---|---|---|
| Fatty acids | Total | sn-2 | Total | sn-2 |
| Lauric acid C12:0 | 1.94 ± 0.01 | 3.00 ± 0.13 | 0.53 ± 0.00 | 0.65 ± 0.08 |
| Myristic acid C14:0 | 5.09 ± 0.02 | 4.84 ± 0.14 | 1.72 ± 0.01 | 2.41 ± 0.09 |
| Palmitic acid C16:0 | 36.70 ± 0.11 | 48.53 ± 1.40 | 37.55 ± 0.13 | 35.11 ± 0.02 |
| Stearic acid C18:0 | 4.29 ± 0.02 | 4.03 ± 0.03 | 3.87 ± 0.02 | 3.55 ± 0.17 |
| Oleic acid C18:1 n-9 | 15.28 ± 0.03 | 9.82 ± 0.12 | 36.40 ± 0.25 | 33.99 ± 1.05 |
| Linoleic acid C18:2 n-6 | 2.89 ± 0.02 | 1.83 ± 0.01 | 10.09 ± 0.09 | 10.14 ± 0.16 |
| Gamma-linolenic acid C18:3 n-6 | 0.83 ± 0.01 | 0.19 ± 0.00 | 5.03 ± 0.02 | 5.43 ± 0.90 |
| Arachidonic acid C20:4 n-6 | 17.69 ± 0.09 | 9.73 ± 0.13 | — | — |
| Docosahexaenoic acid C22:6 n-3 | 10.75 ± 0.15 | 4.80 ± 0.03 | 3.75 ± 0.02 | 2.25 ± 0.10 |

TABLE 4.2
Product characteristics of microencapsulated
TDA-SL and PDG-SL powder^{a}

| Product characteristics | TDA-SL powder | PDG-SL powder |
|---|---|---|
| Total oil (g/g of sample) | 0.2373 ± 0.0019 | 0.2502 ± 0.0099 |
| Free oil (g/g of sample) | 0.0237 ± 0.0017 | 0.0240 ± 0.0013 |
| Microencapsulation efficiency (%) | 90.00 ± 0.73 | 90.39 ± 0.55 |
| Moisture content (%) | 1.78 ± 0.09 | 1.96 ± 0.03 |
| Water activity, a_{w} | 0.15 ± 0.02 | 0.16 ± 0.03 |
| Hydroperoxide value, PV | 20.22 ± 0.65* | 4.98 ± 0.78* |
| (mmol/kg oil) | | |
| TBARS (mmol/kg oil) | 1.00 ± 0.14 | 0.64 ± 0.07 |
| Oxidative onset temperature^{b}, | 225.67 ± 1.15* | 239.23 ± 0.89* |
| OOT (° C.) | | |
| Oxidative induction time^{c}, | 5.17 ± 0.06* | 11.60 ± 0.00* |
| OIT (min) | | |

^{a}Microencapsulation was prepared using 1:1 ratio of oil to protein and 25% oil load in powder. Average values of at least triplicate measurements were reported. Asterisk indicates values with significant difference (p < 0.05) between the two SL microcapsules.
^{b}OOT determined by DSC at a heating rate of 10° C./min.
^{c}OIT determined by DSC isothermally at 220° C.

### Example 5

Synthesis of Structured Lipid Enriched with Omega Fatty Acids and sn-2 Palmitic Acid by Enzymatic Esterification, and Its Incorporation in Powdered Infant Formula

### Materials and Methods

Materials. Materials are as provided and described in Example 1 or Example 4, except as follows. Tripalmitin and internal standard C15:0 pentadecanoic acid (>98% purity) were purchased from Tokyo Chemical Industry America (Montgomeryville, Pa.). Triolein, and ethyl oleate were purchased from Sigma-Aldrich Chemical Co. (St. Louis, Mo.). TAG standard mix (GLC reference standard) was purchased from Nu-check Prep, Inc. (Elysian, Minn.). Other ingredients including non-fat dry milk, lactose, and infant formula vitamin and mineral premix were generously donated by O-AT-KA Milk Products Cooperative, Inc. (Batavia, N.Y.), Hilmar Ingredients (Hilmar, Calif.), and Fortitech, Inc. (Schenectady, N.Y.), respectively.

Preparation of FFAs and FAEEs. DHASCO and ARASCO were mixed at a mole ratio of 1:1 prior to the preparations of FFAs and FAEEs. The mixture contained 26.01±0.35% DHA, 22.56±0.56% ARA, 18.65±0.32% oleic acid, 8.90±0.02% palmitic acid, 5.62±0.02% myristic acid, 4.47±0.03% stearic acid, and 2.56±0.19% lauric acid. Hydrolysis and ethanolysis of the oil mixture were performed according to the methods described in the examples above, with some modifications described here. For hydrolysis, 150 g of oil was saponified using KOH (34.5 g), distilled water (66 mL), 96% ethanol (396 mL), and butylated hydroxytoluene (0.03 g). 120 mL of distilled water was added to stop reaction and acidified to pH 2 to release FFAs. The FFAs were washed, filtered through a sodium sulfate column, and stored in an amber Nalgene bottle under nitrogen at −20° C. until use.

For ethanolysis, the reaction was performed by mixing oil with sodium ethoxide (2.625%, v/v) in absolute ethanol at a ratio of 4:2 (v/v) (2.25-fold molar excess of ethanol). The mixture was heated at 60° C. with mechanical shaking for 40 min, under nitrogen atmosphere. The product was first washed with 100 mL of a saturated NaCl solution, and then washed with 100 mL of distilled water. After separation, FAEEs were dried over sodium sulfate, vacuum filtered, and stored similarly as FFAs. FFAs and FAEEs were confirmed by thin-layer chromatography (TLC) analysis using oleic acid and ethyl oleate, respectively as standards.

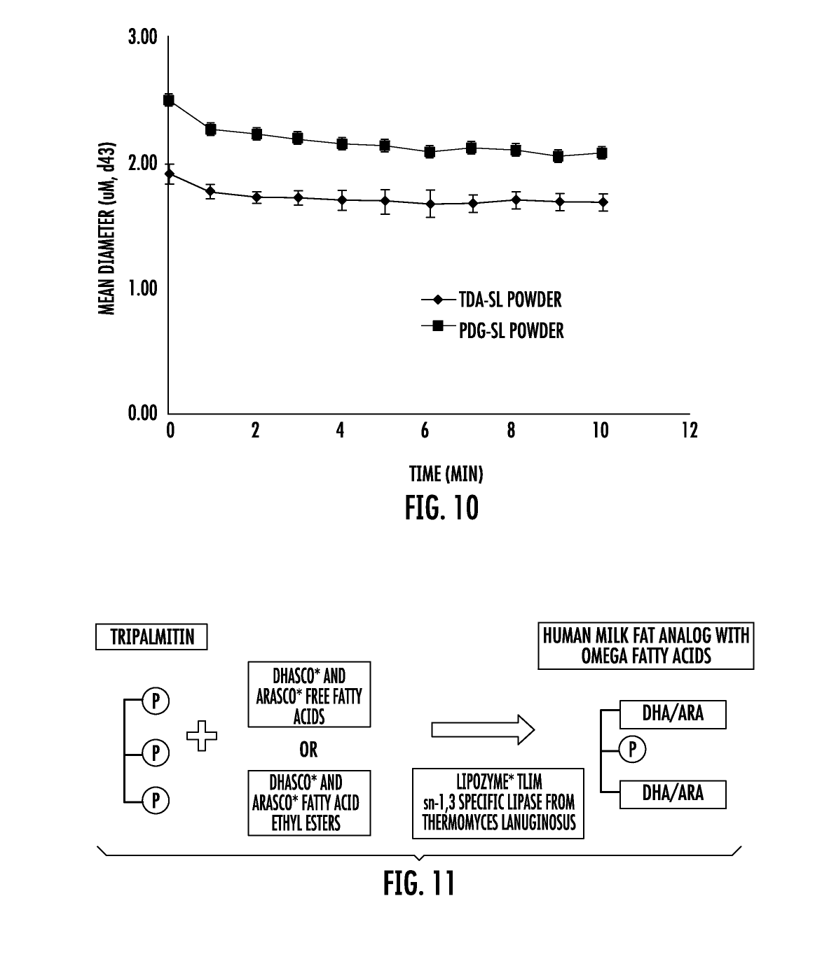

Small-scale Synthesis and Analysis of SL Products. SLs were produced using two types of reactions, acidolysis (with FFAs as substrate) and interesterification (with FAEEs as substrate) as illustrated in FIG. 11. The reaction mixtures included hexane (3 mL) and a mixture of FFAs or FAEEs and tripalmitin at different substrate mole ratios (FFAs or FAEEs to tripalmitin at 3, 6, and 9 mol/mol) were placed in screw-capped test tubes. Lipozyme TL IM (10% of total weight of the substrates) was added. The tubes were incubated at 60° C. for 12, 18, and 24 h in an orbital shaking water bath at 200 rpm. The products were collected and passed through a sodium sulfate column to remove moisture and enzyme. All reactions were performed in triplicate. Averages and standard deviations are reported.

TLC analysis of product was carried out according to the method described by Lumor and Akoh [76, which is hereby incorporated by reference herein] with modification. Fifty microliters of the reaction product was spotted on silica gal G TLC plate. Petroleum ether/ethyl ether/acetic acid (80:20:0.5, v/v/v) was used to develop the plates (for SL made with FFAs), and a 90:10:0.5 (v/v/v) combination (for SL made with FAEEs). The bands were sprayed with 0.2% 2,7-dichlorofluorescein in methanol and visualized under UV light. The TAG band was scraped off into a screw-capped test tube for fatty acid composition analysis. TAG sample was converted to fatty acid methyl esters (FAMEs) following AOAC official method 996.01 as described above.

Large-scale Synthesis and Purification of SL. The conditions given highest incorporation of ARA and DHA were selected for 1 L-scale production of SL. The solvent-free acidolysis reaction was performed in a 1 L-stirred batch reactor at 60° C. for 24 h with a substrate mole ratio of 9 (a mixture of FFAs to tripalmitin), 10% (w/w) of Lipozyme TL IM, and a constant stirring at 200 rpm. The reactor was wrapped with foil to reduce exposure to light. At the end of the reaction, the resulting SL was vacuum filtered through a Whatman no.1 containing sodium sulfate and then through a 0.45 μm membrane filter to dry and separate the SL from the enzyme. SL was stored in an airtight amber container under nitrogen at 4° C.

Purification of SL product was performed using short-path distillation and followed by alkaline deacidification. Distillation was performed under the following conditions: 60° C. holding temperature; approximately 100 mL/h feeding rate; 170° C. heating oil temperature; 20° C. coolant temperature; and vacuum <13.33 Pa. Deacidification by alkaline extraction was performed according to the method described above with minor modification. Purified SL (10 g) from short-path distillation was mixed with hexane (150 mL), phenolphthalein solution, and 80 mL of 0.5 N KOH in 20% ethanol. The separation was obtained in a reparatory funnel, and the upper phase was collected. The upper phase was extracted with another 30 mL of 0.5 N KOH in 20% ethanol and 60 mL of saturated NaC1 solution. The hexane phase containing SL was passed through a sodium sulfate column. Hexane was evaporated to obtain the deacidified SL. The deacidification step was completed to obtain sufficient purified SL for further studies (FFAs<0.1%). The FFAs content was determined according to AOCS Official Method Ac 5-41 [7].

Positional Analysis. The pancreatic lipase hydrolysis procedure followed was as described above. Hydrolysis product was extracted with 2 mL diethyl ether and concentrated with nitrogen. The concentrated extract was spotted on silica gel G TLC plates and developed with a mixture of hexane: diethyl ether: formic acid (60:40:1.6, v/v/v). 2-Oleoylglycerol was spotted in parallel as identification standard for 2-MAG. The bands corresponding to 2-MAG were collected and converted to FAMEs for fatty acid composition analysis as described above.

¹³C NMR Analysis

In addition to pancreatic lipase analysis, the regio-isomeric distribution of ARA and DHA was determined by proton-decoupled ¹³C nuclear magnetic resonance (NMR) analysis. The spectrum was collected for 200 mg sample dissolved in 0.8 ml 99.8% CDCl₃ using continuous ¹H decoupling at 25° C. with a Varian DD 600 MHz spectrometer, equipped with a 3 mm triple resonance cold probe. The data was acquired at a ¹³C frequency of 150.82 MHz using the following acquisition parameters: 56,818 complex data points, spectral width of 37,879 Hz (251 ppm), pulse width 30°, acquisition time 1.5 s, relaxation delay 1 s, and collection of 20,000 scans. Exponential line broadening (1 Hz) was applied before Fourier transforming the data. ¹³C chemical shifts were expressed in parts per million (ppm) relative to CDCl₃ at 77.16 ppm.

Melting and Crystallization Profile. Melting and crystallization profiles were determined for tripalmitin, SL, and fat extracted from a commercial infant formula (CIFL) as described above, using a differential scanning c alorimeter (DSC1 STAR^{c} System, Mettler-Toledo), cooled with a Haake immersion cooler (Haake EK90/MT, Thermo Scientific). Lipid extraction from infant formula was performed according to Teichart and Akoh⁶. The analysis was performed according to AOCS Official Method Cj 1-94 with minor modification using indium as a standard. Samples were heated from 25° C. to 80° C. at 50° C./min, held for 10 min, cooled from 80° C. to -55° C. at 10° C./min (for crystallization profiles), held for 30 min, and then heated from −55° C. to 80° C. at 5° C./min (for melting profiles). Melting and crystallization profiles were performed in duplicate.

TAG Molecular Species. TAG molecular species of SL and CIFL was analyzed as described above, with the following modifications. The ELSD conditions were 70° C., 3.0 bar, and gain of 7. Sample concentration was 5 mg/mL in chloroform. The eluent gradient was at solvent flow rate of 1 mL/min with a gradient of 0 min, 65% B; 55 min, 95% B and 65 min, 65% B and post run of 10 min. Standards TAG mix containing trilinolenin (ECN=36), trilinolein (42), triolein (48), tripalmitin (48), tristearin (54), and triarachidin (60), as well as, palm olein were chromatographed to help determine the TAG species.

Infant Formula Preparation. SL-containing infant formulas were prepared using two general manufacturing methods 1) a wet-mixing/spray-drying process and 2) a dry-blending process) [147, which is hereby incorporated herein by reference for infant formula preparations]. For wet-mixing/spray-drying process, non-fat dry milk (20 g), whey protein isolate (10 g), lactose (31 g), maltodextrin (30 g), and water (800 mL) were mixed at 50° C. -60° C. To the mixture was added with SL (30 g) and vitamin/mineral premix (3.9 g), and homogenized using a high-speed benchtop homogenizer (Brinkmann Kinematica polytron, Switzerland). The sample was passed through a high-pressure homogenizer (Avestin Emulsiflex-C5, Canada) in two steps at 35 MPa and subsequently at 10 MPa, pasteurized at 65° C. for 30 min, then spray-dried using a mini spray dryer Buchi-290 (Switzerland). Two different combinations of spray drying inlet-outlet temperature (120° C.-70° C. vs. 180° C.-80° C.) were used. The effects of these drying temperatures to product qualities were compared.

For dry blending process, prior to the blending step, SL was encapsulated, following the method described in Example 4, above. The microencapsulated SL (120 g) was then dry-blended with the ingredients listed above except for water.

Lipid Oxidation and Color Measurement of Infant Formulas. Lipid hydroperoxides and thiobarbituric acid-reactive substances (TBARS) were measured according to the method described in Example 4, above, except that for TBARS, the sample mixture centrifuged at 3400 g for 25 min after cooling.

For color measurement, the L*, a*, b* values were measured using a Minolta color analyzer. Chroma C* and hue angle h* were calculated from a* and b* values. The mathematic C* and h* are defined as C*=[a*²+b*²]^{1/2} and h*=actan[b*/aα*]²². All data represe of two different trials, and results are reported as average and standard deviation of these measurements.

Statistical Analysis. The statistical significance of differences between samples was calculated using analysis of variance (ANOVA) and post-hoc Tukey's test at a significance level of p<0.05 using IBM SPSS Statistics 19.

### Results and Discussion

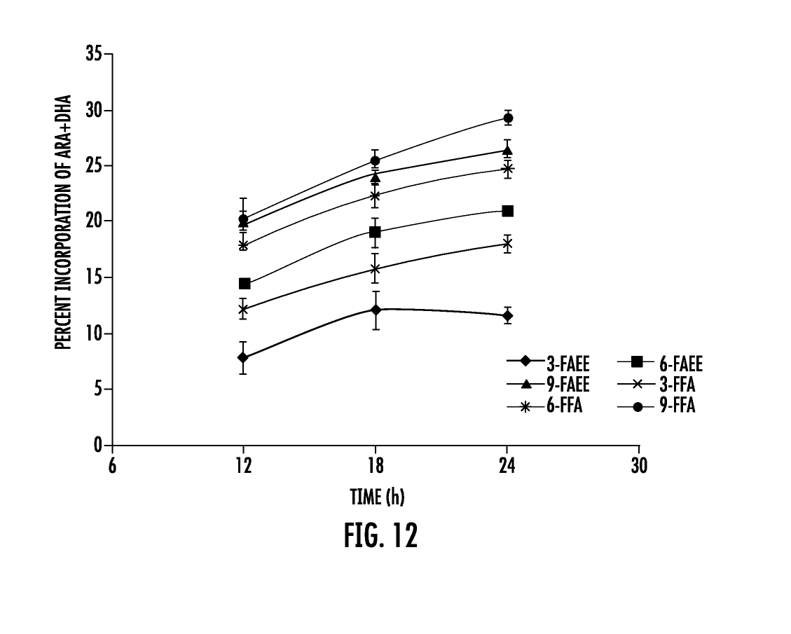

The effects of substrate mole ratio of acyl donors (FFAs or FAEEs mixture), tripalmitin, reaction time, and type of acyl donors on the incorporation of ARA and DHA were determined. In FIG. 12, it can be seen that as the reaction time and substrate mole ratio increase, the total incorporation of ARA and DHA also increases. Increasing reaction times led to increased incorporation of LCPUFAs as longer residence times allowed for prolonged contact between the enzyme and the substrates. An increase in omega-3 PUFAs (DHA and EPA) incorporation into tripalmitin has been observed with increasing reaction time and substrate mole ratio [113, 85] The total incorporation of ARA and DHA was significantly higher when the substrate mole ratio was 9 for both interesterification and acidolysis reactions (p<0.05). The highest total incorporation for interesterification (26.38±0.97%) and for acidolysis (29.27±0.74%) were obtained when the reaction continued for 24 h at 60° C. at a substrate mole ratio of 9. At these conditions, the incorporation of ARA and DHA were significantly higher when FFAs (acidolysis) were used as substrate compared to FAEEs (interesterification) (p<0.05). A higher incorporation of LCPUFAs (GLA, an omega-6 LCPUFA) has been observed when FFAs were used as acyl donors compared to FAEEs in reactions catalyzed by sn-1, 3 specific lipase [76], Lipozyme RM IM (donor organism: Rhizomucor miehei) at 45, 55, and 65° C. At a molecular level, interesterification process involves hydrolysis of the ester molecule followed by an esterification reaction. Hydrolysis of fatty acid ethyl esters produces ethanol in the reaction, which induces a loss in enzyme activity. This possibly complicated the process and led to a lower incorporation of ARA and DHA in the interesterification batch compared to acidolysis batch.

The conditions that gave highest ARA and DHA incorporations were used to scale-up acidolysis reaction in a 1 L-stirred batch reactor. Purified SL product was obtained through short-path distillation followed by alkaline deacidification. The FFAs content of purified SL was 0.01±0.02%. The fatty acid composition and positional distribution of the SL and CIFL are shown in Table 5.1. The major fatty acids found in SL were palmitic (36.77±0.11%), ARA (17.69±0.09%), oleic (15.28±0.03%), DHA (10.75±0.15%) and myristic (5.0.9±0.02%) acids. Positional analysis showed that the sn-2 position of SL contained 48.53±1.40% palmitic, 9.82±0.12% oleic, 9.73±0.13% ARA and 4.80±0.03% DHA. The presence of ARA and DHA at the sn-2 position were possibly due to acyl migration from sn 1,3 to the sn-2 position during the reaction.

Better absorption of palmitic acid was shown with infant formulas rich in palmitic acid esterified at the sn-2 position compared to formulas containing palmitic acid largely esterified to the sn-1, 3 positions [16]. SL appears to provide similar level of sn-2 palmitic acid (48.53%) to that of human milk fat (51.17-52.23%). Vegetable oils blend used in the commercial infant formula, as listed on the label, contained palm olein, soy, coconut, and high-oleic safflower or high oleic sunflower oils. Position analysis revealed the content of sn-2 palmitic acid from CIFL (6.02%) was much lower than SL. Palmitic acids in vegetable oils are predominantly located at the sn-1,3 positions, which led to a lower fat and calcium absorption in infants fed with vegetable oil-based formulas. The level of ARA in CIFL was 0.08±0.00% and DHA was 0.39±0.01%. CIFL must contain ARA and DHA as a physical blend. The SL produced in the current example could be used in an oil blend to increase the sn-2 palmitic acid, ARA, and DHA contents.

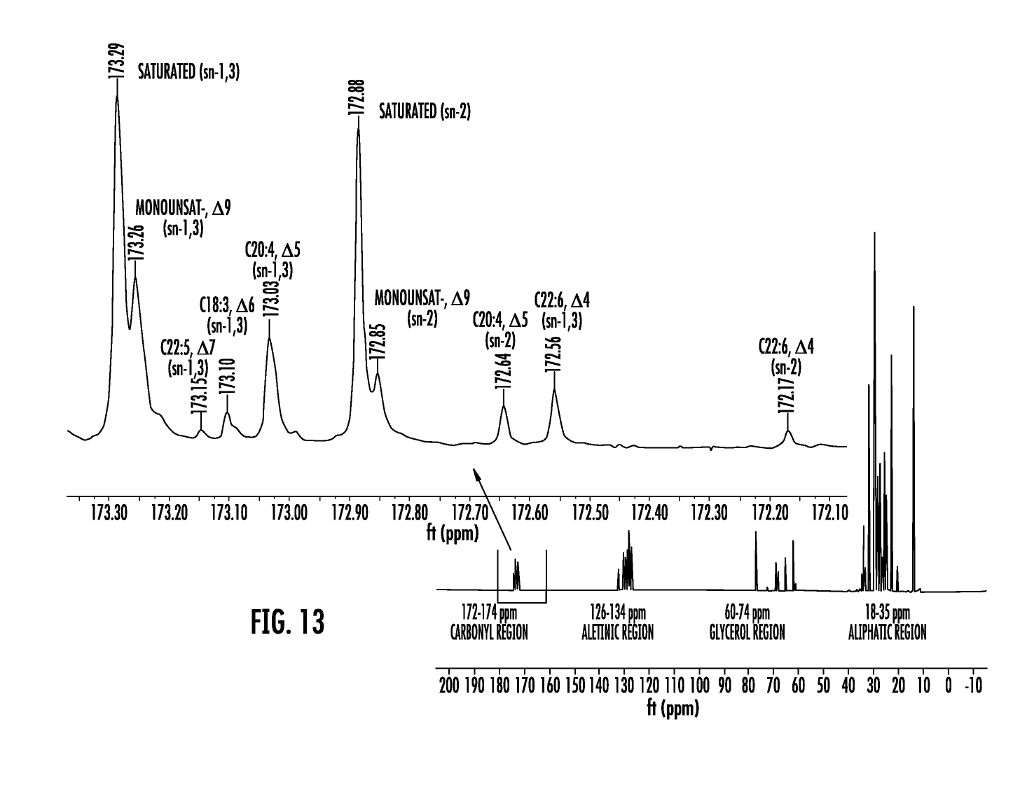

Positional distribution of fatty acids in SL was also determined by ¹³C-NMR spectroscopy. The chemical shift of carbonyl carbon of fatty acids in TAGs depends on the regiospecific position (sn-1, 3 or sn-2), and for carbonyl carbon of unsaturated fatty acid, the chemical shift also depends on the position and number of double bonds in the chain. Different carbon atoms give signals in different regions of the ¹³C-NMR spectrum. The spectrum of SL is shown in FIG. 13. The region where carbonyl carbons (C1 atoms) give signals is between 172-174 ppm. Assignments of resonances were made according to previous studies [112, 126] on fish lipids and the fact that the distance between the sn-1, 3 and sn-2 chains is approximately 0.4 ppm. The spectrum showed that saturated fatty acids, monounsaturated n-9 fatty acids, DHA, and ARA were esterified at the sn-2 position.

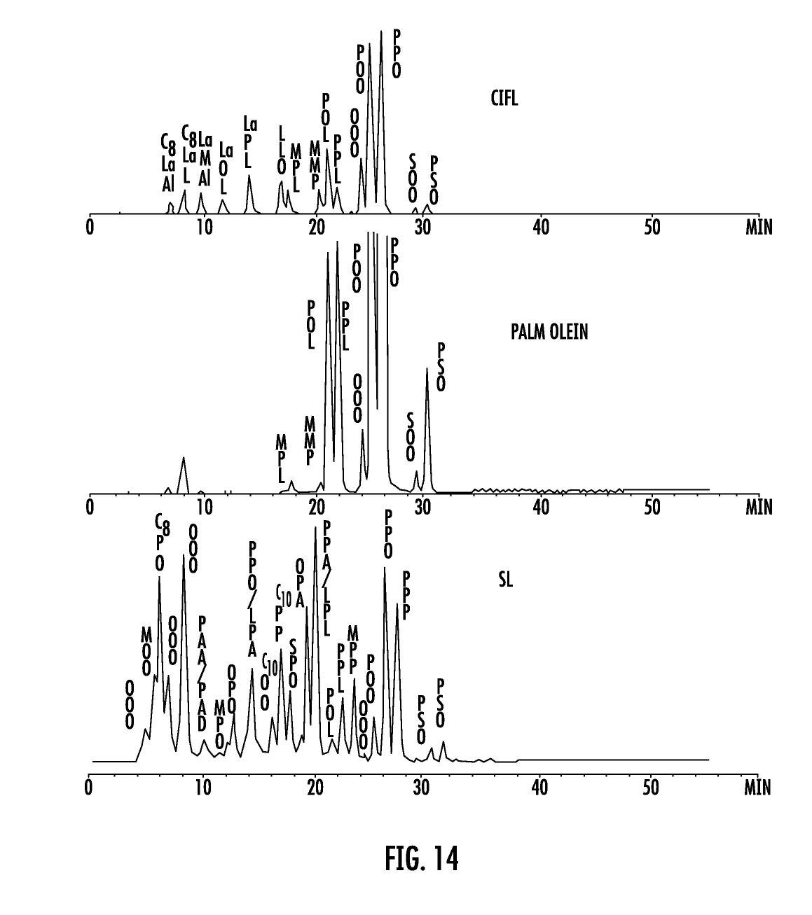

TAG molecular species were determined using reversed-phase HPLC. Peak identifications were made according to published works involving palm oil and palm olein [66, 90], elution time of TAG standards, and the fact that TAG species are eluted in order of equivalent carbon number (ECN)=TC-2×DB. TC is total carbon number of acyl group and DB is total number of double bond in TAG. FIG. 14 shows RP-HPLC chromatograms of palm olein, CIFL, and SL. Table 5.2 shows a comparison between TAG species and their relative percentages in the three lipid samples. PPO (61.01, 26.09%) and POO (34.23, 23.70%) constituted the majority of TAGs in both palm olein and CIFL, respectively. These TAGs were also found in the SL; however, their abundances were much lower (PPO=9.97%, POO=1.80%). Recently, the TAG species composition of colostrum fat, transitional, and mature milk fat was determined by RP-HPLC [151]. Twenty-two different TAG species were found in these milk samples and the majority included POO (21.51±5.39%), POL (16.93±3.27%), and POLa (10.39±3.02%). SL made in this study contained a variety of 26 different TAG species. Major TAG species in SL include PDD (15.36%), PPA or LPL (12.33%), PPO (9.97%), PPP (7.66%), C₈PD (7.40%), PPD or LPA (7.38%), and OPA (7.35%). Nine TAG species identified in the SL, including POO, OOO, POL, PPL, PPP, PPO, PSO, MPP, and SPP were reported as HMF TAGs [151]; however, the amounts were considerably different. Most of the SL TAGs contained more than 3 DB in their structures, four contained no DB (PPP=7.66%, C₁₀PP=5.39%, SPP=1.02%, and MPP=3.82%). The variety of TAG species, fatty acid chain length, and degree of saturation were shown to affect melting and crystallization profile of fat and oil [77, 128].

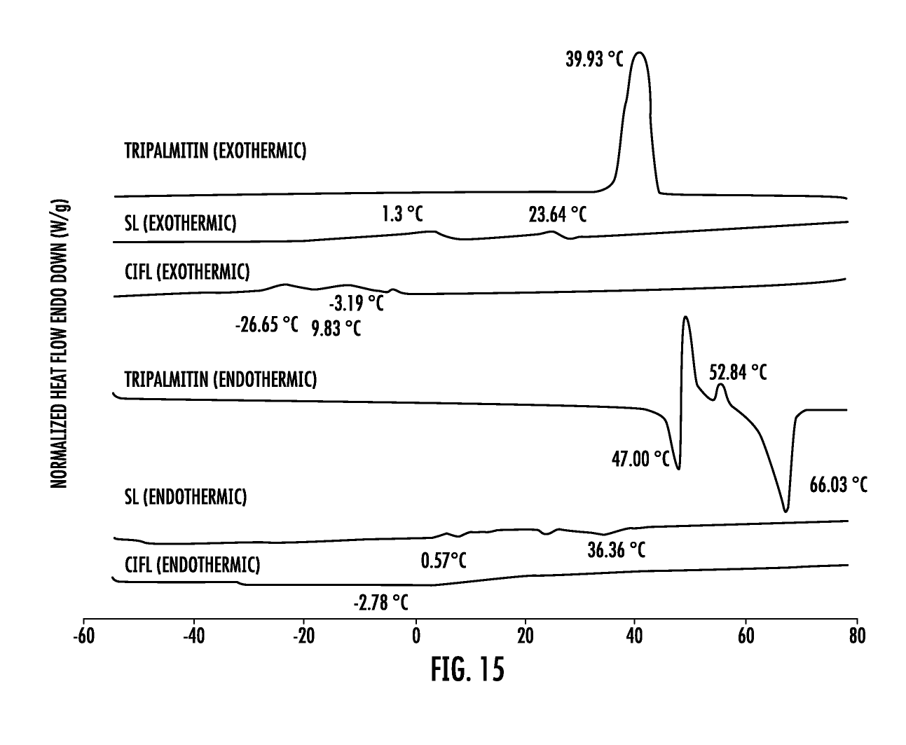

The melting and crystallization behaviors of SL were compared with its substrate, tripalmitin and fat extracted from CIFL (FIG. 15). SL has lower melting points and broader melting range around 37° C. to −25° C. Both SL and CIFL thermograms exhibited multiple peaks indicating complexity of the TAG distribution. This was also shown as multiple peaks in the chromatogram from the analysis of TAG molecular species. The presence of palmitic acid in the TAGs of SL and highly saturated TAG species (PPP, C₁₀PP, SPP, and MPP) contributed to the higher temperature melting peak at 36.36° C. Highly saturated TAGs including SPP, MPP, PPP, SMM were also found in human milk fat samples (colostrum, transitional, and mature milk fat). However, the amounts of these TAGs were rather low (with content of <1% or in the range of 1-5%). This suggested the use of this SL as a complimentary fat in infant formulas with a blend containing unsaturated oils rather than a substitute for a vegetable oil blend. Crystallization thermogram showed an onset of crystallization at −6° C. ending at 26° C. for SL. CIFL had a lower melting range of −30° C. to −3° C.

Powdered infant formula is manufactured using two general types of processes: a dry-blending and a wet-mixing/spray-drying process. Some manufacturers also use a combination of these processes to spray-dry the base powder (protein and fat component) then dry-blend with carbohydrate, vitamin, and mineral ingredients. To determine which process is suitable for SL application in powdered infant formula, infant formulas were prepared with SL as the fat source using these two general processes and the products were evaluated for oxidative stability and visual scores (L*, a*, b*, C*, and h*). PV measures the ability of lipid hydroperoxides (primary oxidation products) to oxidize ferrous ions to ferric ions, which form a red-violet complex with thiocyanate. TBARs test measures secondary oxidation products which form pink color when reacted with thiobarbituric reagent. The results of these analyses of infant formulas are shown in Table 5.3. Dry-blending process yielded products with significantly lower PV and TBARs values compared to wet-mixing/spray-drying process. The PV and TBARs values of dry-blended infant formulas and of the commercial infant formula were not significantly different. Higher temperature (180° C.) used in wet-mixing/spray-drying resulted in significantly higher PV and TBARs values compared to lower temperature of 120° C. Visual score, L* for lightness and C* for chroma or saturation, showed a negative correlation with PV and TBARs values (Table 5.3). The color of products with higher PV and TBARs values (wet-mixing/spray-drying products) was less saturated (lower C*), meaning that the color looked dull and grayish. These products were also darker with lower L* values. The hue color values of all infant formulas fall between yellow and green.

According to the European Society for Pediatric Gastroenterology, Hepatology and Nutrition (ESPGHAN), infant formulas should provide 60-70 kcal/100 mL [63]. The preparation of infant formula in this example was aimed at a formulation that contributes 60-70 kcal/100 mL resulting from 3.3-6.0% fat, 1.2-3.0% protein, and 5.4-8.1% carbohydrates. Microencapsulated SL contained about 25% fat (SL), 25% protein (WPI), and 50% carbohydrate (CSS). Microencapsulation of SL increased the stability of the final product; however, the energy contributed from carbohydrate and protein used as encapsulant increased the product energy contribution by 35 kcal/100 mL (Table 5.4).

SL was prepared from tripalmitin and FFAs derived from DHASCO and ARASCO, in acidolysis reaction using Lipozyme TL IM as biocatalyst. This SL could provide a fat source with physiologically important fatty acids and serve as a good source of sn-2 palmitic acid, which can improve fat and calcium absorption. Powdered infant formulas containing SL were prepared by a wet-mixing/spray-drying and dry-blending process. Infant formula prepared by dry-blending process with microencapsulated SL had a better oxidative stability and visual quality.

TABLE 5.1
Fatty acid composition (%) of structured lipid (SL) produced via acidolysis of tripalmitin and mixture of FFAs
from DHA and ARA-rich single cell oils, compared to fat extracted from a commercial infant formula (CIFL).

| | SL^{a} | | | CIFL^{c} | | |
|---|---|---|---|---|---|---|
| Fatty acid | Total | sn-2 | sn-1, 3 | Total | sn-2 | sn-1, 3 |
| C12:0 | 1.94 ± 0.01 | 3.00 ± 0.13 | 1.12 ± 0.10 | 9.53 ± 0.04 | 13.94 ± 0.23 | 7.32 ± 0.06 |
| C14:0 | 5.09 ± 0.02 | 4.84 ± 0.14 | 5.23 ± 0.12 | 4.42 ± 0.02 | 3.24 ± 0.08 | 5.01 ± 0.06 |
| C16:0 | 36.70 ± 0.11 | 48.53 ± 1.40 | 30.91 ± 0.83 | 23.80 ± 0.04 | 6.02 ± 0.45 | 32.62 ± 0.29 |
| C18:0 | 4.29 ± 0.02 | 4.03 ± 0.03 | 4.43 ± 0.02 | 4.00 ± 0.03 | 5.65 ± 0.27 | 3.17 ± 0.45 |
| C18:1 n-9 | 15.28 ± 0.03 | 9.82 ± 0.12 | 18.06 ± 0.04 | 32.55 ± 0.15 | 42.40 ± 0.27 | 27.62 ± 0.09 |
| C18:2 n-6 | 2.89 ± 0.02 | 1.83 ± 0.01 | 3.43 ± 0.03 | 19.21 ± 0.02 | 26.18 ± 0.38 | 15.72 ± 0.16 |
| C18:3 n-3 | nd^{b} | nd | nd | 1.65 ± 0.01 | 1.29 ± 0.01 | 1.83 ± 0.01 |
| C18:3 n-6 | 0.83 ± 0.01 | 0.19 ± 0.00 | 1.16 ± 0.01 | nd | nd | nd |
| C20:4 n-6 | 17.69 ± 0.09 | 9.73 ± 0.13 | 21.73 ± 0.04 | 0.80 ± 0.00 | 0.80 ± 0.12 | 0.80 ± 0.06 |
| C22:6 n-3 | 10.75 ± 0.15 | 4.80 ± 0.03 | 13.76 ± 0.20 | 0.39 ± 0.00 | 0.49 ± 0.01 | 0.34 ± 0.00 |

^{a}Fatty acids found in trace amounts were: C8:0, C10:0, C17:0, C20:0, C20:1 n-9, C22:0, C20:3 n-6, C22:5 n-3 and C24:0.
^{c}CIFL = Fat extracted from a commercially available infant formula enriched with ARA and DHA by physical blending.

TABLE 5.2
TAG molecular species of SL, CIFL, and palm olein determined by RP-HPLC
according to their ECN^{a}

| SL | | | CIFL | | | Palm olein | | |
|---|---|---|---|---|---|---|---|---|
| TAG | ECN | % | TAG | ECN | | TAG | ECN | |
| species^{b} | (DB) | Area | species | (DB) | % Area | species | (DB) | % Area |
| DDD | 30 (18) | 1.52 | C₈LaAl | 32 (3) | 1.38 | MPL | 44 (2) | 0.06 |
| MDD | 34 (12) | 1.36 | C₈LaL | 34 (2) | 3.46 | MMP | 44 (0) | 0.04 |
| C₈PD | 34 (6) | 7.40 | LaMA1 | 38 (3) | 2.87 | POL | 46 (3) | 1.50 |
| DDO | 36 (13) | 2.91 | LaOL | 42 (3) | 2.67 | PPL | 46 (2) | 1.76 |
| PDD | 36 (12) | 15.36 | LaPL | 42 (2) | 6.72 | OOO | 48 (3) | 0.35 |
| PAA/PAD | 40 (8)/38 | 1.12 | LLO | 44 (5) | 4.49 | POO | 48 (2) | 34.23 |
| MPD | (10) | 0.18 | MPL | 44 (2) | 3.74 | PPO | 48 (1) | 61.01 |
| OPD | 40 (6) | 3.22 | MMP | 44 (0) | 3.02 | SOO | 50 (2) | 0.13 |
| PPD/LPA | 42 (7) | 7.38 | POL | 46 (3) | 9.42 | PSO | 50 (1) | 0.91 |
| C₁₀OO | 42 (6) | 1.96 | PPL | 46 (2) | 4.00 | | | |
| C₁₀PP | 42 (2) | 5.39 | OOO | 48 (3) | 6.78 | | | |
| SPD | 42 (0) | 3.07 | POO | 48 (2) | 23.70 | | | |
| OPA | 44 (6) | 7.35 | PPO | 48 (1) | 26.09 | | | |
| PPA/LPL | 44 (5) | 12.33 | SOO | 50 (2) | 0.56 | | | |
| POL | 44 (4) | 0.65 | PSO | 50 (1) | 1.12 | | | |
| PPL | 46 (3) | 3.54 | | | | | | |
| MPP | 46 (2) | 3.82 | | | | | | |
| OOO | 46 (0) | 0.17 | | | | | | |
| POO | 48 (3) | 1.80 | | | | | | |
| PPO | 48 (2) | 9.97 | | | | | | |
| PPP | 48 (1) | 7.66 | | | | | | |
| PSO | 48 (0) | 0.55 | | | | | | |
| SPP | 50 (1) | 1.02 | | | | | | |
| | 50 (0) | | | | | | | |

^{a}Equivalent carbon number (ECN) = TC-2xDB; TC is total carbon number of acyl group and DB is total number of double bond in TAG. TAG species do not reflect stereochemical configuration.

TABLE 5.3
Characterization of powdered infant formulas.

| Characteristics of | Wet-mixing/ | Wet-mixing/ | | |
|---|---|---|---|---|
| powdered infant | spray-drying at | spray-drying at | | Commercial |
| formulas | 120° C. | 180° C. | Dry-blending | infant formula |
| Peroxide (μg/mg | 0.18 ± 0.02^{b} | 0.37 ± 0.02^{a} | 0.07 ± 0.02^{c} | 0.06 ± 0.03^{c} |
| sample) | | | | |
| TBARS (μg/mg | 0.06 ± 0.01^{b} | 0.11 ± 0.01^{a} | 0.04 ± 0.01^{c} | 0.05 ± 0.01^{c} |
| sample) | | | | |
| Color | | | | |
| L* | 94.59 ± 2.46^{b} | 95.75 ± 0.53^{b} | 98.83 ± 0.49^{a} | 96.35 ± 2.34^{a,b} |
| a* | −2.28 ± 0.08^{a} | −3.12 ± 0.05^{b} | −3.80 ± 0.08^{c} | −5.21 ± 0.0.05^{d} |
| b* | 16.37 ± 0.34^{b,c} | 15.30 ± 0.79^{c} | 17.71 ± 0.55^{b} | 19.29 ± 0.65^{a} |
| C* | 17.64 ± 0.36^{b,c} | 16.74 ± 1.14^{c} | 18.83 ± 0.33^{b} | 21.25 ± 1.89^{a} |
| h* | 97.24 ± 0.32^{c} | 100.30 ± 0.76^{b} | 101.28 ± 0.31^{b} | 103.89 ± 1.04^{a} |

Mean ± SD, n = 6 means with the same letter in the same row and category are not significantly different (p > 0.05)

TABLE 5.4
Energy contribution (in 100 mL of resuspended formula)

| Ingredients | | Energy |
|---|---|---|
| Total energy | Composition | contribution |
| contribution | (g) | (kcal) |
| Non-fat milk (fat 0%, protein 34.8%, | 2 | 6.98 |
| carbohydrate 52.2%) | | |
| WPI (fat 0.6%, protein 92%, | 1 | 3.93 |
| carbohydrate 0.5%) | | |
| Lactose | 3.1 | 12.4 |
| Maltodextrin | 3 | 12 |
| SL | 3 | 27 |
| Total energy contribution | — | 62.31 |
| (wet-mixing/spray drying method) | | |
| Microencapsulated SL (fat 25%, | 12 | |
| protein 25%, carbohydrate 50%) | | |
| Total energy contribution | — | 97.35 |
| (microencapsulated SL, dry-blending) | | |

### Example 6

Production and Characterization of DHA and GLA-Enriched Structured Lipid from Palm Olein for Infant Formula Use

### Materials and Methods

Materials were as described and obtained in the examples above, except Borage oil GLA in free fatty acid form (70% GLA) was purchased from Sanmark (Greensboro, N.C.). Palmitic acid (95% pure) was purchased from Alra Aesar (Heysham, Lancashire, UK).

Preparation of FFAs from DHASCO. DHASCO was converted to FFAs as described above. One hundred and fifty grams of oil was saponified using a mixture of KOH (34.5 g), distilled water (66 mL), 96% ethanol (396 mL), and butylated hydroxytoluene (0.03 g), The hydroalcoholic mixture was acidified by adding 6 M HCl and adjusted to pH 2 to release the FFAs. FFAs were stored in an amber Nalgene bottle under nitrogen at −20° C. until use.

Acidolysis Reactions. The acidolysis reaction mixture included palm olein, a FFA mix of palmitic acid:GLA:DHA (1:4:4) at different substrate mole ratios as previously determined by RSM, and 3 mL n-hexane. The mixture was placed in screw-capped test tubes and immobilized lipase, Novozym 435 (10% weight of total reactants) was added. The amount of lipase was selected based on the examples above. The specific activity of Novozym 435 was 10,000 PLU/g (PLU is propyl laurate units). The tubes were incubated in an orbital shaking water bath at 60° C. and 200 rpm. All reactions were performed in triplicate and average results and standard deviations reported.

Experiment Design for RSM Study. RSM was applied to investigate the effects of “substrate mole ratio, Sr” and “reaction time, T” on the amount of palmitic acid at the sn-2 position of the produced SL. RSM was also employed to study the incorporation of DHA and GLA into the SL, and to predict a model for the reaction conditions. The central composite face design included 11 experimental runs with 3 center points, and these were generated by using Modde 5.0 (Umetrics, Sweden) software. The levels for the two variables were: Sr (palm olein/FFA mix 0.5-2 mol/mol) and T (12-24 h). The independent variables and experimental design are shown in Table 6.1.

Analysis of Acidolysis Products. After enzymatic reaction, the resulting product was concentrated to half of its volume under nitrogen and spotted onto silica gel G TLC plates. A mixture of petroleum ether: diethyl ether: acetic acid (70:30:0.5, v/v/v) was used to separate the TAG from other reaction products. The TAG band was identified using triolein as standard and visualized under UV light after spraying the plates with 0.2% 2,7-dichlorofluorescein in methanol. The TAG band was recovered into test tube for conversion to fatty acid methyl esters (FAME) and positional analysis. TAG sample was converted to FAME following AOAC official method 996.01, with modification, as described in Example 2, and others, above, but with incubation for 5 min at 100° C. The upper organic layer was recovered in a GC vial for analysis. The FAME external standard, Supelco 37 component FAME mix was run parallel with the samples for FAs identification.

Pancreatic Lipase Catalyzed sn-2 Positional Analysis. The pancreatic lipase hydrolysis of TAG was as described by Pina-Rodriguez and Akoh [104] and as described in the examples above. Briefly, sample was extracted twice from the recovered TAG bands on TLC using 1.5 ml of diethyl ether. Sample was completely dried under nitrogen. Forty milligrams of purified pancreatic lipase (porcine pancreatic lipase, crude type II), 1 ml of Tris buffer (pH 8.0), 0.20 ml of 0.05% sodium cholate, and 0.1 ml of 2.2% calcium chloride were added to the sample. The mixture was incubated at 40° C. in a water bath for 3 min. Once completed, 1 ml of 6 M HCl and 4 ml of diethyl ether were added and centrifuged at 1000 rpm (approximately 100 ×g). The upper layer containing lipid components was concentrated with nitrogen. The concentrated extract was spotted on silica gel G TLC plates and developed with a mixture of hexane: diethyl ether: formic acid (60:40:1.6, v/v/v). 2-Oleoylglycerol was spotted in parallel as identification standard for 2-monoacylglycerol (2-MAG). The bands corresponding to 2-MAG were collected and converted into FAME for FA composition analysis.

Fatty Acid Composition Analysis. The fatty acid composition of single cell oils, palm olein, and acidolysis products were analyzed on a 6890N gas chromatograph (Agilent Technologies, Santa Clara, Calif.) with a flame ionization detector (FID). A Supelco SP-2560 column (100 m×250 μm, 0.20 μm film) was used for FA separation. Injection of 1 μL of sample was made at a split ratio of 20:1. Helium was the carrier gas at the flow rate of 1.1 mL/min and at a constant pressure (45.0 mL/min). The injector temperature and the FID set point was 300° C. The oven was held at 140° C. for 5 min, then increased to 240° C. at 4° C./min, and held at 240° C. for 15 min. The relative FAME content was calculated using the online computer. The average and standard deviation of triplicate analyses were reported.

Model Verification. To verify the model, five acidolysis reactions were carried out in test tubes at random conditions, as well as at the optimal condition suggested by RSM. The experimental values were then compared to the values predicted by the model, as shown in Table 6.2.

Scaled-Up Production of SL. The solvent-free acidolysis reaction was performed in a 1 L stirred batch reactor at 60° C. using a substrate mole ratio of 2 (palm olein: FFA mix) and Novozym 435 (10% weight of total reactants) as biocatalyst. The reaction was incubated for 22.7 h with constant stirring, at 200 rpm. At the end of the reaction, the resulting mixture of SL and substrates was vacuum filtered through a Whatman no. 1 containing sodium sulfate and then through a 0.45 μm membrane filter to dry and separate the SL from the enzyme. Short-path distillation (KDL-4 unit, UIC Inc.) was used to remove FFAs from the SL under the following conditions: holding temperature: 60° C.; feeding rate: ˜100 mL/h; heating oil temperature: 185° C.; coolant temperature: 15-20° C.; and vacuum: <100 mTorr. After short-path distillation, the FFA content was determined according to AOCS Official Method Ac 5-41 [7, which is incorporated by reference herein]. The SL obtained was stored under nitrogen at −80° C. until further use.

TAG Molecular Species Analysis. TAG analysis was performed as described in Examples 1, 2, and other examples above. The eluent was a gradient of acetonitrile (A) and acetone (B) at a solvent flow rate of 1 mL/min with a gradient of 0 min, 65% B; 55 min, 95% B, and 65 min, 65% B with a post run of 10 min. The equivalent carbon number (ECN) method was used to predict the elution order of TAG species. Standards: TAG mix containing trilinolenin (ECN=36), trilinolein (42), triolein (48), tripalmitin (48), tristearin (54), and triarachidin (60) as well as palm olein were also chromatographed to help identify the TAG molecular species.

Melting and Crystallization Profiles. Melting and crystallization profiles were determined as described in examples above and according to AOCS Official Method Cj 1-94 with minor modifications using indium as calibration standard. The sample was heated from 25 to 80° C. at 50 ° C./min, held for 10 min, cooled from 80 to −55° C. at 10° C./min (for crystallization profiles), held for 30 min, and then heated from −55 to 80° C. at 5° C./min (for melting profiles).

Statistical Analysis. All analyses, except melting and crystallization profiles, were performed in triplicate. Melting and crystallization profiles were performed in duplicate. Average values and standard deviations were determined. The analysis of variance (ANOVA) and the mathematical model for optimization were carried out using (Modde 5.0, Umetrics, Sweden).

### Results and Discussion

Model Fitting. RSM experimental design was applied in this example to obtain the predictive models for palmitic acid content at the sn-2 position and the total DHA and GLA incorporation in SL. Two independent variables were time and substrate mole ratio, and the responses were 1) palmitic acid content at the sn-2 position and 2) the total DHA and GLA incorporation (Table 6.1). Multiple linear regression and backward selection method were used to fit the results into a second-order polynomial model. For palmitic acid content at the sn-2 position, the first-order parameter with p-value<0.01 was time and this had a positive effect. The significant second-order parameter was the second-order term of time (t²), which had a negative effect. The model equation for palmitic acid content at the sn-2 position is as follows: Palmitic acid at sn-2=31.61+3.85t−2.57t²; where t=time.

For total DHA and GLA incorporation, time and substrate mole ratio were the significant first-order parameters with p-value<0.01. Time had a positive effect on the total DHA and GLA incorporation, but substrate mole ratio had a negative effect. The significant second-order parameters were the second-order term of substrate mole ratio (Sr²) and the interaction term of time and substrate mole ratio (t*Sr). Total DHA and GLA incorporation was negatively correlated to both of these second-order terms. The model equation for total DHA and GLA incorporation can be written as follows:

Total DHA and GLA incorporation=11.33+0.96t−5.90Sr+2.49Sr²−0.90t*Sr

where t=time and Sr=substrate mole ratio. The R², fraction of the variation for the response explained by the model, were 0.90 and 0.99 for palmitic acid content at the sn-2 position and total DHA and GLA incorporation, respectively. Lack of fit values (p>0.05) indicated that both models were appropriate for the prediction.

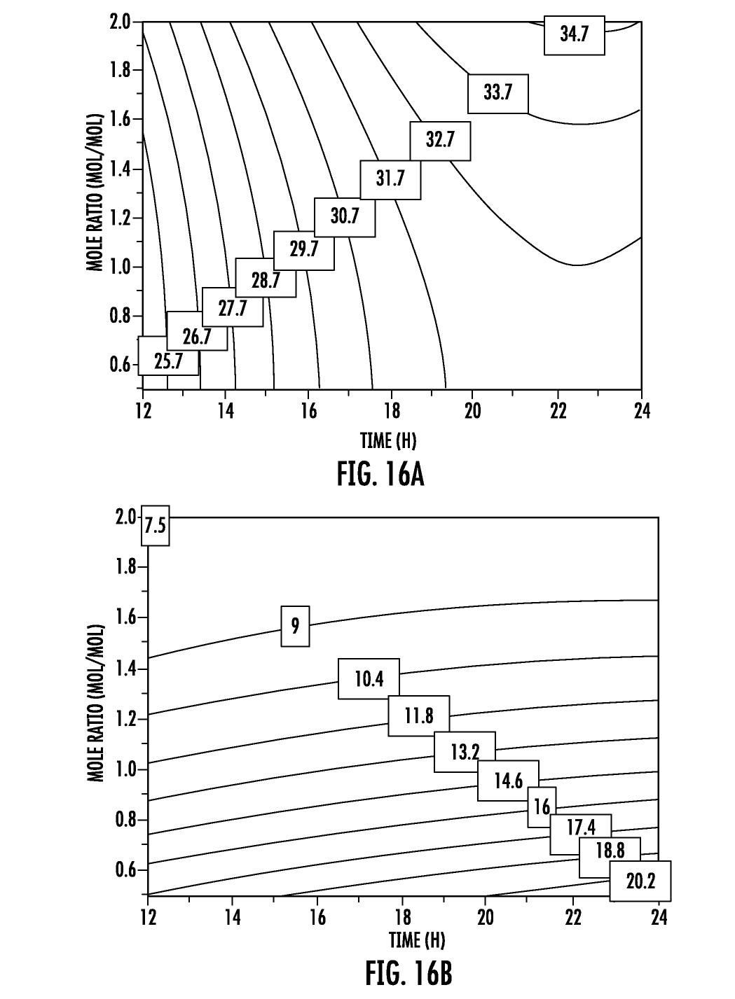

Optimization of the Reaction. Contour plots describing the interaction of time and substrate mole ratio with 1) palmitic acid content at the sn-2 position, and 2) total DHA and GLA incorporation are shown in FIGS. 16A and 16B, respectively. Palmitic acid content at the sn-2 position increased as time and substrate mole ratio (palm olein: FFA mix) increased (FIG. 16A). A higher substrate mole ratio indicates more palmitic acid from palm olein was present in the reaction resulting in a higher palmitic acid content in the SL. It has been shown that high concentration of substrate in a reaction led to an increase in the targeted fatty acid incorporation. Teichert and Akoh [131] reported that higher sn-2 palmitic acid contents were achieved with high content of palmitic acid in the reaction. However, some authors reported substrate inhibition of the lipase and lower targeted fatty acid incorporation into the SL [50, 118]. The substrate mole ratio used in this study did not result in substrate inhibition of the lipase or decreased incorporation of palmitic acid at the sn-2 position of the SL. Total DHA and GLA incorporation slightly increased as time increased (FIG. 16B). Longer residence times allow for prolonged contact between the enzyme and the substrates. FIG. 16B showed an increase in total DHA and GLA incorporation with time when lower substrate mole ratios were used in the reaction. As more DHA and GLA were available in the reaction mixture, the incorporation of these FAs increased.

The primary aim of this example was to increase palmitic acid content at the sn-2 position of palm olein glycerol backbone using a non-specific lipase. RSM predicted the highest palmitic acid at the sn-2 position to be 34.86% at the incubation time of 22.7 h and substrate mole ratio of 2. Under these conditions, the predicted total DHA and GLA incorporation was 7.77%. These parameters were used for model validation and large-scale production of SL.

Validation of Model. Acidolysis reactions were carried out in test tubes at various conditions including the optimal conditions obtained with RSM in order to verify the model. Furthermore, the optimal conditions were used for large-scale production of SL. The results of model verification in small and large-scale productions are given in Table 6.2. Verification fell within the upper and lower limits of the predicted values of total DHA and GLA incorporation and palmitic acid content at the sn-2, indicating the usefulness of RSM prediction to estimate values of the responses.

Fatty Acid and sn-2 Positional Fatty Acid Composition of Substrates and SL. The fatty acid composition and distribution of palm olein and SL are shown in Table 6.3. Major fatty acids in palm olein were palmitic (43.60%), oleic (40.91%), and LA (9.92%). Despite being the most abundant fatty acid, palmitic acid was found at only 13.79% at the sn-2 position of palm olein glycerol backbone. The major fatty acids at the sn-2 position were the unsaturated oleic (66.38%) and linoleic acids (18.96%). HMF has most of its palmitic acid (greater than 60%) at the sn-2, whereas the unsaturated fatty acids are located at the outer positions. Lower absorption of fat in formula-fed infants was attributed to the differences in stereospecific structure of the TAGs of vegetable oils and HMF. Acidolysis experiments using palm olein and FFAs mixture of DHA (23.23%), GLA (31.42%), and palmitic acid (15.12%) were performed to increase sn-2 palmitic acid content in palm olein. The resulting SL produced at the optimal conditions selected by RSM contained 35.11% palmitic acid at the sn-2 position compared to 13.79% in original palm olein. Oleic acid at the sn-2 position of palm olein decreased from 66.38 to 33.99%. The nutritional value of palm olein was improved by the addition of PUFAs including 3.75 DHA, 5.03 GLA, and 10.09% LA. DHA and GLA levels found in human milk were 0.15-0.92% and 0.06-0.13%, respectively. Even though greater than 60% sn-2 palmitic acid was not achieved, 35.11% is acceptable according to the model prediction (Tables 6.1 & 6.2). This SL could also be used in oil blends for infant formula to provide higher sn-2 palmitic acid TAGs and beneficial PUFAs.

HPLC TAG Molecular Species Identification. TAG molecular species of palm olein and its SL product were determined using reversed-phased HPLC. Peak identifications were made as described above, the elution time of TAG standards, and the fact that TAG species elute in order of equivalent carbon number (ECN)=TC−2×DB; TC is the total carbon number of acyl group and DB is the total number of double bonds in TAG). Table 6.4 shows a comparison between TAG molecular species and their relative percentages in palm olein and SL. The main TAG molecular species of palm olein were PPO, POO, PPL, and POL. These TAGs were also predominant in the SL product, however their abundance changed drastically. The amount of PPO and POO were reduced from 61.01 to 28.99% for PPO and 34.24 to 24.96% for POO. PPL increased from 1.76 to 3.97%. Similarly POL increased from 1.50 to 9.58%. SL contained up to 29 different TAG molecular species. Most of these TAGs contained more than 3 DB in their structure, only two contained no DB (MMP=1.69% and PPP=5.23%). The variety of TAG species, fatty acid chain length, and degree of saturation were shown to affect melting and crystallization profile of fats and oils.

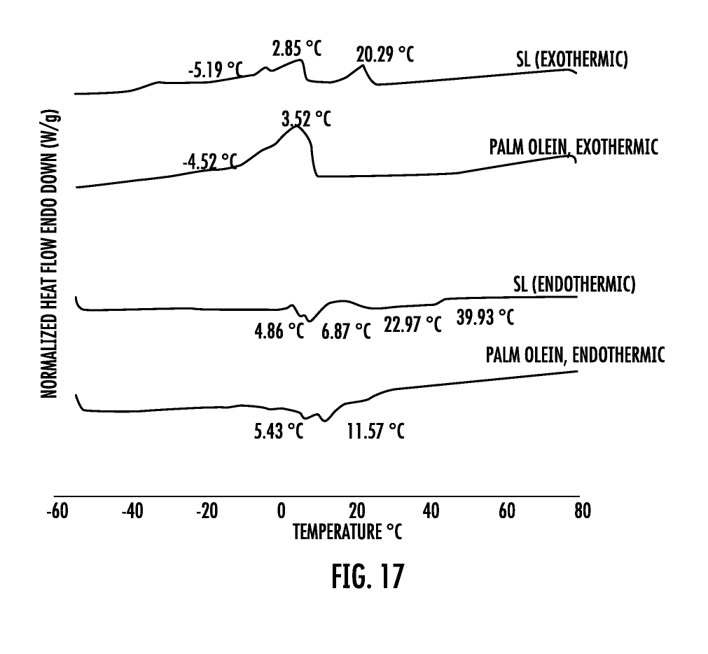

SL Melting and Crystallization Profiles. Both cooling and heating thermograms of SL were broader and contained more peaks than those of palm olein. The multiple peaks observed in thermograms can be attributed to the complexity of TAGs distribution in vegetable oils. Palm olein exhibited one major exothermic peak (with shoulder peaks) in the crystallization profile, whereas in SL, two major peaks were observed (FIG. 17). Palm olein major exothermic peak at 3.52° C. and its shoulder peak at −4.52° C. were close to the first major exothermic peak of SL (2.85° C.) and its shoulder peak (−5.19° C.), indicating that they both have the same types of polymorphic forms. Cooling thermogram of RBD palm olein in the study by Che Man et al., [18] indicated that these low temperature peaks represented polymorphs β₂′ and α. The second major peak in the SL crystallization profile was new compared to palm olein and at a higher temperature (20.29° C.), indicating a change in polymorphic profile as a result of enzymatic modification of the TAG species. TAGs species analysis by HPLC revealed a significant amount of trisaturates (PPP, 5.23% and MMP, 1.69%). These highly saturated TAGs represent this second peak at 20.29° C. For melting profile, SL started to melt at a lower temperature (2.18° C.) compared to the onset melting temperature of palm olein (4.19° C.). This melting behavior is due to the presence of highly unsaturated (DGD, GGD) TAGs in SL. Both SL and palm olein have similar melting peaks between 4 to 12° C. However, SL had two shoulder peaks (22.97 and 39.93° C.) reflecting the presence of highly saturated TAGs.

The SL produced from palm olein in this example had a higher content of sn-2 palmitic acid than the original palm olein and should enhance fatty acid and calcium absorption when used in infant formula products. DHA and GLA were incorporated into the TAGs of this SL to improve the nutritional value of the oil. This SL had similar fatty acid profile as HMF. Therefore, it can be used in a fat blend for infant formula to provide fat with similar structure as HMF as well as beneficial PUFAs.

TABLE 6.1
Total incorporation of DHA and GLA and palmitic acid (PA) at
the sn-2 position of SL by acidolysis using RSM conditions^{a}

| Experiment | | Mole ratio^{b} | Total DHA and | sn-2 Palmitic |
|---|---|---|---|---|
| number | Time (h) | (mol/mol) | GLA (%) | acid (%) |
| 1 | 12 | 0.5 | 17.08 ± 1.22 | 23.49 ± 1.92 |
| 2 | 24 | 0.5 | 21.37 ± 0.59 | 32.00 ± 2.38 |
| 3 | 12 | 2 | 7.27 ± 0.25 | 25.76 ± 1.27 |
| 4 | 24 | 2 | 7.96 ± 0.17 | 34.88 ± 0.41 |
| 5 | 12 | 1.25 | 10.82 ± 0.46 | 27.39 ± 0.59 |
| 6 | 24 | 1.25 | 11.58 ± 0.18 | 32.89 ± 0.63 |
| 7 | 18 | 0.5 | 20.08 ± 0.43 | 32.39 ± 0.57 |
| 8 | 18 | 2 | 7.90 ± 0.14 | 34.12 ± 1.07 |
| 9 | 18 | 1.25 | 11.13 ± 0.19 | 30.80 ± 0.85 |
| 10 | 18 | 1.25 | 11.08 ± 0.04 | 31.62 ± 1.11 |
| 11 | 18 | 1.25 | 11.42 ± 0.65 | 30.20 ± 1.27 |

^{a}Incubation temperature was 60° C.
^{b}Substrate mole ratio of palm olein to FFA mix of PA:DHA:GLA (1:4:4)

TABLE 6.2
Predicted and observed values (%) from RSM model verification

| | | Conditions | | | | | | | |
|---|---|---|---|---|---|---|---|---|---|
| | | | | | | Predicted | | | Observed |
| | Mole | Predicted | | | Observed | DHA + G | | | DHA + G |
| Time (h) | ratio^{a} | sn-2 PA^{b} | LL | UL | sn-2 PA | LA | LL^{c} | UL^{d} | LA^{e} |
| 12 | 2 | 26.72 | 23.08 | 30.36 | 25.53 ± 1.67 | 7.56 | 6.36 | 8.76 | 7.09 ± 0.84 |
| 18 | 1 | 31.28 | 29.24 | 33.33 | 30.89 ± 1.86 | 13.56 | 12.89 | 14.24 | 13.48 ± 0.23 |
| 24 | 1 | 32.52 | 29.63 | 35.41 | 31.39 ± 1.93 | 14.52 | 13.57 | 15.47 | 13.47 ± 0.29 |
| 20 | 1.25 | 32.61 | 30.56 | 34.56 | 31.22 ± 0.20 | 11.61 | 10.94 | 12.29 | 11.72 ± 0.23 |
| 22.7^{f} | 2 | 34.86 | 31.73 | 37.99 | 34.27 ± 0.18 | 7.77 | 6.74 | 8.80 | 8.19 ± 0.06 |

^{a}Substrate mole ratio of palm olein to FFA mix.
^{b}Palmitic acid at sn-2 position (%).
^{c}Lower limit (%)
^{d}Upper limit (%).
^{e}Total DHA and GLA content in SLs (%).
^{f}Optimal conditions predicted by RSM and reaction performed in test tubes

TABLE 6.3
Total and positional distribution of fatty acids (%) of substrates and produced SL

| | Palm olein | | | | | | SL^{e} | |
|---|---|---|---|---|---|---|---|---|
| Fatty acid | Total | sn-2 | free DHA^{b} | free GLA^{c} | free PA | FFA mix^{d} | Total | sn-2 |
| C12:0 | — | — | 4.83 ± 0.05 | — | — | 2.19 ± 0.01 | 0.53 ± 0.00 | 0.65 ± 0.08 |
| C14:0 | 1.04 ± 0.00 | — | 10.77 ± 0.02 | — | 0.64 ± 0.00 | 5.16 ± 0.00 | 1.72 ± 0.01 | 2.41 ± 0.09 |
| C16:0 | 43.60 ± 0.01 | 13.79 ± 0.18 | 9.61 ± 0.15 | — | 98.91 ± 0.02 | 15.12 ± 0.08 | 37.55 ± 0.13 | 35.11 ± 0.02 |
| C18:0 | 4.53 ± 0.00 | 0.87 ± 0.03 | 0.92 ± 0.10 | — | 0.36 ± 0.01 | — | 3.87 ± 0.02 | 3.55 ± 0.17 |
| C18:1n-9 | 40.91 ± 0.01 | 66.38 ± 0.12 | 17.80 ± 0.12 | 1.66 ± 0.12 | — | 9.14 ± 0.03 | 36.40 ± 0.25 | 33.99 ± 1.05 |
| C18:2n-6 | 9.92 ± 0.01 | 18.96 ± 0.15 | 1.01 ± 0.12 | 25.45 ± 0.07 | — | 11.39 ± 0.06 | 10.09 ± 0.09 | 10.14 ± 0.16 |
| C18:3n-6 | — | — | 0.17 ± 0.01 | 71.63 ± 0.07 | — | 31.42 ± 0.09 | 5.03 ± 0.02 | 5.43 ± 0.90 |
| C22:6n-3 | — | — | 47.58 ± 0.42 | — | — | 23.23 ± 0.19 | 3.75 ± 0.02 | 2.25 ± 0.10 |

^{b}Others include: C8:0, C10:0, C16:1, C17:0, C20:1, C22:0, and C20:5n-3
^{c}Others include: C21:0 and C20:2.
^{d} FFA mix of PA:DHA:GLA (1:4:4), Others include: C8:0, C10:0, C12:0, C14:0, C16:1, C17:0, C21:0, and C20:1
^{e}SL from large scale (1L) production

TABLE 6.4
TAG molecular species of palm olein and SL determined by
RP-HPLC according to their ECN^{a}

Relative %

| TAG Species^{b} | ECN | DB | Palm olein | SL |
|---|---|---|---|---|
| DGD | 32 | 15 | —^{c} | 0.44 |
| GGD | 34 | 12 | — | 1.10 |
| DOD | 36 | 13 | — | 0.70 |
| DPD | 36 | 12 | — | 1.53 |
| GLD | 36 | 11 | — | 8.34 |
| OLD/SGD | 40 | 9 | — | 0.17 |
| PLD | 40 | 8 | — | 0.15 |
| LLG | 40 | 7 | — | 0.20 |
| OOD | 42 | 8 | — | 0.25 |
| POD | 42 | 7 | — | 0.16 |
| LOG | 42 | 6 | — | 0.13 |
| PLG | 42 | 5 | — | 0.21 |
| MOG | 42 | 4 | — | 0.28 |
| LaLO | 42 | 3 | — | 0.22 |
| LLO/OOG | 44 | 5 | — | 1.25 |
| LLP/POG | 44 | 4 | — | 1.76 |
| PLM | 44 | 2 | 0.06 | 2.57 |
| LaPO | 44 | 1 | — | 0.46 |
| MMP | 44 | 0 | 0.04 | 1.69 |
| POL | 46 | 3 | 1.50 | 9.58 |
| PPL | 46 | 2 | 1.76 | 3.97 |
| MOP | 46 | 1 | — | 0.27 |
| OOO | 48 | 3 | 0.35 | 2.97 |
| POO | 48 | 2 | 34.24 | 24.96 |
| PPO | 48 | 1 | 61.01 | 28.99 |
| PPP | 48 | 0 | — | 5.23 |
| SOO | 50 | 2 | 0.13 | 0.34 |
| PSO | 50 | 1 | 0.91 | 1.53 |
| SSO | 52 | 1 | 0.01 | 0.53 |

### Example 7

### Enzymatic Synthesis of Refined Olive Oil-Based Structured Lipids Containing Omega-3 and -6 Fatty Acids for Potential Application in Infant Formula

### Materials and Methods

Materials. Materials were provided and described as set forth in Example 1, and other, above, with the addition of the following γ-linolenic acid (GLA) in free fatty acid (FFA) form (70% GLA) was purchased from Sanmark Corp. (Greensboro, N.C.). Commercial infant formula, Nestle Good Start Gentle (Nestle USA, Inc., Glendale, Calif.), containing DHA and ARA, was purchased at a local grocery store in Athens, Ga. Milk fat (MF) was purchased from Dairy Farmers of America (Winthrop, Minn.). Other solvents and chemicals were purchased from Fisher Scientific (Norcross, Ga.) and Sigma-Aldrich (St. Louis, Mo.).

Preparation of Fatty Acid Ethyl Esters. Fatty acid ethyl esters (FAEEs) of DHASCO and GLA-FFA were prepared according to the methods described above, with minor modifications. 100 mL of DHASCO or GLA-FFA were mixed with sodium ethoxide (2.625%, v/v) in absolute ethanol at a ratio of 4:2 (v/v). The mixture was heated at 60° C. with constant agitation at 200 rpm for 40 min under nitrogen atmosphere. The product was subsequently washed with 100 mL saturated NaCl solution, followed by a washing step with 100 mL distilled water. After separation, the upper layer containing FAEEs was collected and passed through a sodium sulfate column under vacuum. FAEEs were then confirmed by thin-layer chromatography (TLC) using ethyl oleate as standard. DHASCO-EE and GLAEE were finally mixed with a molar ratio of 1:2 (named DG12) and 2:3 (named DG23), respectively, and stored in amber bottles under nitrogen at −20° C. until use.

Small-Scale Synthesis and Analysis of SL Products

Tripalmitin was mixed with ROO, DG12 or DG23 at different substrate molar ratios (tripalmitin to ROO to DG12 or DG23 at 1:1:1, 1:2:1, 1:3:2, 1:4:2, 1:5:2, and 1:5:1). 3 mL hexane and Lipozyme TL IM at 10% (w/w) of the total substrate mass were also added to the reaction mix. The mixture was placed in screw-capped test tubes and incubated at 65° C. for 24 h with constant agitation at 200 rpm. The products were then collected and passed through a sodium sulfate column to remove moisture and enzyme. All reactions were performed in triplicate and the average value and standard deviation were reported. A physical blend (PB) was also prepared with a molar ratio of tripalmitin to ROO to DG23 of 1:1:1 without adding Lipozyme TL IM. The PB was subjected to the same synthesis and clean-up process as that of SLs.

Separation of SLs from FAEEs

SLs were separated from FAEEs by TLC by utilizing TLC solvent systems discussed in the examples above. Petroleum ether/diethyl ether/acetic acid (97.5/52.5/3, v/v/v) were firstly used to separate SLs and FAEEs from monoacylglycerols (MAGs), diacylglycerols (DAGs), and FFA. In the following TLC, petroleum ether/diethyl ether/acetic acid (75/5/1, v/v/v) were used to separate SLs from FAEEs.

Fat Extraction from Commercial Infant Formula

Fat extraction from commercial infant formula was carried out following the method previously described by Bligh and Dyer [13, which is hereby incorporated by reference herein] with minor modification. 100 grams of the infant formula was mixed with 100 mL of chloroform and homogenized for 30 s. 200 mL of methanol was then added to the mixture and homogenized again for 30 s. Another 100 mL of chloroform was added and the mixture was blended for 1-2 min. Finally, 100 mL of 0.88% sodium chloride solution was added, and the mixture was blended again for 1 min. A Whatman No. 1 filter paper was used to vacuum-filter the mixture through a Buchner funnel. The residue on the filter paper was transferred into a beaker and mixed with 100 mL of chloroform. The resultant mixture was vacuum-filtered again as described above and collected with the first filtrate. The entire filtrate was then transferred to a 1 L separatory funnel and allowed to separate. After clear separation was observed, the bottom chloroform layer was collected and passed through an anhydrous sodium sulfate column to remove any excess water. Chloroform was then removed using a rotovapor at 40° C. The extracted infant formula fat (IFF) was stored in an amber bottle under nitrogen at −20° C. until use.

Determination of Fatty Acid Profiles

The substrates, namely ROO, DHASCO-EE, GLAEE, and the products (SLs, PB, IFF, and milk fat (MF)) were converted to FA methyl esters as described above (following AOAC Official Method 996.01 with minor modifications), e.g., example 4. All samples were analyzed in triplicate and average values were reported.

Positional Analysis. sn-2 positional fatty acid composition was determined following the method described above. All samples (SLs, PB, IFF, and MF) were analyzed in triplicate and average values and standard deviation were reported.

Scaled-up Production of SL. The solvent-free interesterification reaction was performed in a 1 L stirred batch reactor at 65° C. using a substrate molar ratio of 1:1:1 (tripalmitin:ROO:DG23) and Lipozyme TL IM (10% weight of total substrates) as biocatalyst. The reactor was sealed and covered with aluminum foil to minimize the impact of light and oxygen. The reaction was carried out for 24 h with constant stirring at 200 rpm. At the end of the reaction, product was vacuum-filtered through a Whatman No. 1 filter paper to separate the SLs from the enzyme. A second filtration using Whatman No. 1 filter paper and sodium sulfate was performed to remove any excess water. SLs were kept in an amber container flushed with nitrogen and stored at 4° C. until use.

Short-path Distillation. Short-path distillation was performed to remove excess FFAs from the SLs using KDL-4 (UIC Inc., Joliet, Ill. USA) system under the following conditions: holding temperature of 65° C., feeding rate of approximately 100 mL/h, heating oil temperature of 175° C., coolant temperature of 20-25° C., and vacuum of <100 mTorr. SLs were passed three times and the FFA content expressed as oleic acid percentage was determined following the AOCS Official Method 5a-40 [9], incorporated by reference herein].

Triacylglycerol Molecular Species. The TAG composition was determined with a reverse phase HPLC (Agilent Technologies 1260 Infinity, Santa Clara Calif.) equipped with a Sedex 85 ELSD (Richard scientific, Novato, Calif.). The column was Beckman Ultrasphere® C18, 5 μm, 4.6'250 mm with temperature set at 30° C. The injection volume was 20 μL. The mobile phase at a flow rate of 1 mL/min consisted of solvent A, acetonitrile and solvent B, acetone. A gradient elution was used starting with 35% solvent A to 5% solvent A at 45 min and then returning to the original composition in 5 min. Drift tube temperature was set at 70° C., pressure at 3.0 bar and gain at 8. The samples (SLs, PB, IFF, and MF) were dissolved in chloroform with a concentration of 5 mg/mL. The TAG peaks were identified by comparison of retention times with those of the standards and also by equivalent carbon number (ECN). ECN is defined as CN−2n, where CN is the number of carbons in the TAG (excluding the three in the glycerol backbone) and n is the number of double bonds. Triplicate determinations were carried out and averaged data was reported.

Solid Fat Content. Solid fat content (SFC) was determined following the AOCS Official Method Cd 16b-93 (8) on a Benchtop NMR analyser—MQC (Oxford Instruments, Abingdon, England). Samples were tempered at 100° C. for 15 min and then kept at 60° C. for 10 min, followed by 0° C. for 60 min and finally for 30 min at each selected temperature of measurement. SFC was measured at intervals of 5° C. from 25 to 55° C.

Oxidative Stability Index (OSI). The OSI of the samples were determined with an Oil Stability Instrument (Omnion, Rockland, Mass., U.S.A.) at 110° C. according to the AOCS Official Method Cd 12b-92 [92, incorporated herein by reference].

Melting and Crystallization Profiles. The melting and crystallization profiles were determined using a differential scanning c alorimeter, DSC 204 F1 Phoenix (NETZSCH Instruments North America, Burlington, Mass.) following AOCS Official Method Cj 1-94 [94, incorporated herein by reference]. First, 8-12 mg samples were weighed into aluminum pans and sealed. Samples were rapidly heated to 80° C. at 20° C./min, and held for 10 min to destroy any previous crystalline structure. The samples were then cooled to −80° C. at 10° C./min (for crystallization profiles), and held for 30 min and finally heated to 80° C. at 10° C./min (for melting profiles). Nitrogen was used as the protective and purge gas. All samples were analyzed in triplicates and averaged values were reported.

Statistical Analysis. Statistical analyses were performed with the SAS software package (SAS Institute, Cary, N.C.). Duncan's multiple-range test was performed to determine the significant difference between samples.

### Results and Discussion

Total and Positional Fatty Acid Profiles. Characterization of the scaled-up SLs product was carried out after short-path distillation. Three passes were required to lower the FFA value of the SLs to 0.08%. The high amount of FFA in the product was probably due to the presence of DHASCO-EE and GLAEE, which could produce DHASCO-FFA and GLA-FFA during the hydrolysis of their respective ethyl esters. Table 7.1 shows the fatty acid composition of DHASCO-EE and GLAEE, as well as the total and positional fatty acid composition of ROO. It can be seen that the DHASCO-EE contained 45.98 mol % DHA while GLAEE contained 71.79 mol % GLA. Oleic acid was the primary fatty acid found in ROO at 73.95 mol % while palmitic acid content was only 9.97 mol %. At the sn-2 position of ROO TAG, oleic acid content was 86.35 mol % while palmitic acid content was only 1.49 mol %, which is considerably lower than human milk fat which contains 50-60 mol % of palmitic acid at the sn-2 position.

The total and positional fatty acid composition of SLs, PB, IFF, and MF are shown in Table 7.2. It can be seen that at the sn-2 position, only 6.12 mol % of palmitic acid was found in IFF TAG while 49.28 mol % was found in the SLs TAG. PB contained similar total palmitic acid content (46.60 mol %) to SLs, however, at the sn-2 position, its 32.67 mol % was significantly lower (P<0.5) than that of SLs. As previously discussed, TAGs having a high palmitic acid at the sn-2 position is preferred as it helps increase the absorption of palmitic acid and calcium. Compared to the positional distribution of fatty acids in commercial infant formula, the SLs showed a closer resemblance to the positional distribution in human milk fat.

It is also worth noting that although the commercial infant formula claims to contain ARA and DHA, they were found to contain 0.59 and 0.26 mol %, respectively. In comparison, the SLs contained 0.73 mol % DHA, and while no ARA was found in the SLs, 5.00 mol % of GLA was incorporated, which can be converted to ARA in humans. The SLs contained desirable palmitic acid content at the sn-2 position of its TAGs and were enriched with DHA and GLA. Although they had higher total palmitic acid compared to human milk fat, they can be used with other vegetable oils as a blend to produce an ideal total palmitic acid content while still maintaining the sn-2 palmitic acid and total DHA level in the final product.

TAG Molecular Species. The TAG molecular species of SLs, PB, IFF, and MF are shown in Table 7.3. The IFF and MF had more diverse TAG species than SLs and PB. The predominant TAG in PB was PPP which was expected since tripalmitin was one of the starting TAGs in the interesterification reaction. In comparison, the predominant TAGs in the SLs were POP (31.91%) and OPO (22.78%), followed by LnDLn (10.91%), PPP (10.18%), LPL (10.09%), LOO (9.83%), and OOO (4.29%). Besides PPP, TAGs containing palmitic acid increased from 32.75% in PB to 64.78%, suggesting a potential increase in palmitic acid content at sn-2 position, which is in accordance with what was observed in the positional distribution of fatty acids in the SLs. In contrast, the major TAG molecular species found in human milk fat are OPO (1.56-42.44%), POL (9.24-38.15%), OOO (1.61-11.96%), and LOO (1.64-10.18%). The OPO, 000, and LOO content of the SLs were all within the range of that found in human milk while the OPO (3.37%) and LOO (ND) contents of IFF were not.

Solid Fat Content. Solid fat content (SFC) is the measure of solid/liquid ratio of a fat at various temperatures. It can have an impact on the physical and sensorial properties such as texture and mouthfeel of the product containing the TAG. The temperatures of choice in this study were 25, 35, 45, and 55° C., which we believe is within the range of temperature that infant formula would be consumed or heated before consumption.

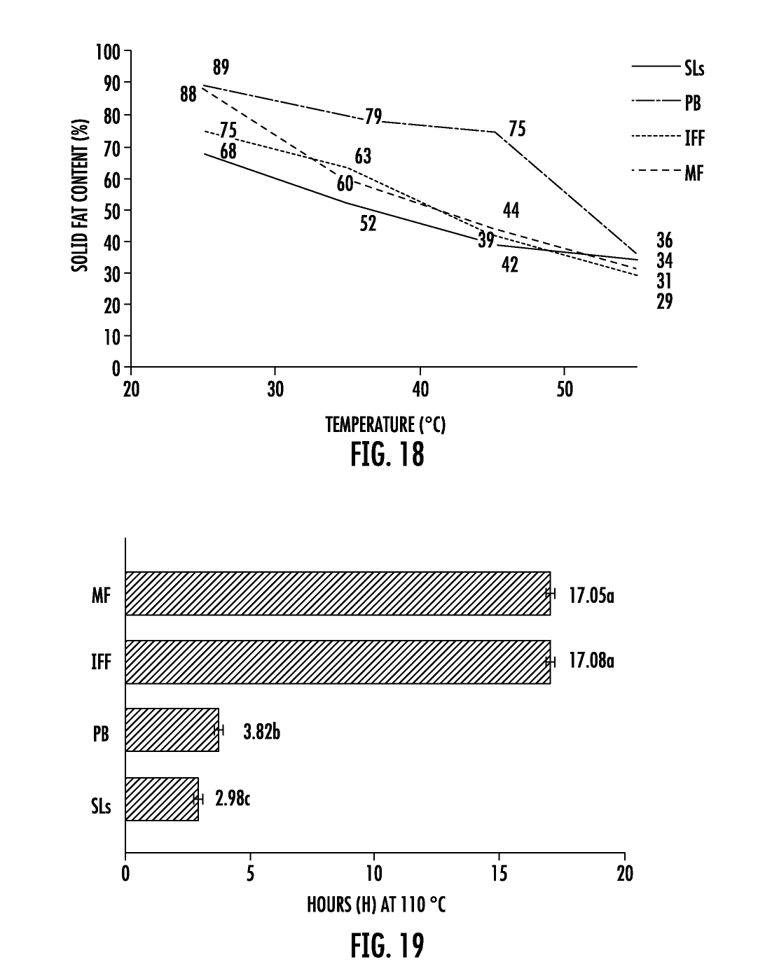

The SFC of SLs, PB, IFF, and MF are shown in FIG. 18. SLs exhibited a comparable SFC profile to IFF at each temperature tested, suggesting a promising feasibility of applying the SLs in infant formula production.

Oxidative Stability Index (OSI). The OSI of the SLs, PB, IFF, and MF were evaluated and results are shown in FIG. 19. The commercial infant formula (17.08 h) and milk fat (17.50 h) showed significantly higher OSI than the SLs (2.98 h) and PB (3.82). The lower OSI observed in the SLs compared to PB was probably due to the loss of natural antioxidants such as tocopherols during the interesterification process and short-path distillation. Additional antioxidants may be recommended to be added to the SLs to increase the oxidative stability and prolong the shelf life of the product containing the SLs.

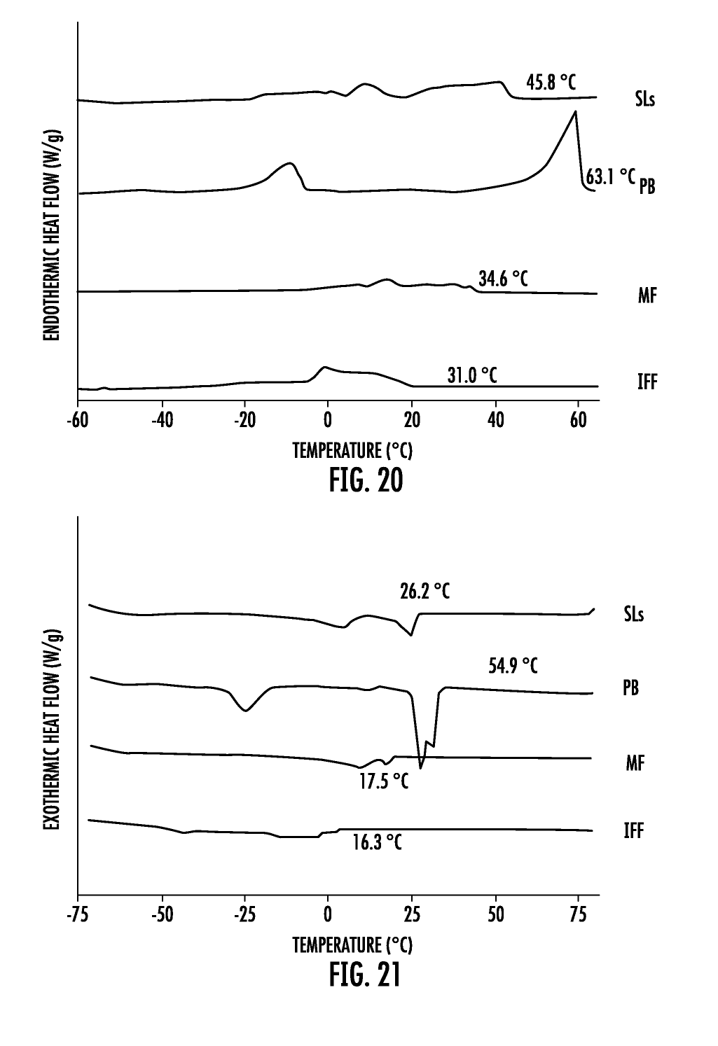

Melting and Crystallization Profiles. Melting and crystallization profiles of the SLs, PB, IFF, and MF are shown in FIGS. 20 and 21, respectively. The melting completion temperature (T_{mc}) normally depends on the type of fatty acids present and TAG species. An UUU type of TAG suggests that the TAG consists of three unsaturated fatty acids while a SSS type of TAG consists of three saturated fatty acids. Since unsaturated fatty acids usually exhibit lower melting point than their saturated counterparts with the same hydrocarbon chain length, an UUU type of TAG would be expected to have a lower melting point than its SSS counterpart. In the present example, SLs contained 4.29% of OOO, while it was absent in PB. In addition, SLs contained significantly lower (P<0.5) PPP (10.18%) than PB (64.23%). This could explain the lower melting completion temperature observed with SLs (45.8° C.) than PB (63.1° C.). Similarly, both IFF and MF contained higher OOO (8.96 and 5.24%, respectively) and lower PPP (ND and 8.78%) than SLs, which could result in the significantly lower (P<0.5) melting completion temperatures observed in IFF (31.0° C.) and MF (34.6° C.) than SLs. The SLs have broader melting curve as a result of interesterification compared to the non-esterified PB, MF, and IFF. In addition, the SLs exhibited a significantly higher crystallization onset temperature (T_{co}) (26.2° C.) than IFF (16.3° C.) and MF (17.5° C.). PB had the highest T_{co} (54.9° C.) (P<0.5) compared to the SLs, IFF, and MF.

As discussed, infant formulas with fat fraction that resembles human milk fat would be ideal nutrition substitute for human milk when breastfeeding is unavailable or limited. In this example, a commercial infant formula was found to contain as low as 6.12 mol % of palmitic acid at the sn-2 position of its TAG. The SLs produced in this study contain 49.28 mol % of palmitic acid at the sn-2 position, while the DHA content is also significantly higher than that found in the commercial infant formula. The SLs contained an increased amount of OPO species which is desirable for better absorption of palmitic acid and calcium. In addition, the SLs exhibited similar SFC to IFF. Therefore, the SLs produced herein have potential to be used in infant formula applications.

TABLE 7.1
Total and positional fatty acid composition (mol %) of
substrates DHASCO-EE, GLAEE, and refined olive oil

| | DHASCO- | | Refined olive oil* | |
|---|---|---|---|---|
| Fatty acid | EE* | GLAEE* | Total | sn-2 |
| C12:0 | 6.34 ± 0.07 | ND | ND | ND |
| C14:0 | 14.10 ± 0.13 | ND | ND | ND |
| C16:0 | 11.97 ± 0.45 | ND | 9.97 ± 0.08 | 1.49 ± 0.33 |
| C16:1n7 | ND | ND | 1.01 ± 0.00 | 0.84 ± 0.01 |
| C18:0 | ND | ND | 6.90 ± 0.15 | ND |
| C18:1n9 | 21.61 ± 0.89 | 1.63 ± 0.14 | 73.95 ± 0.55 | 86.35 ± 0.32 |
| C18:2n6 | ND | 26.58 ± 0.41 | 7.26 ± 0.01 | 10.30 ± 0.03 |
| C18:3n3 | ND | ND | 0.51 ± 0.00 | 1.01 ± 0.02 |
| C18:3n6 | ND | 71.79 ± 0.54 | ND | ND |
| C22:6n3 | 45.98 ± 1.21 | ND | ND | ND |

*Mean ± SD;
ND: not detected.

TABLE 7.2
Total and sn-2 fatty acid composition (mol %) of the scaled-up product (SLs), physical blend, commercial infant formula fat, and milk fat

| | Total fatty acids* | | | | sn-2* | | | |
|---|---|---|---|---|---|---|---|---|
| Fatty acids | SLs | PB | IFF | MF | SLs | PB | IFF | MF |
| C8:0 | ND | ND | 1.74 ± 0.04a | 1.56 ± 0.03a | ND | ND | 5.50 ± 1.76a | 5.95 ± 0.49a |
| C10:0 | ND | ND | 1.19 ± 0.03a | 3.05 ± 0.02b | ND | ND | ND | 3.21 ± 0.19 |
| C12:0 | ND | 0.44 ± 0.01a | 9.24 ± 0.20b | 3.65 ± 0.13c | ND | ND | 17.56 ± 1.93d | 8.02 ± 0.97e |
| C14:0 | 2.61 ± 0.93a | 1.29 ± 0.03b | 4.40 ± 0.06c | 11.76 ± 0.45d | 2.63 ± 0.54a | ND | 3.18 ± 0.20d | 17.54 ± 2.25e |
| C14:1 | ND | ND | ND | 0.98 ± 0.01 | ND | ND | ND | 1.35 ± 0.23 |
| C16:0 | 47.80 ± 0.41a | 46.60 ± 1.78a | 21.92 ± 0.09b | 31.63 ± 0.09c | 49.28 ± 1.68a | 32.67 ± 2.42c | 6.12 ± 1.07d | 33.05 ± 1.37c |
| C16:1 | ND | 0.74 ± 0.03a | ND | 1.97 ± 0.04b | ND | ND | ND | ND |
| C17:0 | ND | ND | ND | 1.91 ± 0.14 | ND | ND | ND | ND |
| C18:0 | 2.55 ± 0.09a | 1.92 ± 0.04b | 4.13 ± 0.02c | 11.17 ± 0.10d | ND | ND | ND | ND |
| C18:1trans | ND | ND | ND | 1.91 ± 0.03 | ND | ND | ND | 7.77 ± 0.72 |
| C18:1cis | 36.13 ± 0.37a | 41.22 ± 1.41b | 30.49 ± 0.20c | 26.26 ± 0.12d | 38.28 ± 0.84a | 59.33 ± 3.62e | 39.75 ± 2.47a | 20.56 ± 1.15f |
| C18:2trans | ND | ND | ND | 0.68 ± 0.01 | ND | ND | ND | ND |
| C18:2cis | 5.19 ± 0.05a | 3.77 ± 0.14b | 23.05 ± 0.06c | 3.02 ± 0.11bd | 6.29 ± 1.52e | 7.99 ± 1.50f | 26.22 ± 1.69c | 2.55 ± 0.20d |
| C18:3n6 | 5.00 ± 0.16a | 0.62 ± 0.02b | ND | ND | 3.52 ± 0.37c | ND | ND | ND |
| C18:3n3 | ND | 0.51 ± 0.02a | 2.99 ± 0.07b | 0.46 ± 0.01a | ND | ND | 1.66 ± 0.16c | ND |
| C20:4n6 | ND | ND | 0.59 ± 0.00 | ND | ND | ND | ND | ND |
| C22:6n3 | 0.73 ± 0.04a | 2.89 ± 0.14b | 0.26 ± 0.00c | ND | ND | ND | ND | ND |

*Mean ± SD; ND: not detected; SLs: structured lipids; PB: physical blend; IFF: infant formula fat; MF: milk fat; Values with different letter in each row are significantly different at P ≦ 0.5.

TABLE 7.3
Relative (%) of triacylglycerol (TAG) molecular species of structured lipids,
physical blend, infant formula fat, and milk fat

| TAG species | SL | PB | IFF | MF |
|---|---|---|---|---|
| LaCC | ND | ND | ND | 1.25 ± 0.09 |
| LaCLa | ND | ND | ND | 3.63 ± 0.21 |
| LnDLn | 10.91 ± 0.30a | ND | 2.72 ± 0.06b | ND |
| LaLnLa | ND | ND | ND | 12.25 ± 1.35 |
| LaLaLa | ND | ND | 4.97 ± 0.18 | ND |
| LaMLa | ND | ND | 4.74 ± 0.22a | 25.41 ± 0.98b |
| OLaM | ND | ND | ND | 3.24 ± 0.67 |
| MLaM | ND | ND | 3.76 ± 0.13a | 2.12 ± 0.67b |
| LLL | ND | ND | 2.02 ± 0.14 | ND |
| MML | ND | ND | 11.93 ± 0.32a | 2.26 ± 0.54b |
| MMM | ND | ND | ND | 1.36 ± 0.35 |
| LnLnS | ND | ND | ND | 3.48 ± 1.63 |
| LnOO | ND | ND | ND | 2.62 ± 0.72 |
| LPL | 10.09 ± 0.26 | ND | ND | ND |
| LOL | ND | ND | 8.61 ± 0.43 | ND |
| MPL | ND | ND | 5.23 ± 0.47a | 3.99 ± 0.63b |
| LOO | 9.83 ± 0.96a | 3.02 ± 0.41b | ND | 2.25 ± 0.45c |
| PLP | ND | ND | 5.38 ± 0.31 | 3.61 ± 0.48 |
| OOO | 4.29 ± 0.48a | ND | 8.96 ± 0.16b | 5.24 ± 0.74a |
| OPO | 22.78 ± 0.75a | 24.49 ± 1.47a | 3.37 ± 0.13b | 2.57 ± 0.27c |
| POP | 31.91 ± 0.68a | 8.26 ± 0.07b | ND | ND |
| PPP | 10.18 ± 0.52a | 64.23 ± 1.60b | ND | 8.78 ± 0.47c |
| OSO | ND | ND | 7.04 ± 0.63a | 7.73 ± 0.76a |
| OSP | ND | ND | 15.49 ± 0.22a | 2.64 ± 0.35b |
| PSP | ND | ND | 13.60 ± 0.02a | 1.61 ± 0.23b |
| MSS | ND | ND | ND | 3.37 ± 0.51 |
| SOS | ND | ND | 0.90 ± 0.14 | ND |
| PSS | ND | ND | 1.28 ± 0.09 | ND |

The fatty acids are not in regiospecific order;
Values with different letter in each row are significantly different at P ≦ 0.5.

### REFERENCES:

1. Agostoni C (2008) Role of Long-chain Polyunsaturated Fatty Acids in the First Year of Life. J Pediatr Gastroenterol Nutr 47:S41-S44
2. Augusto P E D, Soares B M C, Chiu M C, Goncalves L A G (2012) Modelling the effect of temperature on the lipid solid fat content (SFC), Food Res. Int. 45:132-135
3. Akoh C, Xu X (2002) Enzymatic production of betapol and other specialty fats. in Kuo T M, Gardner H W (eds) Lipid Biotechnology. CRC Press, New York, pp. 461-478.
4. Akoh C C, Min D B (2008) Food lipids: chemistry, nutrition, and biotechnology, 3rd edn. CRC Press/Taylor & Francis Group, Boca Raton
5. Akoh, C. C.; Kim, B. H. Structured lipids. In Food lipids: chemistry, nutrition, and biotechnology, 3^{rd} ed.; Akoh, C. C., Min, D. B., Eds.; CRC Press: Boca Raton, Fla., 2008, pp. 841-865.
6. AOAC International (1998) Official Methods of Analysis of AOAC International, 17th edn. Gaithersburg, Md., Method 996.01
7. AOCS Official Methods Ac 5-41 and Cj 1-94 (2009) Official methods and recommended practices of the American Oil Chemists' Society. In: Firestone D (ed) 6th edn., American Oil Chemist's Society, Champaign.
8. ASTM American Society for Testing and Materials Standard E1858-2008 “Standard test method for determining oxidation induction time of hydrocarbons by differential scanning calorimetry.” West Conshohocken, Pa.: ASTM International.
9. ASTM American Society for Testing and Materials Standard E2009-2008 “Standard test method for oxidation onset temperature of hydrocarbons by differential scanning calorimetry.” West Conshohocken, Pa.: ASTM International.
10. Augustin M A, et al. 2011. Effects of microencapsulation on the gastrointestinal transit and tissue distribution of a bioactive mixture of fish oil, tributyrin and resveratrol. J Funct Foods 3:25-37.
11. Augustin M A, et al. 2006. Maillard reaction products as encapsulants for fish oil powders. J Food Sci 71:E25-E32.
12. Barbas, C.; Herrera, E. Lipid composition and vitamin E content in human colostrum and mature milk. J. Physiol. Biochem. 1998, 54, 167-173.
13. Bligh E G, Dyer W J (1959) A rapid method of total lipid extraction and purification, Can. J. Biochem. Phys. 37:911-917
14. Brenna J T, et al. 2007. Docosahexaenoic and arachidonic acid concentrations in human breast milk worldwide. Am J Clin Nutr 85:1457-1464.
15. Burdge, G. C.; Calder, P. C. Conversion of alpha-linolenic acid to longer-chain polyunsaturated fatty acids in human adults. Reprod. Nutr. Dev. 2005, 45, 581-597.
16. Carnielli V P, et al. (1996) Structural position and amount of palmitic acid in infant formulas: effects on fat, fatty acid, and mineral balance, J Pediatr Gastroenterol Nutr 23 :553-560
17. Carnielli,V.; et al. Feeding premature newborn infants palmitic acid in amounts and stereoisomeric position similar to that of human milk: Effects on fat and mineral balance. Am. J. Clin. Nutr. 1995, 61, 1037-1042.
18. Che Man Y, et al. (1999) Composition and thermal profile of crude palm oil and its products, J Am Oil Chem Soc 76:237-242
19. Chnadhapuram M, Sunkireddy Y R (2012) Preparation of palm olein enriched with medium chain fatty acids by lipase acidolysis, Food Chem 132:216-221
20. Choi K, et al. 2010. Spray-dried conjugated linoleic acid encapsulated with Maillard reaction products of whey proteins and maltodextrin. Food Sci Biotechnol 19:957-965.
21. Chopra R, Rastogi N, Sambaiah K (2011) Enrichment of rice bran oil with α-linolenic acid by enzymatic acidolysis: optimization of parameters by response surface methodology, Food Bioprocess Tech 4:1153-1163
22. Christensen, M. M.; Hoy, C. E. Early dietary intervention with structured triacylglycerols containing docosahexaenoic acid. Effect on brain, liver, and adipose tissue lipids. Lipids 1997, 32, 185-191.
23. Christie W, et al. (1991) Stereospecific analysis of triacyl-sn-glycerols via resolution of diastereomeric diacylglycerol derivatives by high-performance liquid chromatography on silica, J Am Oil Chem Soc 68:695-701
24. Coulson S, Vitetta L (2009) Nutrients and the brain, Journal of Complementary Medicine 8:24-29
25. Crawley, H.; Westland, S. Infant milks in the UK: Greenwich breastfeeding strategy. URL (http://www.greenwichbreastfeeding.com/downloads/Infant%20milks%20in%20the%20UK.pdf) (accessed March, 2013).
26. de la To r re-Carbot, K et al. Characterization and quantification of phenolic compounds in olive oils by solid-phase extraction, HPLC-DAD, and HPLC-MS/MS. J. Agric. Food Chem. 2005, 53, 4331-430.
27. Del Coco, et al. Comparison among different gilthead sea bream (Sparus aurata) farming systems: activity of intestinal and hepatic enzymes and ¹³C NMR analysis of lipids. Nutrients 2009, 1, 291-301.
28. Doyle K M, Bird D A, Alsalihi S, Hallaq Y, Cluettebrown J E, Goss K A, Laposata M (1994) Fatty acid ethyl esters are present in human serum after ethanol ingestion, J. Lipid Res. 35:428-437.
29. EFSA Panel on Dietetic Products, Nutrition and Allergies. Scientific opinion on the substantiation of a health claim related to beta-palmitate and increased calcium absorption pursuant to Article 14 of Regulation (EC) No 1924/2006. Eur. Food Safety Authority J. 2011, 9, 2289-2305.
30. Esteban L, et al. (2011) Production of structured triacylglycerols rich in palmitic acid at sn-2 position and oleic acid at sn-1,3 positions as human milk fat substitutes by enzymatic acidolysis, Biochemical Engineering Journal 54:62-69
31. Femandez-Lafuente, R. Lipase from Therinomyces lanuginosus: uses and prospects as an industrial biocatalyst. J. Mol. Catal. B: Enzym., 2010, 62, 197-212.
32. Filer L J, Jr., et al. (1969) Triglyceride configuration and fat absorption by the human infant, J Nutr 99:293-298
33. Fleith M, Clandinin M T (2005) Dietary PUFA for preterm and term infants: review of clinical studies, Crit Rev Food Sci Nutr 45:205-229
34. Gibson, R. A.; Makrides, M. The role of long chain polyunsaturated fatty acids (LCPUFA) in neonatal nutrition. Acta Paediatr. 1998, 87, 1017-1022.
35. Groenendaal W, van den Burg C. , inventors 2002. Late addition of pufa in infant formula preparation process. U.S. Pat. No. 6,428,832.
36. Gunstone, F. D.; Seth, S. A study of the distribution of eicosapentaenoic acid and docosahexaenoic acid between the α and β glycerol chains in fish oils by ¹³C NMR spectroscopy. Chem. Phys. Lipids 1994, 72, 119-126.
37. Hamam, F.; Shahidi, F. Acidolysis reactions lead to esterification of endogenous tocopherols and compromised oxidative stability of modified oils. J. Agric. Food Chem. 2006, 54, 7319-7323.
38. Hamosh M (1990) Lingual and Gastric Lipases. Nutr 6:421-428
39. Hamosh M (2008) Fatty acids and growth and development. in Chow C K (ed) Fatty acids in foods and their health implications. Boca Raton: CRC Press, pp. 899-935
40. Heird W C (2006) The role of essential fatty acids in development. Cambridge Univ Press, Cambs, England
41. Hernandez-Martin, E.; Otero, C. Different enzyme requirements for the synthesis of biodiesel: Novozym® 435 and Lipozyme® TL IM. Bioresource Technol. 2008, 9, 277-286.
42. Hogan S A, et al. 2001. Emulsification and microencapsulation properties of sodium caseinate/carbohydrate blends. Int Dairy J 11:137-144.
43. Horby Jorgensen M, et al. (1998) Effect of formula supplemented with docosahexaenoic acid and gamma-linolenic acid on fatty acid status and visual acuity in term infants, J Pediatr Gastroenterol Nutr 26:412-421
44. Horrobin D F. 1992. Nutritional and medical importance of gamma-linolenic acid. Prog Lipid Res 31:163-194.
45. Ibrahim, N A.; et al. Enzymatic interesterification of palm stearin and coconut oil by a dual lipase system. J. Am. Oil Chem. Soc. 2008, 85, 37-45.
46. Innis S M. 2007. Fatty acids and early human development. Early Hum. Dev 83:761-766.
47. Innis S M, et al. (1994) Evidence that palmitic acid is absorbed as sn-2 monoacylglycerol from human milk by breast-fed infants, Lipids 29:541-545
48. Innis, S. M. S.; et al. Palmitic acid is absorbed as sn-2 monopalmitin from milk and formula with rearranged triacylglycerols and results in increased plasma triglyceride sn-2 and cholesteryl ester palmitate in piglets. J. Nutr. 1995, 125, 73-81.
49. Jeffrey B G, et al. (2001) The role of docosahexaenoic acid in retinal function, Lipids 36:859-871
50. Jennings B, Akoh C (1999) Enzymatic modification of triacylglycerols of high eicosapentaenoic and docosahexaenoic acids content to produce structured lipids, J Am Oil Chem Soc 76:1133-1137
51. Jensen R G. 1999. Lipids in human milk. Lipids 34:1243-1271.
52. Kagami Y, et al. 2003. Oxidative stability, structure, and physical characteristics of microcapsules formed by spray frying of fish oil with protein and dextrin wall materials. J Food Sci 68:2248-2255.
53. Karel M, Labuza T P, Maloney J F. 1967. Chemical changes in freeze-dried foods and model system. Cryobiol 3:288-296.
54. Karupaiah, T.; Sundram, K. Effects of stereospecific positioning of fatty acids in triacylglycerol structures in native and randomized fats: a review of their nutritional implications. Nutr. Metabol. 2007, 4, 1-17.
55. Kato, A. Industrial applications of Maillard-type protein-polysaccharide conjugates. Food Sci. Technol. Res. 2002, 8, 193-199.
56. Kennedy, K, et al. (1999) Double-blind, Randomized Trial of a Synthetic Triacylglycerol in Formula-fed Term Infants: Effects on Stool Biochemistry, Stool Characteristics, and Bone Mineralization. Am J Clin Nutr 70: 920-927
57. Kim B H, Akoh C C (2005) Modeling of Lipase-Catalyzed Acidolysis of Sesame Oil and Caprylic Acid by Response Surface Methodology: Optimization of Reaction Conditions by Considering Both Acyl Incorporation and Migration. J Agric Food Chem 53:8033-8037
58. Kim, J.; Friel, J. Lipids and human milk. Lipid Technol. 2012, 24, 103-105.
59 Kinnunen P M, Lange L G (1984) Identification and quantitation of fatty acid ethyl esters in biological specimens, Anal. Biochem. 140:567-576
60. Kleiner L, et al. (2012) Increasing stearidonic acid (SDA) in modified soybean oil by lipase-mediated acidolysis, J Am Oil Chem Soc 89:1267-1275
61. Klinkesorn U, et al. 2006. Characterization of spray-dried tuna oil emulsified in two-layered interfacial membranes prepared using electrostatic layer-by-layer deposition. Food Res Int 39:449-457.
62. Klinkesorn U, et al. 2005. Stability of spray-dried tuna oil emulsions encapsulated with two-layered interfacial membranes. J Agric Food Chem 53:8365-8371.
63. Koletzko, B.; et al. Global standard for the composition of infant formula: recommendations of an ESPGHAN coordinated international expert group. J. Pediatr. Gastr. Nutr. 2005, 41, 584-599.
64. Koo W K, et al. (2003) Reduced bone mineralization in infants fed palm olein-containing formula: A randomized, double-blinded, prospective trial, Pediatr 111:1017-1023
65. Kosaraju S L, et al. 2009. In-vitro evaluation of hydrocolloid-based encapsulated fish oil. Food Hydrocolloid 23:1413-1419.
66. Lai O M, et al. (2005) Lipase-catalyzed acidolysis of palm olein and caprylic acid in a continuous bench-scale packed bed bioreactor, Food Chem 92:527-533
67. Lee K T, Akoh C C (1998) Characterization of Enzymatically Synthesized Structured Lipids Containing Eicosapentaenoic, Docosahexaenoic, and Caprylic Acids. J Am Oil Chem Soc 75:495-499
68. Lee K T, Foglia T A (2000) Synthesis, purification, and characterization of structured lipids produced from chicken fat, J Am Oil Chem Soc 77:1027-1034
69. Legako J, Dunford N T. 2010. Effect of spray nozzle design on fish oil-whey protein microcapsule properties. J Food Sci 75:E394-E400.
70. Lien E L (1994) The role of fatty acid composition and positional distribution in fat absorption in infants, J Pediatr 125:S62-68
71. Lien E L, et al. (1997) The effect of triglyceride positional distribution on fatty acid absorption in rats, J Pediatr Gastroenterol Nutr 25:167-174
72. Lopez-Lopez A, et al. (2001) The influence of dietary palmitic acid triacylglyceride position on the fatty acid, calcium and magnesium contents of at term newborn faeces, Early Hum Dev 65:S83-S94
73. Lopez-Lopez A, et al. (2002) Fatty acid and sn-2 fatty acid composition in human milk from Granada (Spain) and in infant formulas, European Journal of Clinical Nutrition 56:1242-1254
74. Luddy F E, Magidman P, Herb S F, Riemenschneider R W, Barford R A (1964) Pancreatic lipase hydrolysis of triglycerides by semi-micro technique, J. Am. Oil Chem. Soc. 41:639-696
75. Lumor S E, et al. (2007) Synthesis and characterization of canola oil-stearic acid-based trans-free structured lipids for possible margarine application, Journal of Agricultural and Food Chemistry 55:10692-10702
76. Lumor, S. E.; Akoh, C. C. Incorporation of γ-linolenic and linoleic acids into a palm kernel oil/palm olein blend. Eur. J. Lipid Sci. Technol. 2005, 107, 447-454.
77. Marikkar J M N, et al. (2003) Differential scanning c alorimetric analysis for determination of some animal fats as adulterants in palm olein, J Food Lipids 10:63-79
78. Master K. 1991. Spray drying handbook. New York: John Wiley & Sons, Inc.
79. Mateo, C.; et al. Improvemnet of enzyme activity, stability and selectivity via immobilization techniques. Enzyme Microb. Tech. 2007, 40, 1451-1463.
80. Mattson F H, Lutton E S. 1958. The specific distribution of fatty acids in the glycerides of animal and vegetable fats. J Biol Chem 233:868-871.
81. Mattson F H, Volpenhein R A (1962) Rearrangement of glyceride fatty acids during digestion and absorption, J Biol Chem 237:53-55
82. Morera S, et al. (2003) Triacylglycerol Markers of Mature Human Milk. Eur J Clin Nutr 57:1621-1626
83. Mu H, Høy C E (2004) The Digestion of Dietary Triacyglycerols: Review. Prog Lipid Res 43:105-133
84. Mu H, et al. (2001) Quantitation of Acyl Migration During Lipase-Catalyzed Acidolysis and of the Regioisomers of Structured Triacylglycerols Formed. J Am Oil Chem Soc 78:959-964
85. Nagachinta S, Akoh C C (2012) Enrichment of Palm Olein with Long Chain Polyunsaturated Fatty Acids by Enzymatic Acidolysis. LWT-Food Sci Technol 46:29-35
86. Nagachinta S, Akoh C C (2013) Production and characterization of DHA and GLA-enriched structured lipid from palm olein for infant formula use, Journal of the American Oil Chemists Society 90:1141-1149
87. Negishi, S.; et al. Synthesis of 1,3-dicapryloyl-2-docosahexacnoylg lycerol by a combination of nonselective and sn-1,3-selective lipase reactions. J. Am. Oil Chem. Soc. 2003, 80, 971-974.
88. Nelson S E, et al. (1998) Absorption of fat and calcium by infants fed a milk-based formula containing palm olein, J Am Coll Nutr 17:327-332
89. Nelson S E, et al. (1996) Palm olein in infant formula: absorption of fat and minerals by normal infants, Am J Clin Nutr 64:291-296
90. Noor Lida H, et al. (2002) TAG composition and solid fat content of palm oil, sunflower oil, and palm kernel olein belends before and after chemical interesterification, J Am Oil Chem Soc 79:1137-1144
91. Official Methods and Recommended Practice of the AOCS, 6^{th} ed.; Firestone, D., Ed.; American Oil Chemists' Society: Champaign, Ill., 2009; Official Methods Ac 5-41 and Cj 1-94; Ca 5a-40 and Ce 8-89.
92. Official Methods and Reommended Practices of the AOCS. (1997) American Oil Chemists' Society, Champaign, Ill.; Official Method Cd 12b-92.
93. Official Methods of Analysis of AOAC International, 17th ed.; AOAC International: Gaithersburg, Md., 1998; Official Method 996.01.
94. Official Methods and Recommended Practices of the American Oil Chemists' Society, 6th ed.; AOCS: Champaign, Ill., 2011; Official Method Cd 3a-94; Ch 3-91; Cd 3a-94; Ch 3-91; Cj 1-94; Cj 1-94.
95. Official Methods of Analysis of AOAC International (2012) 19th ed. AOAC Intl, Gaitherburg, Md.; Method 996.01.
96. Owen, R. W.; et al. Olive-oil consumption and heal h: the possible role of antioxidants. Lancet Oncol. 2000,1, 107-112.
97. Owen, R. W.; et al. Phenolic compounds and squalene in olive oils: the concentration and antioxidant potential of total phenols, simple phenols, secoiridoids, lignansand squalene. Food Chem. Toxicol. 2000, 38, 647-659.
98. Pande G, et al. (2013) Synthesis of infant formula fat analogs enriched with DHA from extra virgin olive oil and tripalmitin, Journal of the American Oil Chemists Society 90:1311-1318
99. Pande, G., et al. Production of trans-free margarine with stearidonic acid soybean and high-stearate soybean oils-based structured lipid. J. Food Sci . 2012, 77, C1203-C1210.
100. Pande, G.; Akoh, C. C. Enzymatic synthesis of trans-free structured margarine fat analogues using stearidonic acid soybean and high stearate soybean oils. J. Am. Oil Chem. Soc. 2012, 89, 1473-1484.
101. Patten G S, et al. 2009. Site specific delivery of microencapsulated fish oil to the gastrointestinal tract of the rat. Dig Dis Sci 54:511-521.
102. Picciano M F (1998) Human Milk: Nutritional Aspects of a Dynamic Food. Biol Neonates 74:84-93
103. Pina-Rodriguez A M, Akoh C C (2009) Enrichment of amaranth oil with ethyl palmitate at the sn-2 position by chemical and enzymatic synthesis, Journal of Agricultural and Food Chemistry 57:4657-4662
104. Pina-Rodriguez A M, Akoh C C (2009) Synthesis and characterization of a structured lipid from amaranth oil as a partial fat substitute in milk-based infant formula, Journal of Agricultural and Food Chemistry 57:6748-6756
105. Quinlan P T, et al. (1995) The relationship between stool hardness and stool composition in breast-fed and formula-fed infants, J Pediatr Gastr Nutr 20:81-90
106. Raphael M, Rohani S. 1996. On-line estimation of solids concentrations and mean particle size using a turbidimetry method. Powder Technol 89:157-163.
107. Robles A, et al. (2011) Enzymatic production of human milk fat substitutes containing palmitic and docosahexaenoic acids at sn-2 position and oleic acid at sn-1,3 positions, LWT-Food Science and Technology 44:1986-1992
108. Rodrigues, R. C., et al. Modifying enzyme activity and selectivity by immobilization. Chem. Soc. Rev. 2013, 42, 6290-6307.
109. Ruiz-Gutierrez V, Barron L J (1995) Methods for the analysis of triacylglycerols, J Chromatogr B 671:133-168
110. Rusli J, et al. 2006. Stabilization of oils by microencapsulation with heated protein-glucose syrup mixtures. J Am Oil Chem Soc 83:965-972.
111. Ryan, A. S., et al. Effects of long-chain polyunsaturated fatty acid supplementation on neurodevelopment in childhood: a review of human studies. Prostaglandins, Leukotrienes Essent. Fatty Acids 2010, 82, 305-314.
112. Sacchi, R., et al. Quantitative high-resolution ¹³C NMR analysis of lipids extracted from the white muscle of Atlantic tuna (Thunnus alalunga). J. Agric. Food Chem. 1993, 41, 1247-1253.
113. Sahin, N., et al. Human milk fat substitutes containing omega-3 fatty acids. J. Agric. Food Chem. 2006, 54, 3717-3722.
114. Sahin, S., Sumnu, S. G. Electromagnetic Properties. In Physical Properties of Foods, Sahin, S.; Sumnu, S. G., Eds; Springer: New York, N.Y., 2006; pp. 157-192.
115. Schmid, U., et al. Highly selective synthesis of 1,3-oleoyl-2-palmitoylglycerol by lipase catalysis. Biotechnol. Bioeng. 1999, 64, 678-684.
116. Scott D T, et al. (1998) Formula supplementation with long-chain polyunsaturated fatty acids: are there developmental benefits?, Pediatr 102:E59
117. Senanayake S, Shahidi F (1999) Enzymatic incorporation of docosahexaenoic acid into borage oil, J Am Oil Chem Soc 76:1009-1015
118. Senanayake S, Shahidi F (2004) Incorporation of docosahexaenoic acid (DHA) into evening primrose (Oenothera biennis L.) oil via lipase-catalyzed transesterification, Food Chem 85:489-496
119. Shahidi F, Zhong Y. 2005. Lipid oxidation: Measurement methods. In Shahidi F, editor. Bailey's Industrial Oil and Fat Products. John Wiley & Sons, Inc. p 357-385.
120. Sørensen A M, et al. (2010) Human Milk Fat Substitute from Butterfat: Production by Enzymatic Interesterification and Evaluation of Oxidative Stability. J Am Oil Chem Soc 87:185-194
121. Soumanou, M M, et al. Two-step enzymatic reaction for the synthesis of pure structured triacylg tycerides. J. Am. Oil Chem. Soc. 1998, 75, 703-710.
122. Spurgeon M J et al. (2003) An investigation of the general, reproductive and postnatal developmental toxicity of Betapol, a human milk fat equivalent, Food Chem Toxicol 41:1355-1366
123. Stepelfeldt H, et al. 1997. Effect of heat treatment, water activity, and storage temperature on the oxidative stability of whole milk powder. Int Dairy J 7:331-339.
124. Straarup E M, et al. 2006. The stereospecific triacylglycerol structures and fatty acid profiles of human milk and infant formulas. J Pediatr Gastroenterol Nutr 42:293-299.
125. Strayer, D, et al. Food fats and oils. 9^{th} ed.; Institute of Shortening and Edible Oils, Washington, D.C., 2006. .iseo.org/httpdocs/Publications/FoodFatsOils2006.pdf (Accessed: Aug. 5^{th}, 2013)
126. Suarez, E, et al. ¹³C NMR regioisomeric analysis of EPA and DHA in fish oil derived triacylglycerol concentrates. J. Am. Oil Chem. Soc. 2010, 87, 1425-1433.
127. Takeuchi H (2010) Application of biotechnology in the development of a healthy oil capable of suppressing fat accumulation in the body. in Bagchi D, Lau F C, Ghosh D K (eds) Biotechnology in Functional Foods and Nutraceuticals. CRC Press, Boca Raton, pp. 103-112
128. Tan C P, Che Man Y B (2002) Differential scanning c alorimetric analysis of palm oil, palm oil based products and coconut oil: effects of scanning rate variation, Food Chem 76:89-102
129. Teichert S A, Akoh C C (2011) Characterization of stearidonic acid soybean oil enriched with palmitic acid produced by solvent-free enzymatic interesterification, J Agric Food Chem 59:9588-9595
130. Teichert S A, Akoh C C (2011) Modifications of Stearidonic Acid Soybean Oil by Enzymatic Acidolysis for the Production of Human Milk Fat Analogues. J Agric Food Chem 59:13300-13310
131. Teichert S A, Akoh C C (2011) Stearidonic acid soybean oil enriched with palmitic acid at the sn-2 position by enzymatic interesterification for use as human milk fat analogues, Journal of Agricultural and Food Chemistry 59:5692-5701
132. Tomarelli, R M, et al. Effect of positional distribution on the absorption of the fatty acids of human milk and infant formulas. J. Nutr. 1968, 95, 583-590.
133. Turan D, et al. (2012) Production of human milk fat analogue containing docosahexaenoic and arachidonic acids, J Agric Food Chem 60:4402-4407
134. Turan D, et al. (2013) Enrichment of sn-2 position of hazelnut oil with palmitic acid: Optimization by response surface methodology, LWT-Food Science and Technology 50:766-772
135.Türkan, A.; Kalay, S. Monitoring lipase-catalyzed met anolysis of sunflower oil by reversed-phase high-performance liquid chromatography: elucidation of the mechanisms of lipases. J. Chromatogr. A 2006, 1127, 34-44.
136. Uauy R, et al. (2003) Term infant studies of DHA and ARA supplementation on neurodevelopment: results of randomized controlled trials, J Pediatr 143:S17-25
137. Vazquez L, Akoh C (2011) Concentration of stearidonic acid in free fatty acid and fatty acid ethyl ester forms from modified soybean oil by winterization, J Am Oil Chem Soc 88:1775-1785
138. Walczewska A, et al. (2011) The role of docosahexaenoic acid in neuronal function, Postepy Higieny I Medycyny Doswiadczalnej 65:314-327
139. Walstra P. 2003. Physical chemistry of foods. New York: Marcel Dekker.
140. Wanasundara U N, Shahidi F (1999) Concentration of Omega3-Polyunsaturated Fatty Acids of Seal Blubber Oil by Urea Complexation: Optimization of Reaction Conditions. Food Chem 65 :41-49
141. Wijewickreme A N, et al. 1999. Hydroxyl scavenging activity of glucose, fructose, and ribose-lysine model Maillard products. J Food Sci 64:457-461.
142. Xu X (2000) Production of specific-structured triacylglycerols by lipase-catalyzed reactions: a review, European Journal of Lipid Science and Technology 102:287-303
143. Xu X, et al. (1998) Production of Specific-structured Lipids by Enzymatic Interesterification: Elucidation of Acyl Migration by Response Surface Design. J Am Oil Chem Soc 75:1179-1186
144. Yang T, et al. (2005) Supression of Acyl Migration in Enzymatic Production of Structured Lipids through Temperature Programming. Food Chem 92:101-107
145. Yehuda, S, et al. Essential fatty acids and the brain: from infancy to aging. Neurobiol. Aging 2005, 26, 98-102.
146. Young S L, et al. 1993. Microencapsulating properties of whey proteins. 2. Combination of whey proteins with carbohydrates. J Dairy Sci 76:2878-2885.
147. Zink, D. Powdered infant formula: an overview of manufacturing processes. URL (http://www.fda.gov/ohrms/dockets/ac/03/briefing/3939b1_tab4b.pdf) (accessed January, 2013).
148. Zock P L, et al. (1996) Partial Conservation of the sn-2 Position of Dietary Triglycerides in Fasting Plasma Lipids in Humans. Eur J Clin Invest 26:141-150
149. Zou X, et al. 2012. Preparation of human milk fat substitutes from palm stearin with arachidonic and docosahexaenoic acid: Combination of enzymatic and physical methods. J Agric Food Chem 60:9415-9423.
150. Zou, L.; Akoh, C. C. Identification of tocopherols, tocotrienols, and their fatty acid esters in residues and distillates of structured lipids purified by short-path distillation. J. Agric. Food Chem. 2012, 61, 238-246.
151. Zou, X Q, et al. Model for human milk fat substitute evaluation based on triacylglycerol composition profile. J. Agric. Food Chem. 2013, 61, 167-175.

1. A composition comprising:
a mixture of structured lipids (SLs), wherein at least a portion of the SLs in the mixture comprise palmitic acid at a sn-2 position, and wherein the mixture is selected from the group consisting of: SL1-1, SL1-2, SL2-1, SL2-2, SL132, SL142, SL151, TDA-SL, PDG-SL, SL3, SL5, SL6, and SL7.

2. The composition of claim 1, wherein the palmitic acid at a sn-2 position is about 13 to 65 mol % of total fatty acids in the SL mixture.

3. (canceled)

4. The composition of claim 1, wherein the palmitic acid at a sn-2 position is about 50 mol % or more of total palmitic acid in the SL mixture.

5. The composition of claim 1, wherein the SL mixture comprises one or more fatty acids selected from the group consisting of: docosahexaenoic acid (DHA), arachidonic acid (ARA), palmitic acid, and gamma-linolenic acid (GLA).

6. (canceled)

7. (canceled)

8. (canceled)

9. The composition of claim 1, wherein the mixture is a powdered formulation.

10. (canceled)

11. A method of making a mixure of structured lipids (SLs), the method comprising:
a. providing one or more substrate oils, wherein at least one of the oils is a tripalmitin oil;
b. providing one or more free fatty acid compounds, wherein the free fatty acid compounds comprise fatty acid oils, free fatty acids (FFAs), fatty acid ethyl esters (FAEEs), or a combination thereof; and
c. reacting the one or more substrate oils and the one or more free fatty acid compounds with one or more lipases selected from the group consisting of: non-specific lipases, sn-1,3 specific lipases, and combinations of both non-specific and sn-1,3 lipases to form a SL mixture having at least a portion of palmitic acid in the SLmixture at an sn-2 position.

12. The method of claim 11, wherein the substrate oils comprise tripalmitin and one or more additional substrate oils selected from olive oil and palm olein oil.

13. (canceled)

14. (canceled)

15. (canceled)

16. The method of claim 11, wherein the fatty acid oils FFAs and FAEEs are selected from the group consisting of: docosahexaenoic acid (DHA) oils, FFAs of DHA, FAEEs of DHA, arachidonic acid (ARA) oils, FFAs of ARA, FAEEs of ARA, gamma-linolenic acid (GLA) oils, FFAs of GLA, FAEEs of GLA, and combinations of these.

17. The method of claim 11, wherein the substrate oils and free fatty acid compounds are reacted with both a non-specific and a sn-1,3 specific lipase lipases.

18. The method of claim 17, wherein the sn-1,3 specific lipase is Lipozyme TL IM and the non-specific lipase is Novozym 435.

19. (canceled)

20. The method of claim 17, wherein the lipases are reacted simultaneously in a one-stage reaction.

21. (canceled)

22. The method of claim 17, wherein the lipases are reacted sequentially in a two-stage reaction, wherein the one or more substrate oils is reacted in a first stage with the non-specific lipase to produce an intermediate SL mixture and then the intermediate SL mixture is reacted with the one or more free fatty acid compounds and the sn-1,3 specific lipase to produce the SL mixture.

23. The method of claim 11, wherein the palmitic acid at a sn-2 position is about 30 to 65 mol % of total palmitic acid in the SL mixture.

24. The method of claim 11, wherein the one or more substrate oils, one or more free fatty acid compounds, and one or more lipases are reacted for about 12-24 hours.

25. The method of claim 22, wherein the first stage is about 6-12 hours and the second stage is about 6-12 hours.

26. The method of claim 11, wherein the one or more substrate oils and one or more free fatty acid compounds are combined in a substrate mole ratio (substrate oil:fatty acid compound) of about 1-6 (mol/mol).

27. The method of claim 26, wherein the substrate oils comprise tripalmitin and olive oil and the free fatty acid compound includes a combination of FFAs of DHA and ALA, and wherein the substrate mole ratio of olive oil: tripalmitin: FFA is about 0.5-1:1:0.5-1.

28. A method of making a powder formulation of a mixture of structured lipids (SLs), the method comprising:
providing a SL mixture made by the method of any of claim 11;
dispersing the SL mixture in a carbohydrate and protein mixture to form an emulsion; and
spray drying the emulsion to provide a powder formulation of microencapsulated SLs.

29. The method of claim 28, wherein the carbohydrate is selected from the group consisting of: corn syrup solids, cyclodextrin, maltodextrin, carboxymethyl cellulose (CMC), chitosan, gum Arabic, sodium alginate, pectin, milk protein in combination with carbohydrates, Maillard reaction products, and combinations of these and wherein the protein is selected from the group consisting of: whey protein, gelatin, and combinations of these.

30. (canceled)

31. The method of claim 28, wherein forming the emulsion comprises mechanically mixing the SL mixture and the protein/carbohydrate mixture in a homogenizer.
